(19) United States
(12) Patent Application Publication
(10) Pub. No.: US 2025/0156889 A1
(43) Pub. Date: May 15, 2025

(54) Systems and Methods for Generating Insights Based on Physical Signals

(71) Applicant: Google LLC, Mountain View, CA (US)

(72) Inventors: Jingying Hu, Menlo Park, CA (US); Gerard Pallipuram, Cupertino, CA (US); Tong Wu, Mountain View, CA (US); Sriram Krishna Parameswar, Bellevue, WA (US); Ivan Poupyrev, Sunnyvale, CA (US)

(21) Appl. No.: 18/838,481

(22) PCT Filed: Feb. 14, 2022
(86) PCT No.: PCT/US2022/016280

§ 371 Date: Aug. 14, 2024

(51) Int. Cl. G06Q 30/0202; G06Q 30/0601

(52) U.S. Cl. CPC G06Q 30/0202; G06Q 30/0623

(57) ABSTRACT

The present disclosure is directed to generating insight based on physical signals. The method includes receiving contextual data associated with a first party user and at least one item. The contextual data is indicative of a physical interaction between the first party user and the at least one item. The physical interaction, for example, can include an approaching action, a picking up action, or any other action between a first party user and an item in the physical world. The method includes determining an item interest level for the at least one item based, at least in part, on the contextual data. And, the method includes initiating a presentation of a content item to the user via a user device associated with the user based, at least in part, on the item interest level for the at least one item. The content item includes information for the at least one item.

### FIELD

The present disclosure relates generally to insight driven, privacy conscious, user engagement. More particularly, the present disclosure relates to improved techniques for capturing, analyzing, and distributing user insights based on physical signals.

### BACKGROUND

Various forms of digital signal monitoring (e.g., indicative of a user's online activity) can be used to obtain and transfer data associated with a user between a number of different parties. A common digital signal monitoring technique involves using “cookies” (e.g., text files downloaded through a web browser). Cookies can be used to record digital signals such that the information can be accessed by third-parties (e.g., for creating personal websites, personalized ads, etc.). Cookies can be created by a webserver hosting a website (e.g., first-party cookies) or webservers different from a hosting webserver (e.g., third-party cookies). For instance, third-party cookies can include cookies associated with advertisements provided within a website. Therefore, visiting a website can result in multiple cookies being downloaded to a user's device. This enables parties unaffiliated with a user to nevertheless capture information associated with the user such as a user's search history, purchase history, and other personal information. There is a need for “cookie-less” data gathering and communication techniques that enable affiliated parties to collect and use information associated with a user, while preventing the release of such information to parties unaffiliated with the user.

### SUMMARY

Aspects and advantages of embodiments of the present disclosure will be set forth in part in the following description, or can be learned from the description, or can be learned through practice of the embodiments.

An example aspect of the present disclosure includes a computer-implemented method. The method includes receiving, by a first party computing system comprising one or more computing devices, contextual data associated with a first party user and at least one item. The contextual data is indicative of a physical interaction between the first party user and the at least one item. The method includes determining, by the first party computing system, an item interest level for the at least one item based, at least in part, on the contextual data. The method includes initiating, by the first party computing system, a presentation of a content item to the first party user via a user device associated with the first party user based, at least in part, on the item interest level for the at least one item. The content item includes information for the at least one item.

Another example aspect of the present disclosure includes a first party computing system including one or more processors and a memory storing instructions that when executed by the one or more processors cause the first party computing system to perform operations. The operations include receiving contextual data associated with a first party user and at least one item. The contextual data is indicative of a physical interaction between the first party user and the at least one item. The operations include determining an item interest level for the at least one item based, at least in part, on the contextual data. The operations include initiating a presentation of a content item to the first party user via a user device associated with the first party user based, at least in part, on the item interest level for the at least one item. The content item comprises information for the at least one item.

Yet another example aspect of the present disclosure includes one or more non-transitory computer-readable media including instructions that when executed by one or more computing devices cause the one or more computing devices to perform operations. The operations include receiving contextual data associated with a first party user and at least one item. The contextual data is indicative of a physical interaction between the first party user and the at least one item. The operations include determining an item interest level for the at least one item based, at least in part, on the contextual data. The operations include initiating a presentation of a content item to the first party user via a user device associated with the first party user based, at least in part, on the item interest level for the at least one item. The content item includes information for the at least one item.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a data gathering technique using digital cookies that can be replaced by example aspects of the present disclosure;

FIG. 1B depicts a communication technique for transferring data in a privacy conscious, cookie-less manner according to example aspects of the present disclosure;

FIG. 1C depicts an example application of a privacy conscious communication technique for providing an advertisement in an information-poor circumstance according to example aspects of the present disclosure;

FIG. 2A depicts a secure, multi-platform marketing system according to example aspects of the present disclosure;

FIG. 2B depicts an example marketing environment according to example aspects of the present disclosure;

FIG. 3 depicts an example customer journey according to example aspects of the present disclosure;

FIG. 4 depicts an example inventory-aware messaging scenario according to example aspects of the present disclosure;

FIG. 5 depicts an example multi-party ecosystem according to example aspects of the present disclosure;

FIG. 6 depicts an example physical location according to example aspects of the present disclosure;

FIG. 7 depicts an example market analytics cloud computing platform according to example aspects of the present disclosure;

FIG. 8 depicts an example market analytics cloud computing platform user interface according to example aspects of the present disclosure;

FIG. 9 depicts an example physical to digital scenario according to example aspects of the present disclosure;

FIG. 10 depicts an example environment for utilizing physical signals according to example aspects of the present disclosure;

FIG. 11A depicts an example block diagram for generating a privacy conscious communication via a user device according to example aspects of the present disclosure;

FIG. 11B depicts an example block diagram for referencing a first party user based on a privacy conscious communication according to example aspects of the present disclosure;

FIG. 12 depicts an example block diagram for generating a privacy conscious communication for a third party according to example aspects of the present disclosure;

FIG. 13 depicts an example block diagram for referencing third party users based on a privacy conscious communication according to example aspects of the present disclosure;

FIG. 14 depicts an example method for providing privacy conscious advertisements based on physical signals according to example aspects of the present disclosure;

FIG. 15 depicts an example method for object specific audience servicing according to example aspects of the present disclosure;

FIG. 16 depicts an example method for mobile device tracking at point of interest according to example aspects of the present disclosure;

FIG. 17 depicts an example method for inferring user intent based on physical signals according to example aspects of the present disclosure;

FIG. 18 depicts example components of an example computing system according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved, privacy conscious, and insight driven customer engagement through an intermediary marketing platform. For instance, the present disclosure is directed to an intermediary marketing platform capable of securely connecting merchants and marketers to their customers such that merchants/marketers are able to gain relevant insights for their customers in a privacy conscious manner. Specifically, the intermediary marketing platform enables the secure collection and transfer of customer information descriptive of physical interactions between customers and products offered for sale by the merchant/marketers within physical locations maintained, owned, and/or otherwise utilized by the merchant/marketer to physically display their products.

A physical location such as a brick and mortar store can, for example, be outfitted with a number of sensors configured to observe interactions between a customer within the physical location and products placed on display therein. The sensors can record physical signals descriptive of customer interactions and provide the data to the intermediary marketing platform. At times, the physical information can be forwarded to a customer's device (e.g., a mobile phone, etc.) and provided to the intermediary marketing platform therefrom. For instance, the sensors can transmit radio broadcasts that can be received by a customer's device as the device approaches a threshold distance from a respective sensor. The sensors can be placed relative to a number of products placed on display within the physical location such that the reception of a respective radio broadcast can identify a closeness and/or interaction with a respective product. The customer's device can receive various radio broadcasts as the customer moves throughout a physical location and selectively provide physical information indicative of the received broadcasts to the intermediary marketing platform.

The physical information can be collected by the intermediary marketing platform through secure communications with sensors or customer devices that hide the respective identities of associated customers. To do so, a sensor or customer device can apply a hashing function to a user identifier corresponding to a respective customer to create an indecipherable hashed user identifier. The hashed user identifier can include an unintelligible string of numbers, letters, and/or symbols that cannot be reverse engineered by another party. The physical information can be provided to the intermediary marketing platform along with the hashed user identifier. The intermediary marketing platform can reference the respective customer corresponding to the hashed identifier by applying the same hashing function (e.g., used to hash the user identifier) to each of a number of user identifiers accessible to the intermediary marketing platform. By applying the same hashing function, the intermediary marketing platform can produce the same hashed identifier generated by the sensor/customer device when hashing the same information as the sensor/customer device. In this manner, the intermediary marketing platform can generate a hashed identifier that matches the received hashed user identifier in the event that a respective customer has previously provided a user identifier to the merchant/marketer. The customer associated with the received physical information can be referenced based on the matching identifier.

The intermediary marketing platform can determine insights for its customers based on physical information corresponding thereto. The insights can be descriptive of an item interest level for an item placed on display by a merchant/marketer within the physical location. In such a case, the intermediary marketing platform can initiate the presentation of an advertisement to the customer via the customer's device across a number of different marketing channels accessible to the customer's device. For instance, the intermediary marketing platform can provide a personalized message to the customer's device through a merchant/marketer software application executed by the customer's device and/or initiate the presentation of the personalized message through a number of third party advertisement platforms. In this regard, the intermediary marketing platform can leverage the secure communication techniques (e.g., hashed user identifiers) described herein, to enable the secure transfer of customer information obtained firsthand by merchants/marketers (e.g., through a customer's physical interaction with a product) to third party advertisement platforms without revealing the identity of the merchant/marketer's customers. For instance, the intermediary marketing platform can provide a hashed list of customer identifiers to a recipient party, the recipient party can hash all user identifiers accessible to the recipient, and then match the hashed identifier to the received identifier to reference users of the recipient's platform. The information can be leveraged by various advertising platforms that have previously received user identifiers from affiliated customers to provide personalized messages to their affiliated customers through multiple channels operated by the platforms such as, for example, search browser interfaces, multimedia interfaces, social media platforms, etc. The personalized messages can be provided to customers (and/or potential customers) of the merchant/marketer while the customers are physically located within a brick and mortar store maintained, owned, and/or otherwise utilized by the merchant/marketer to physically display their products.

With reference now to the figures, example aspects of the present disclosure will be discussed in greater detail.

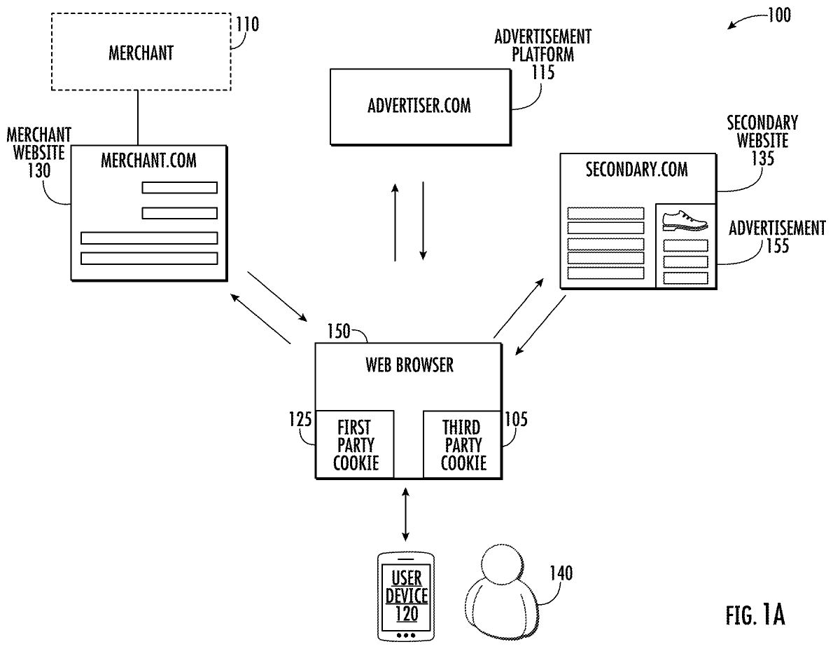

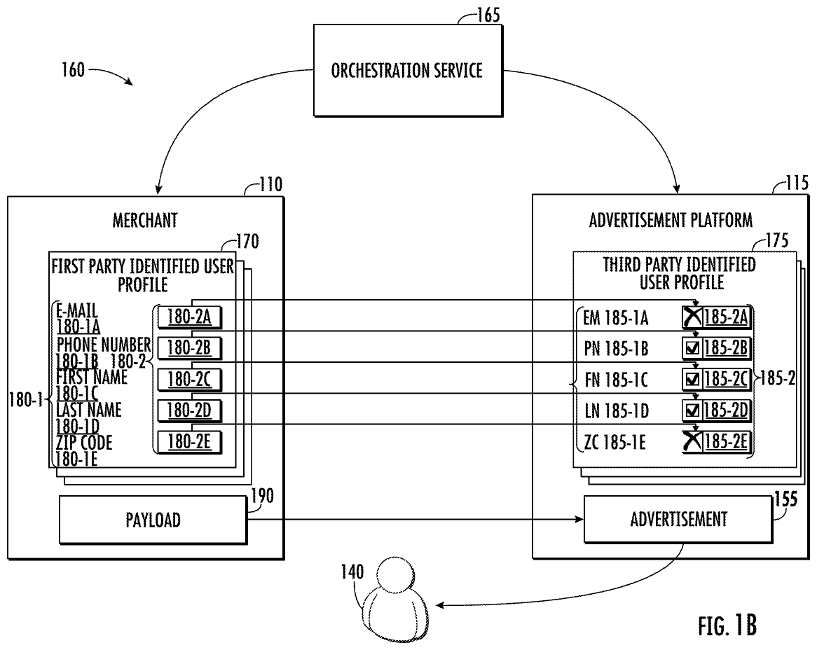

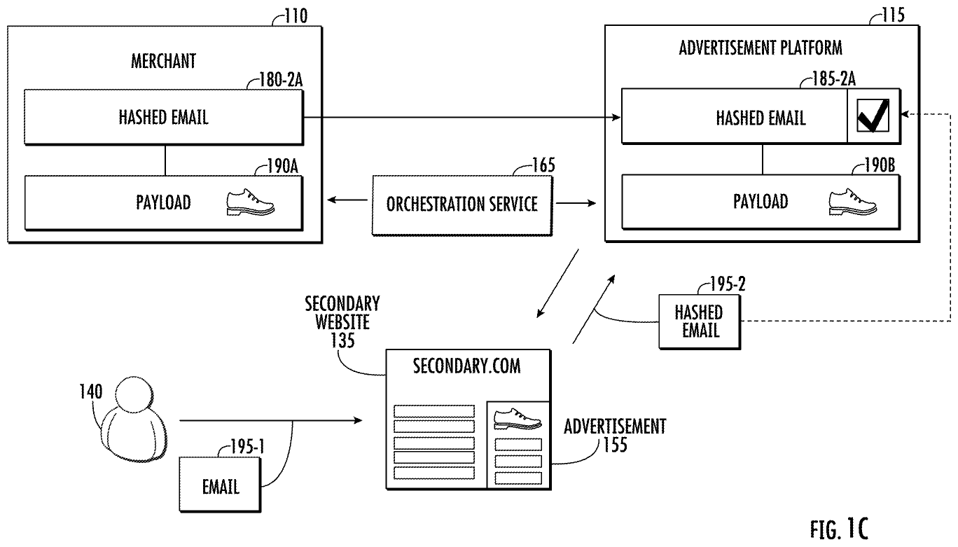

FIG. 1A depicts a data gathering technique 100 using digital cookies that can be replaced by example aspects of the present disclosure. The data gathering techniques 100 involve using a third-party cookie 105 to collect information related to an interaction between a customer 140 and a merchant 110. The term customer 140 is used to describe any person (or entity) that interacts with a merchant 110 to buy, browse for, and/or otherwise interact with products or services offered by the merchant 110. The customer 140 can include a person (or entity such as an organization) that buys products or services from the merchant 110 or potential customers that have shown an interest in the merchant 110 or products/services offered by the merchant 110. The term merchant 110 describes any entity involved in the supply of products or services to customers. The merchant 110 can include a product manufacturer, retailer, distributor, designer, publisher, etc. that creates and/or offers for sale products and/or services to customers such as, for example, customer 140. To do so, the merchant 110 can host and/or otherwise be affiliated with a merchant website 130 (e.g., “merchant.com”) that includes product/service information and/or offers a number of products, services, etc. for sale to the customer 140. By way of example, the merchant 110 can include a shoe retailer that hosts a merchant website 130 providing information and enabling the customer 140 to purchase shoes and other related merchandise from the merchant 110.

The data gathering techniques 100 illustrate a scenario in which an advertisement platform 115 leverages a third-party cookie 105 to indirectly obtain customer information for the customer 140 from the customer's digital interaction with the merchant website 130 to create an advertisement 155 personalized to the customer 140. An advertisement platform 115 can be any entity that collaborates with the merchant 110 to advertise the merchant's products or services to the customer 140. The advertisement platform 115 can do so in a variety of ways using different marketing channels including, for example, website interfaces, multimedia interfaces, social media platforms, etc. One example of a marketing channel can include an advertising website (e.g., “advertiser.com”) hosted and/or otherwise affiliated with the advertisement platform 115. As another example, a marketing channel can include one or more secondary website(s) 135 (e.g., “secondary.com”) through which the advertisement platform 115 can host advertisement(s) 155. The secondary website 135, for example, can include a social media website, a news outlet's website, a blog repository, or another content provider accessible to the customer 140.

The advertisement platform 115 typically does not sell products directly to the customer 140 and does not have access to firsthand customer information, such as transaction records, that could be helpful in providing personalized advertisements 155 to the customer 140. Due to concerns with revealing private information of its customers, the merchant 110 may be reluctant to provide such information to the advertisement platform 115 as customer information can include intimate details for the customer 140. Moreover, if communicated without taking proper security measures, communications with intimate details for the customer 140 could be intercepted by malicious parties allowing unintended recipients of a communication to gain personal insights for the customer 140. To compensate for the advertisement platform's lack of firsthand knowledge of the customer 140, the advertisement platform 115 can gain insights for the customer 140 by recording digital signals across a number of websites using third-party cookies 105.

By way of example, the customer 140 can interact with the merchant 110 by browsing the merchant's products or services through a merchant website 130. To do so, the customer 140 can execute a web browser 150 on the customer's personal device 120. The customer 140 can select the merchant website 130 from a list of search results provided by the web browser 150. In response, the web browser 150 can issue a request to a host webserver that hosts the merchant website 130 for information (e.g., HTML, CSS, JavaScript code, etc.) to render the merchant webpage 130 for the customer 140. If the web browser 150 has been previously used to access the merchant website 130, the request to the host webserver can include a first-party cookie 125 associated with the host webserver. The first-party cookie 125 includes a text file stored on the user device 120. The text file includes a name-value pair that identifies a first-party unique identifier for the customer 140 in association with the host webserver (e.g., a domain name). The first-party cookie 125 can be set by the host webserver the first time the customer 140 accesses the merchant website 130 using the web browser 150. Each time the web browser 150 issues a request to the domain associated with the first-party cookie 125, it will pass the first-party cookie 125 to the host webserver. In the event that the host webserver does not receive a first-party cookie 125 associated with the host webserver in a request for the merchant website 130, the host webserver can generate the first-party cookie 125 and can respond to the web browser 150 with information for rendering the merchant website 130 and a request to store the first-party cookie 125 in memory on the user device 120. The first-party cookie 125 can be stored on the user device 120 if granted permission by the user device 120 (and/or web browser 150).

When the web browser 150 issues another request to the host webserver, the web browser 150 can look up the first-party cookie 125 associated with the merchant website 130 and include the first-party cookie 125 in the request to the host webserver. In this way, the customer 140 can send the same first-party cookie 125 each time the customer 140 initiates another request to the host webserver by interacting with the merchant website 130. For instance, a new request can be issued when the customer 140 clicks on a product displayed by the merchant website 130. The new request can request information for rendering a webpage of the merchant website 130 associated with the selected product. Each time a new request is provided to the host webserver, the host webserver can store information provided by the request (e.g., that the customer 140 selected a particular product, etc.) in server memory and map the information to the first-party unique identifier of the first-party cookie 125. In addition, or alternatively, customer information for the customer 140 (e.g., that the customer selected the particular product, looked at a particular product for an extended time period, etc.) can be stored directly in the first-party cookie 125. In such a case, the web browser 150 can provide customer information for the customer 140 to the host webserver by providing the first-party cookie 125 to the host webserver with each request to the host webserver.

In this way, when the customer 140 returns to the merchant website 130, through the web browser 150, and the web browser 150 provides the first-party cookie 125 to the host webserver, the host webserver can access information associated with the customer's previous interactions with the merchant website 130 (e.g., by looking up information mapped to the first-party cookie 125, by obtaining the information directly from the first-party cookie 125 in the request, etc.) and provide information for rendering a personalized merchant website to the customer 140 based on the customer's previous interactions. This can include, for example, automatically entering customer credentials (e.g., a username, password, etc.) stored in association with the first-party cookie 125, providing personalized product recommendations based on product interests stored in association with the first-party cookie 125, etc.

The advertisement platform 115 can gain information for the customer 140 based on the customer's digital interactions with the merchant website 130 using a third-party cookie 105. The third-party cookie 105, for example, can include another text file stored on the user device 120 (e.g., if permitted by the user device 120 and/or web browser 150) that includes another name-value pair that identifies a third-party unique identifier for the customer 140 in association with the advertisement platform 115 (e.g., a domain name associated with the advertisement platform 115). The third-party cookie 105 can be used to record digital interactions between the customer 140 and website(s) that are not hosted by the advertisement platform 115. The third-party cookie 105, for example, can be retrieved by the advertisement platform 115 across a number of different websites that are not hosted by the advertisement platform 115 to record the customer's digital interactions with each of the number of different websites.

By way of example, the third-party cookie 105 can be set and/or retrieved by the advertisement platform 115 when the customer 140 uses the web browser 150 to access the merchant website 130. For instance, the web browser 150 can issue a request to the host webserver of the merchant website 130 as described herein. The host webserver can receive the request and respond with information to render the merchant website 130 and instructions to send a request to the advertisement platform 115. The instructions can redirect the web browser 150 to a third-party website (e.g., “advertiser.com”) affiliated with the advertisement platform 115 to allow the advertisement platform 115 to set and/or retrieve the third-party cookie 105. In other examples, the merchant website 130 may itself provide third-party cookie 105 to web browser 150.

For instance, the web browser 150 can issue a request to the advertisement platform 115 by retrieving any third-party cookie 105 associated with the advertisement platform 115 and providing the third-party cookie 105 to the advertisement platform 115. If the request to the advertisement platform 115 does not include a third-party cookie 105, the advertisement platform 115 can respond to the request with a request to set the third-party cookie 105. Once the third-party cookie 105 is set on the web browser 150, any future request from the web browser 150 to the advertisement platform 115 can include the third-party cookie 105 and information associated with the request such as, for example, the website (or specific webpage) in which the request was redirected from (e.g., the merchant website 130), an advertisement clicked on by the customer 140, etc. Each time a new request is provided to the advertisement platform 115, the advertisement platform 115 can store customer information provided by the request (e.g., that the customer 140 selected a particular product at the merchant website 130, etc.) in server memory and map the information to the third-party unique identifier of the third-party cookie 105. In addition, or alternatively, and as stated with respect to the first-party cookie 125, customer information associated with the customer 140 can be stored directly in the third-party cookie 105 and retrieved each time another request is issued to the advertisement platform 115.

The advertisement platform 115 can use information stored in association with the third-party cookie 105 to provide personalized advertisements 155 to the customer 140 when the customer 140 visits a secondary website 135 (e.g., “secondary.com”). For example, the secondary website 135 can include space for rendering third-party content such as the advertisement 155. In such a case, the information for rendering the secondary website 135 can include instructions for requesting third-party information from the advertisement platform 115. The web browser 150 can receive the instructions and issue a request to the advertisement platform 115 that includes the third-party cookie 105. The advertisement platform 115 can access information associated with the customer's previous interactions with affiliated websites, such as the merchant website 130, that initiate requests to the advertisement platform 115 (e.g., by looking up information mapped to the third-party cookie 105, by obtaining the information directly from the third-party cookie 105, etc.) and provide information for rendering a personalized advertisement 155 within the secondary website 135 based on the customer's previous interactions. This can include, for example, providing personalized product recommendations based on product interests determined by indirectly recording the customer's interactions with the merchant website 130 using the third-party cookie 105.

In the example of FIG. 1A, the merchant 110 is affiliated with the customer 140, because the customer 140 has made a conscious decision to visit the merchant web site 130 and interact with it. In contrast, no such affiliation exists between the advertisement platform 115 and the customer 140. While helpful for marketing purposes, third-party cookies 105 can be intrusive and present privacy risks to the customer 140 because they can be set by parties, such as advertisement platform 115, unaffiliated with the customer 140. Third-party cookies can also be unreliable and provide different insights for the customer 140 depending on where the third-party cookies 105 are used. In addition, the efficacy of any cookie can be eliminated at any time by deleting the cookie from a web browser, thereby resetting the customer information available to an advertiser. This results in cookie-based advertisements that can be inconsistent and, in some cases, irrelevant for the customer 140. The technology of the present disclosure can enable the merchant 110 and the advertisement platform 115 to determine and securely distribute insights corresponding to the customer 140 without the use of cookies (e.g., first-party cookie 125 or third-party cookie 105) or other digital signals that record the customer's internet activity.

FIG. 1B depicts a communication technique 160 for transferring data in a privacy conscious, cookie-less manner according to example aspects of the present disclosure. The communication technique 160 can replace the data gathering techniques 100 of FIG. 1A by enabling the merchant 110 to provide customer information obtained directly from the customer 140 to the advertisement platform 115 without exposing personal details of the customer 140 to the advertisement platform 115. The communication technique 160 involves drawing inferences for the customer 140 by matching indecipherable hashes (e.g., hashed user information attribute(s) 180-2, 185-2) of individual customer identifiers (e.g., user information attribute(s) 180-1, 185-1) independently obtained from the customer 140 by the merchant 110 and the advertisement platform 115.

User information attribute(s) 180-1, 185-1 can include units of information that uniquely identify, by themselves or in combination with other user information attributes 180-1, 185-1, the customer 140. Examples include email addresses 180-1A, 185-1A, phone numbers 180-1B, 185-1B, first names 180-1C, 185-1C, last names 180-1D, 185-1D, zip codes 180-1E, 185-1E, IP addresses, credit card numbers, billing addresses, usernames, or any other attributes at least partially unique to the customer 140. Certain user information attributes 180-1, 185-1 can uniquely identify the customer 140 by themselves, while others can be combined to identify the customer 140 within a reasonable certainty. For instance, an email address 180-1A, 185-1A or a phone number 180-1B, 185-1B used by the customer 140 can uniquely identify the customer 140, whereas a first name 180-1C, 185-1C can be combined with a last name 180-1D, 185-1D and zip code 180-1E, 185-1E to uniquely identify the customer 140. In some implementations, each user information attribute 180-1, 185-1 can be associated with a confidence level indicative of a confidence in the identity of the customer 140. In such a case, the customer 140 can be identified in the event that a number of user information attributes 180-1, 185-1 obtained for the customer 140 achieve a threshold confidence level.

The merchant 110 and the advertisement platform 115 can independently interact with the customer 140 to obtain user information attributes 180-1, 185-1, respectively. For example, the merchant 110 can collect first-party user information attributes 180-1 from the customer 140 through the course of providing a product, service, or information thereof to the customer 140. As an example, the customer 140 can provide a first-party email 180-1A or a first-party phone number 180-1B to the merchant 110 to sign up for a subscription service, to receive a discount, etc. As another example, the customer 140 can provide user information attributes 180-1 to the merchant while buying a product from the merchant 110. For instance, the customer 140 can pay for the product using a credit card and, to verify the purchase, provide a first-party first name 180-1C, a first-party last name 180-1D, and/or a first-party zip code 180-1E. In some implementations, the customer 140 can create a user account with the merchant 110 and provide the first-party user information attributes 180-1 during the creation of the user account. The merchant 110 can obtain the first-party user information attributes 180-1 in any of a plurality of scenarios, a person of ordinary skill in the art would understand that the examples provided herein are just a few of the possible scenarios.

Separately and independently from the merchant 110, and based on its own, separate affiliation with customer 140, the advertisement platform 115 can interact with the customer 140 and, in the course of providing its own separate services, will obtain third-party user information attributes 185-1. For instance, the advertisement platform 115 can be associated with a service that encourages user engagement. By way of example, the advertisement platform 115 can include a social media platform that allows the customer 140 to create an account to engage with users of the social media platform. As another example, the advertisement platform 115 can include a search browser that enables the customer 140 to create an account to seamlessly search the internet. During the creation of an account, the customer 140 can provide a third-party email address 185-1A, a third-party phone number 185-1B, a third-party first name 185-1C, a third-party last name 185-1D, a third-party zip code 185-1E, and/or any other information. As another example, the advertisement platform 115 can include a service that allows the customer 140 to view and/or purchase media content. The customer 140 can provide the customer's third-party email address 185-1A, third-party phone number 185-1B, third-party first name 185-1C, third-party last name 185-1D, third-party zip code 185-1E, and/or any other information to the advertisement platform 115 while viewing and/or purchasing media content. The advertisement platform 115 can include any number of different platforms and/or advertisement entities and can obtain the third-party user information attributes 185-1 in any of a plurality of scenarios. A person of ordinary skill in the art would understand that the examples provided herein are just a few of the possible scenarios.

It should be noted that the customer 140 can independently provide different user information attributes 180-1, 185-1 to the merchant 110 and the advertisement platform 115. For example, the customer 140 can provide a junk first-party email address 180-1A, phone number 180-1B, first name 180-1C, last name 180-1D, or zip code 180-1E to the merchant 110 in order to receive an incentive without receiving merchant promotions. As another example, the customer 140 can provide a fake third-party email address 185-1A to the advertisement platform 115 to anonymously sign up with the advertisement platform 115. The customer 140 can provide any combination of fake, real, or junk information to one or both of the merchant 110 and the advertisement platform 115 without nullifying the effectiveness of the communication technique 160.

The merchant 110 can generate a first-party identified user profile 170 based on the user information attributes 180-1 (e.g., whether real or fake) obtained for the customer 140. The first-party identified user profile 170 can be a collection of first-party user information attributes 180-1 collected for the customer 140. The collection of first-party user information attributes 180-1 can include a plurality of units of information provided by the customer 140 to the merchant 110 that bear at least some measure of uniqueness. The merchant 110 can create a respective first-party identified user profile for each of a plurality of customers and/or potential customers that have provided uniquely identifiable information (e.g., user information attributes 180-1) to the merchant 110.

The advertisement platform 115 can generate a third-party identified user profile 175 based on the user information attributes 185-1 (e.g., whether real or fake) obtained for the customer 140. The third-party identified user profile 175 can be a collection of third-party user information attributes 185-1 collected for the customer 140. The collection of third-party user information attributes 185-1 can include a plurality of units of information provided by the customer 140 to the advertisement platform 115 that bear at least some measure of uniqueness. The advertisement platform 115 can create a respective third-party identified user profile for each of a plurality of users (such as the customer 140) that have provided uniquely identifiable information (e.g., user information attributes 185-1) to the advertisement platform 115.

The merchant 110 can obtain first-party information for a first-party identified user profile 170 that corresponds to the customer 140. The first-party information can include customer insight data and product information collected by the merchant 110 from the customer 140 during the course of developing, selling, and/or providing maintenance for products to a number of customers. The customer insight data for the customer 140, for example, can include profile information such as one or more account preferences, transactional information such as transaction records between the customer 140 and the merchant 110, product preferences/interests exhibited by the customer 140 to the merchant 110 (e.g., through customer service requests, etc.), interaction data descriptive of physical interactions (e.g., recorded by sensors within a store associated with the merchant 110, as described further elsewhere in the instant disclosure) between the customer 140 and a product offered by the merchant 110, and/or any other information associated with and obtained firsthand from the customer 140. By way of example, the customer 140 can request information for a particular product from the merchant 110 through a merchant website 130, by emailing the merchant 110, calling the merchant 110, and/or otherwise interacting with the merchant 110. The merchant 110 can record this information (e.g., the customer's interest in the particular product) as customer insight data.

The merchant 110 can generate a payload 190 for the first-party identified user profile 170 corresponding to the customer 140. The payload 190 can include information (and/or insights thereof) for the customer 140 that enables the advertisement platform 115 to provide a personalized advertisement 155 to the customer 140. For instance, the payload 190 can include at least a portion of customer insight data collected for the customer 140. The payload 190, for example, can be indicative of a product interest level, a recently purchased product, a likelihood to purchase a product from the merchant 110, and/or any other information for personalizing the advertisement 155 for the customer 140. As one example, the payload 190 can include an insight for the customer 140 that indicates that the customer 140 has an interest in purchasing the particular product from the merchant 110. In such a case, the personalized advertisement 155 can include information associated with the particular product (e.g., a running shoe) and/or products associated with the particular product (e.g., running socks, water bottles, etc.). As described in further detail herein, in some implementations, the merchant 110 can utilize one or more tools of a market intelligence service to determine one or more customer insights for the customer 140 based on contextual information. These and other insights can be provided as payloads to the advertisement platform 115.

The merchant 110 can send the payload 190 associated with the customer 140 to the advertisement platform 115 along with information for inferring a third-party identity of the customer 140 (e.g., if the advertisement platform 115 is already associated with the customer 140). The information, for example, can include one or more independently hashed user information attributes 180-2 of the first-party identified user profile 170 corresponding to the customer 140. The one or more independently hashed user information attributes 180-2 can be created by hashing one or more of the user information attributes 180-1 according to one or more standards provided by an orchestration service 165.

The orchestration service 165, for example, can be an entity that develops and distributes communication standards for the privacy conscious delivery of information between two parties such as the merchant 110 and the advertisement platform 115. In some implementations, the orchestration service 165 can be provided by the merchant 110 and/or the advertisement platform 115. For instance, the merchant 110 and/or advertisement platform 115 can develop secure communication standards and provide the standards to the other party. In addition, or alternatively, the orchestration service 165 can be an intermediate platform such as a marketing intelligence platform and/or any other entity unaffiliated with the merchant 110 and the advertisement platform 115. In such a case, the orchestration service 165 can develop and provide communication standards to both the merchant 110 and the advertisement platform 115.

The communication standards for the privacy conscious delivery and interpretation of information by two entities can include one or more cryptographic techniques and/or messaging formats. The cryptographic techniques, for example, can include applying a particular hash function to one or more of the user information attributes 180-1, 185-1 available for the customer 140. Such a hashing technique can provide that each user information attribute is hashed individually in some examples, not in combinations. The orchestration service 165 can determine standards that identify which user information attributes 180-1, 185-1 to individually hash and a particular cryptographic hash function to apply to each of the determined user information attributes 180-1, 185-1. In addition, or alternatively, the standards can define a messaging format that identifies an order in which to communicate first-party hashed user information attributes 180-2 and/or one or more spacing, tagging, etc. rules for communicating the first-party hashed user information attributes 180-2. The messaging format, for example, can enable a recipient of a communication including multiple first-party hashed user information attributes 180-2 to identify where a particular hashed user information attribute is located (e.g., where the hash begins and/or ends, etc.) within the communication. The orchestration service 165 can provide the communication standards for the privacy conscious delivery and interpretation of information to both the merchant 110 and the advertisement platform 115.

The orchestration service 165 can develop the communication standards by determining and/or selecting a particular hash function to apply to each of the user information attributes 180-1, 185-1. The hash function can include any type of hashing algorithm such as, for example, at least one of a message digest algorithm (e.g., MD5), secure hash algorithm (e.g., SHA-0, SHA-1, SHA-2, etc.), etc. As one particular example, the orchestration service 165 can determine and/or select SHA-1 as the hash function. In some implementations, the hash function can be selected from a predetermined list of hash functions (e.g., including SHA-1, etc.). The hash function can take a user information attribute 180-1, 185-1 (e.g., a message) as an input and produce a fixed length hashed value 180-2, 185-2 (e.g., a digest). The resulting hashed user information attribute 180-2, 185-2, for example, can include a 20 byte value represented as a hexadecimal, forty digit long number. The hash function can produce a distinct hash value for each unique input. In this way, the same input to a selected hash function can consistently result in the same hash output.

The orchestration service 165 can provide the hash function to each of the merchant 110 and the advertisement platform 115. In some implementations, the orchestration service 165 can periodically change the hash function. For example, the orchestration service 165 can determine (and/or select from predetermined list of hash functions) a new hash function at a predetermined time interval (e.g., one or more minutes, hours, days, weeks, etc.). In some implementations, the orchestration service 165 can dynamically determine the hash function based on one or more factors. For example, the orchestration service 165 can determine a new hash function in response to the detection of a lack of security of a particular hash function, etc. The orchestration service 165 can provide the determined hash function to each of the parties (merchant 110, advertisement platform 115) each time a new hash function is determined. In addition, or alternatively, the orchestration service 165 can provide a timetable and/or other standard for allowing the merchant 110 and/or advertisement platform 115 to determine the particular hash function to use based on the time, day, and/or any other factors. As still another alternative that is within the scope of the present teachings, the orchestration service 165 can perform the actual hashing operation itself as a hashing service provided to clients such as the merchant 110 and/or the advertisement platform 115. By receiving unhashed data elements from the clients and sending back the hashed versions thereof in real time, the orchestration service 165 could avoid any need for sharing the nature or parameters of the hashing function, keeping the overall system that much more secure.

In some implementations, the orchestration service 165 can identify one or more types of user information attributes 180-1, 185-1 to hash and/or a confidence level associated with each of the identified user information attribute types. For instance, the orchestration service 165 can identify a subset of the available user information attributes for the customer 140 to hash. The subset of the available user information attributes can include, for example, an email user information attribute 180-1A, 185-1A, a phone number user information attribute 180-1B, 185-1B, a first name user information attribute 180-1C, 185-1C, a last name user information attribute 180-1D, 185-1D, and/or a zip code user information attribute 180-1E, 185-1E. Other examples can include an IP address, a billing address, a username, a credit card number, and/or any other attribute that can uniquely identify a person (and/or entity) such as the customer 140.

The orchestration service 165 can determine and/or assign a confidence level associated with each of the identified user information attribute types. The confidence level can be a measure of the uniqueness of a particular user information attribute type. For instance, an email user information attribute 180-1A, 185-1A can include a distinct email address typically associated with a single user (e.g., owner) and can therefore be assigned a high confidence level (e.g., 90% confidence of uniquely identifying the customer 140). A phone number user information attribute 180-1B, 185-1B can also include a distinct number typically only associated with a single user; however, historical data may indicate that a phone number user information attribute 180-1B, 185-1B has a higher likelihood of being fake relative to an email address user information attribute 180-1A, 185-1A. Accordingly, the orchestration service 165 can assign the phone number 180-1B, 185-1B a high confidence level (e.g., 85% confidence of uniquely identifying the customer 140) that is lower than the confidence level assigned to the email user information attribute 180-1A, 185-1A. As another example, a first name user information attribute 180-1C, 185-1C, a last name user information attribute 180-1D, 185-1D, and/or a zip code user information attribute 180-1E, 180-1E can be associated with multiple different individuals and therefore offer a low probability of uniquely identifying the customer 140 by themselves. However, a combination of the three 180-1C-E, 185-1C-E can increase the chances of uniquely identifying the customer 140. Therefore, the orchestration service 165 can assign a low confidence level (e.g., a 20% confidence of uniquely identifying the customer 140) to each individual user information attribute 180-1C-E, 185-1C-E and medium confidence level (e.g., a 60% confidence of uniquely identifying the customer 140) to a combination of the user information attributes 180-1C-E, 185-1C-E.

The orchestration service 165 can provide an indication of which user information attribute types to hash and/or the confidence levels associated with each of the indicated user information attribute types to each of the merchant 110 and the advertisement platform 115. In some implementations, the orchestration service 165 can periodically change the identified user information attribute types and/or confidence levels thereof. For example, the orchestration service 165 can determine a new subset of user information attribute types at a predetermined time interval (e.g., one or more minutes, hours, days, weeks, etc.). In some implementations, the orchestration service 165 can dynamically determine the new subset of user information attribute types based on one or more factors. For example, the orchestration service 165 can identify a new set of user information attribute types and/or adjust confidence levels corresponding to the subset of user information attribute types in response to the detection of a lack of security, reliability, etc. of a particular user information attribute type (e.g., based on historical data, real-time data, etc.). The orchestration service 165 can provide an indication of the new subset of user information attribute types to each of the parties (e.g., merchant 110, advertisement platform 115) each time the subset of user information attribute types are updated. In addition, or alternatively, the orchestration service 165 can provide a timetable and/or other standard for allowing the merchant 110 and/or advertisement platform 115 to determine the subset of user information attribute types to hash based on the time, day, and/or any other factor.

The merchant 110 can generate first-party hashed user information attributes 180-2 for each of the user information attributes 180-1 of the first-party identified user profile 170 corresponding to the customer 140 in accordance with the standards provided by the orchestration service 165. For instance, the merchant 110 can apply the hash function (e.g., determined by the orchestration service 165) individually to each of the user information attributes 180-1 (e.g., of a type indicated by the orchestration service 165) collected for the customer 140 to generate a respective first-party hashed user information attribute 180-2 corresponding to each of the user information attributes 180-1. The merchant 110 can store the resulting first-party hashed user information attributes 180-2 in the first-party identified user profile 170 such that the first-party identified user profile 170 can include a collection of first-party hashed user information attributes 180-2 for the customer 140. In addition, or alternatively, the merchant 110 can dynamically generate the first-party hashed user information attributes 180-2 each time a communication for a third-party is created. The merchant 110 can send the one or more first-party hashed user information attributes 180-2 (e.g., newly generated, or previously stored) to the advertisement platform 115 along with the payload 190.

The advertisement platform 115 can receive the first-party hashed user information attributes 180-2 from the merchant 110 and attempt to match the first-party hashed user information attributes 180-2. For example, the advertisement platform 115 can independently hash (e.g., using the hash function determined by the orchestration service 165) each of a plurality of user information attributes (e.g., of a type indicated by the orchestration service 165, etc.) available to the advertisement platform 115 for each of a plurality of users associated with the advertisement platform 115. In the event that the customer 140 is independently affiliated with the advertisement platform 115, at least one of the user information attributes available to the advertisement platform 115 can correspond to the customer 140. The advertisement platform 115 can compare (e.g., using a text matching function, etc.) the indecipherable text of each of the first-party hashed user information attributes 180-2 received from the merchant 110 to the indecipherable text of each of the third-party hashed user information attributes 185-2 generated by the advertisement platform 115 to determine whether the advertisement platform 115 has access to a third-party hashed user information attribute 185-2 that matches (e.g., includes indecipherable text that matches) a first-party hashed user information attribute 180-2 received from the merchant 110.

By way of example, the advertisement platform 115 can generate third-party hashed user information attributes 185-2 for each of the user information attributes 185-1 of a plurality of third-party identified user profiles (e.g., including the third-party identified user profile 175 corresponding to the customer 140) in accordance with the standards provided by the orchestration service 165. For instance, the advertisement platform 115 can apply the hash function (e.g., determined by the orchestration service 165) individually to each of the user information attributes 185-1 (e.g., of a type indicated by the orchestration service 165) collected for each of the third-party identified user profiles to generate a respective third-party hashed user information attribute 185-2 corresponding to each third-party user information attribute 185-1. The advertisement platform 115 can store the resulting third-party hashed user information attributes 185-2 in a respective third-party identified user profile such that each third-party identified user profile (e.g., the third-party identified user profile 175) can include a collection of third-party hashed user information attributes 185-2 corresponding to a collection of third-party user information attributes 185-1 obtained from a respective user (e.g., the customer 140). In some implementations, the advertisement platform 115 can generate the third-party hashed user information attributes 185-2 for a respective third-party identified user profile 175 in response to receiving a communication including first-party hashed user information attributes 180-2.

The advertisement platform 115 can access a third-party identified user profile 175 for the customer 140 to determine whether at least one third-party hashed user information attribute 185-2 generated by the advertisement platform 115 matches a first-party hashed user information attribute 180-2 received from the merchant 110. The at least one third-party hashed user information attribute 185-2 can match the first-party hashed user information attribute 180-2 in the event that the indecipherable text of the at least one third-party hashed user information attribute 185-2 exactly matches the indecipherable text of the first-party hashed user information attribute 180-2. A partial match (e.g., matches between one or more but not all of the received first-party hashed user information attributes 180-2) can be sufficient to determine that the third-party identified user profile 175 for the customer 140 corresponds to a respective communication. For example, the third-party identified user profile 175 for the customer 140 can be determined to correspond to a communication even if a match is found for only one of a plurality of received first-party hashed user information attributes 180-2.

By way of example, the advertisement platform 115 can determine a set of hashed pairs. Each hashed pair of the set of hashed pairs can include a third-party hashed user information attribute 185-2 (e.g., generated by the advertisement platform 115) and a matching first-party hashed user information attribute 180-2 (e.g., received from the merchant 110). The matching first-party hashed user information attribute 180-2 of a hashed pair, for example, can include the exact same indecipherable text as the matching third-party hashed user information attribute 185-1. The advertisement platform 115 can determine whether a third-party identified user profile 175 for the customer 140 corresponds to a communication received from the merchant 110 based on the set of hashed pairs. For example, the advertisement platform 115 can determine that the third-party identified user profile 175 corresponds to a communication based on the particular user information attribute corresponding to each of the hashed pairs that are included in the set of hashed pairs. For instance, the advertisement platform 115 can determine the particular user information attribute 180-1, 185-1 corresponding to a respective hashed pair by identifying the input 185-1 used by the advertisement platform 115 to generate the third-party hashed user information attribute 185-2 of the respective hashed pair. In addition, or alternatively, the particular user information attribute 180-1, 185-1 can be determined by a position, spacing, and/or tag associated with the first-party hashed user information attribute 180-2 of the respective hashed pair (e.g., if provided for by the orchestration service 165).

In some implementations, the advertisement platform 115 can determine that the third-party identified user profile 175 corresponds to a communication based, at least in part, on a confidence level associated with the set of hashed pairs. For example, the advertisement platform 115 can identify each user information attribute 180-1, 185-1 corresponding to the set of hashed pairs. The advertisement platform 115 can determine a confidence level for the set of hashed pairs based on the confidence levels associated with each identified user information attribute 180-1, 185-1 (e.g., as provided for by the orchestration service 165). By way of example, the advertisement platform 115 can determine an aggregate confidence level for the set of hashed pairs by taking the maximum, average, minimum, median, etc. confidence level for each of the user information attributes 180-1, 185-1 corresponding to the set of hashed pairs. The advertisement platform 115 can determine that the third-party identified user profile 175 of the customer 140 corresponds to a communication from the merchant 110 in the event that the aggregate confidence level for the set of hashed pairs achieves a threshold confidence level (e.g., 50%, 75%, etc.).

In addition, or alternatively, the third-party identified user profile 175 for the customer 140 can be determined to correspond to the communication in the event that the set of hashed pairs include one or more allowed matches (e.g., as provided for by the orchestration service 165). By way of example, the orchestration service 165 can determine one or more allowed matches indicative of possible combinations of matching user information attributes 180-1, 185-1 sufficient to infer the identity of a unique individual (e.g., the customer 140). As one example, the allowed matches can include at least one of a primary match, a secondary match, and/or a tertiary match. The primary match can be indicative of matching email addresses 180-1A, 185-1A. The secondary match can be indicative of matching phone numbers 180-1B, 185-1B. The tertiary match can be indicative of a combination of matching first names 180-1C, 185-1C, matching last names 180-1D, 185-1D, and matching zip codes 180-1E, 185-1E. In this manner, a partial match (e.g., between only a subset of the available user information attributes) can be sufficient for the advertisement platform 115 to determine that the third-party identified user profile 175 for the customer 140 corresponds to the communication from the merchant 110.

For example, the merchant 110 can provide first-party hashed user information attributes 180-2A-E corresponding to a first-party email 180-1A, a first-party phone number 180-1B, a first-party first name 180-1C, a first-party last name 180-1D, and a first-party zip code 180-1E for the customer 140 to the advertisement platform 115. The advertisement platform 115 may independently have access to a third-party email address 185-1A, a third-party phone number 185-1B, a third-party first name 185-1C, and a third-party last name 185-1D for the customer 140. The advertisement platform 115 may not have access to a third-party zip code 185-1E. The advertisement platform 115 can generate third-party hashed information attributes 185-2A-D for the third-party email address 185-1A, the third-party phone number 185-1B, the third-party first name 185-1C, and the third-party last name 185-1D for the customer 140. In this example, the advertisement platform 115 does not have access to a third-party zip code 185-1E for the customer 140 and therefore can be unable to generate a hashed third-party zip code 185-2E.

The advertisement platform 115 can determine a set of hashed pairs, in the manner described herein, based on the first-party hashed user information attributes 180-2A-E received from the merchant 110. The set of hashed pairs can include a hashed pair corresponding to the third-party phone number 185-1B (e.g., including a matching first-party hashed phone number 180-2B and a third-party hashed phone number 185-2B), the third-party first name 185-1C (e.g., including a matching first-party hashed first name 180-2C and a third-party hashed first name 185-2C), and the third-party last name 185-1D (e.g., including a matching first-party hashed last name 180-2D and a third-party hashed last name 185-2D).

For instance, the customer 140 may have given a first-party email address 180-1A to the merchant 110 that is different than the third-party email address 185-1A given to the advertisement platform 115 causing the first-party hashed user information attribute 180-2A corresponding the first-party email address 180-1A to differ from the third-party hashed user information attribute 185-2A generated for the third-party email address 185-1A. In addition, or alternatively, the customer 140 may never provide a third-party zip code 185-1E to the advertisement platform 115 causing the advertisement platform 115 to fail to find a third-party hashed user information attribute 185-2E matching the first-party hashed user information attribute 180-2E corresponding to the first-party zip code 180-1E.

The advertisement platform 115 can determine that the set of hashed pairs include a secondary match (e.g., matching hashed phone numbers 180-2B, 185-2B) associated with a third-party information attribute, phone number 185-1B, of the third-party identified user profile 175. The advertisement platform 115 can determine that the third-party identified user profile 175 for the customer 140 corresponds to the communication from the merchant 110 based on the secondary match regardless of whether a match is found for the other hashed user information attributes 180-2A, -2C, -2D, -2E provided by the merchant 110.

As described herein, the third-party identified user profile 175 can include a collection of third-party user information attributes 185-1 (and/or corresponding third-party hashed user information attributes 185-2) collected for the customer 140. The collection of third-party user information attributes 185-1 can include the user information attributes 185-1 for the customer 140 that are independently available to the advertisement platform 115. For example, the third-party identified user profile 175 can include a username (and/or other profile information) for the customer 140 that uniquely identifies the customer 140 to the advertisement platform 115. In addition, or alternatively, the third-party identified user profile 175 can include device information independently provided to the advertisement platform 115 by the customer 140. In this manner, the advertisement platform 115 can associate the payload 190 provided by the merchant 110 with the customer 140 by inferring the customer's identity from hashed, indecipherable, customer information.

In some implementations, the advertisement platform 115 can add the unmatched first-party hashed user information attributes 180-2A, 180-2E to the third-party identified user profile 175. For example, the advertisement platform 115 can store each of the first-party hashed user information attributes 180-2A-E received from the merchant 110 to later match the third-party identified user profile 175 (and thereby infer the customer's identity) (e.g., until the hash function and/or user information attribute types are updated) to a communication provided by the merchant 110. In some implementations, the advertisement platform 115 can identify a user information attribute type associated with each unmatched first-party hashed user information attribute 180-2A, 180-2E based on one or more messaging formats identified by the orchestration service 165. It should be noted that, even in this scenario, the advertisement platform 115 would still be unable to identify the actual user information attribute of an unmatched hashed user information attribute.

The advertisement platform 115 can leverage the payload 190 provided by the merchant 110 to generate a personalized advertisement 155 for the customer 140 corresponding to the third-party identified user profile 175. In this way, a personalized advertisement 155 can be generated for the customer 140 by the advertisement platform 115 based on information (and/or insights thereof) collected by the merchant 110. The personalized advertisement 155, for example, can include information associated with the merchant 110, a product offered by the merchant 110 that the customer 140 has expressed interest in, etc. For example, the personalized advertisement 155 can include information for the particular product that the customer 140 expressed interest in through the merchant website 130, by emailing the merchant 110, calling the merchant 110, and/or otherwise interacting with the merchant 110. The personalized advertisement 155 can be provided to the customer 140 using one or more channels, platforms, etc. associated with the advertisement platform 115.

In this manner, the merchant 110 can determine and securely distribute insights (e.g., payloads 190) for the customer 140 without the use of cookies or other digital signals that track a customer's internet activity. Moreover, identifiable information (e.g., user information attributes 180-1) for the customer 140 can be hashed before distribution of customer information; thereby, preventing malicious parties or unaffiliated third parties from identifying the customer 140 associated with a respective insight. In this regard, each hashed user information attribute distributed to a third-party can include an indecipherable string of variables such that the recipient of a respective hashed user information attribute will be unable to use the hashed user information attribute to discover the user information attribute corresponding to the hash. Ultimately, this prevents the recipient from identifying the customer 140 referenced by the respective hashed user information attribute.

As discussed, in further detail herein, the merchant 110 can use the communication techniques 160 to hash individual user information attributes corresponding to a plurality of different customers associated with respective customer insight data (e.g., an interest in a similar product, etc.). In such a case, the merchant 110 can send one or more payload(s) 190 (e.g., with a portion of customer insight data for a respective insight) to the advertisement platform 115 along with a plurality of first-party hashed user information attributes (e.g., at least a first hashed user information attribute of a first first-party identified user profile and a second hashed user information attribute of a second first-party identified user profile) associated with the plurality of customers. The advertisement platform 115 can determine respective third-party identified user profiles corresponding to the communication based on the plurality of first-party hashed user information attributes (e.g., by matching indecipherable text of the respective first-party hashed user information attributes to the indecipherable text of respective third-party hashed user information attributes associated with the respective third-party identified user profiles) in the event that one or more of the plurality of customers that have independently provided a matching user information attribute to the advertisement platform 115. In this way, the merchant 110 can orchestrate group advertisement campaigns across a number of different advertisement platforms (e.g., including the advertisement platform 115) without disclosing its customer's private information.

While having other advantages relating to privacy and the elimination of third-party cookies, one particularly useful advantage of the communication technique 160 can be found in the ability for the advertisement platform 115 to provide potentially meaningful advertising content (e.g., personalized advertisement 155) even in extremely information-poor circumstances, where very little personally identifying information about the customer 140 is known or even cared about. The communication technique 160 can be thought of as a payload-centric, rather than an identity-centric, method for serving useful advertisements 155 by the advertisement platform 115. Provided only that there is enough information to associate the customer 140 with one or more previous payloads characterizing some particular action, trait, event, interest, etc., the advertisement platform 115 can still provide a meaningful advertisement 155 without ever needing to determine who the customer 140 actually is.

In this regard, FIG. 1C depicts an example application of the communication technique 160 for providing an advertisement 155 is an information-poor circumstance according to example aspects of the present disclosure. As depicted, the customer 140 can interact with a secondary website 135 (e.g., through web browser 150 or any other web browser) affiliated with the advertisement platform 115. During the course of the customer's interaction with the secondary website 135, the customer 140 can provide an email 195-1. By way of example, the secondary website 135 can offer access to a one-time online music concert (e.g., produced by the advertisement platform 115, an entity associated with the secondary website, etc.) in exchange for the customer's email address 195-1. Like many others, the customer 140 can keep a junk e-mail address for this purpose and provides that junk e-mail address (or a real email address) to watch the concert. Meanwhile, customer 140 may have visited the merchant 110 (e.g., merchant website 130, a physical location of the merchant, etc.) in the past and used the same email address 195-1 (e.g., a junk, real, etc. e-mail address), for example, to access a printable coupon for a particular shoe offered by the merchant 110. In some cases, the customer 140 can have provided no other information.

Even in this information-poor circumstance, the merchant 110 may provide a payload 190A with a hashed email 180-2A (e.g., hashed version of the coupon-printer's junk/real e-mail address) to the advertisement platform 115 that indicated an interest in the particular shoe. In some cases, the advertisement platform 115 can, in turn, match the hashed email address 180-2A received from the merchant 110 with another hashed email address 185-2A generated by the advertisement platform 115 based on emails provided by a number of users associated with advertisement platform 115. Regardless of whether a match is found the advertisement platform 115 can store the hashed email 180-2A received from the merchant 110 in association with the payload 190A and, in the case of matching the hashed email 180-2A with another hashed email 185-2A, previous payloads obtained for the customer 140 (or another person associated with the email 195-1).

The secondary website 135 can receive the email address 195-1 and hash the email address 195-1 to generate the hashed email address 195-2. For example, the advertisement platform 115 or another entity such as the merchant 110, the orchestration service 165, etc. can provide data indicative of the communication standards for hashing the email address 195-1 to the secondary website 135. As an example, the advertisement platform 115 can provide computer-implemented code (e.g., JavaScript, etc.) that can be executed by the secondary website 135 upon receipt of the email address 135. The code can automatically apply the hashing function to the email 195-1 to generate the hashed email 195-2 and forward the hashed email 195-2 to the advertisement platform 115 with a request for information to render a personalized advertisement such as advertisement 155. The advertisement platform 115 can, in turn, match the received hash 195-2 with their hash 185-2A of the customer's email 195-1 (e.g., junk, real, etc. e-mail address). An association between that customer 140 (e.g., a particular one-time concert-watching user) and the payload 190B (e.g., that the customer 140 likes a particular shoe) can be established, and a meaningful advertisement 155 can be provided for rendering through the secondary website 135 to the customer (e.g., the particular concert-watching user during the one-time music concert), without the advertising platform 115 or the secondary website 135 ever learning anything about the customer 140 except the customer's e-mail address 195-1. Meanwhile, no cookies were used, and furthermore, if the communication (e.g., between the merchant 110 to the advertisement platform 115 or the advertisement platform to the secondary website 135) carrying the particular shoe-related payload and hashed coupon-printing customer's information were intercepted by a rogue party, the information would be useless in determining any identifying information, even the junk e-mail address 195-1 of the customer 140.

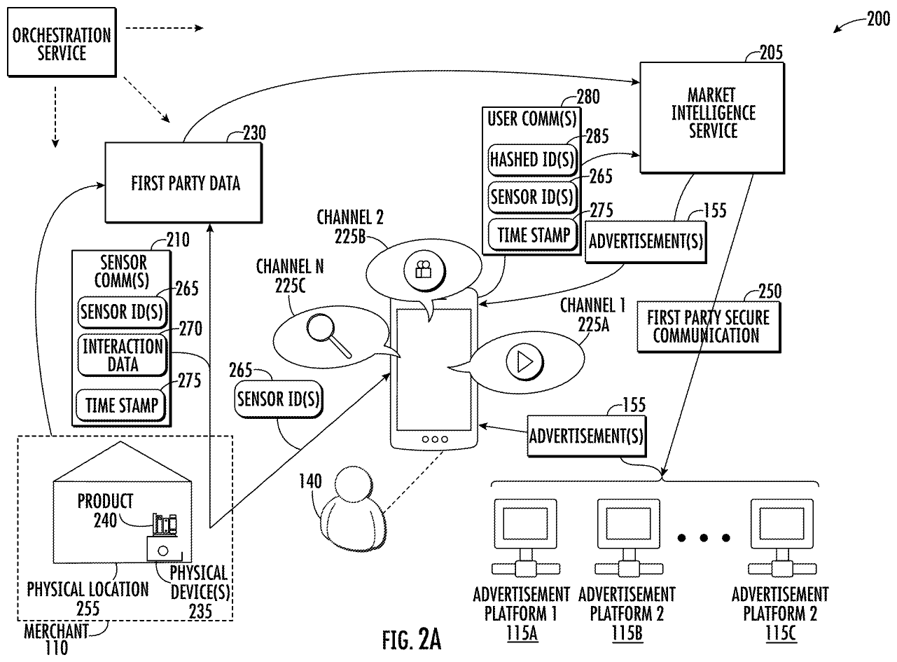

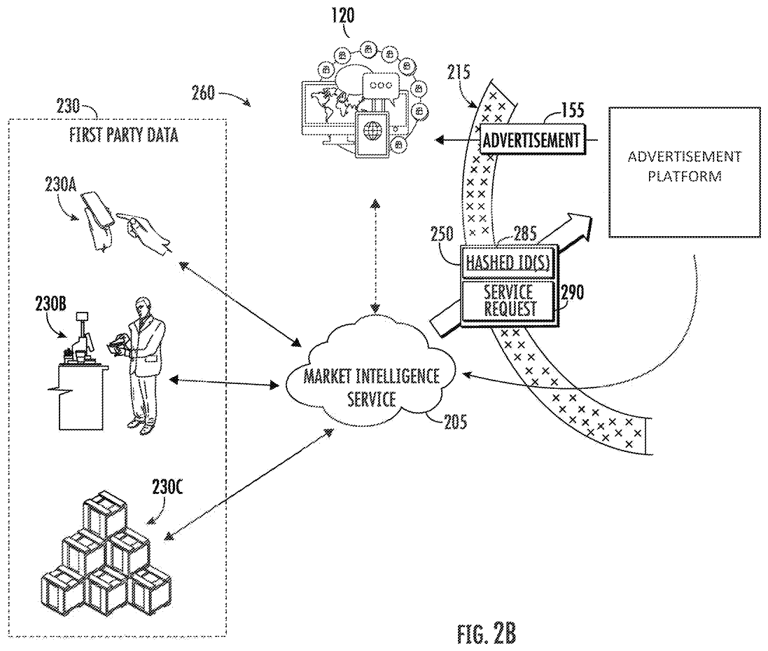

FIG. 2A depicts a secure, multi-platform marketing system 200 according to example aspects of the present disclosure. The multi-platform marketing system 200 includes a market intelligence service 205 that can act as an intermediary between merchant 110 that interacts with customers to sell products, customers that visit physical locations 255 of the merchant 110 to buy/view products, and third-party platforms such as, for example, advertisement platforms 115A-C that interact with customers to advertise products for the merchant 110. Merchant 110 can gather valuable customer information during the course of developing, selling, and providing maintenance for products to a number of customers. This “first-party information” can include transaction records, inventory/supply chain information, customer preferences (e.g., from customer service experiences, etc.) and other information gained through the production and distribution of different products. For instance, the first-party information can be collected through a number of physical locations 255 such as brick and mortar stores or other physical locations utilized by the merchant 110 to distribute products and/or otherwise interact with customers. The physical locations 255, for example, can be outfitted with physical device(s) 235 and product(s) 240 to enable the collection of physical information descriptive of a customer's interaction with a respective product 240. First-party information such as the physical information described herein can be leveraged to make informed product and marketing decisions including decisions to market different products to different customers. However, merchants 110 typically do not have access to advertisement tools, such as advertising platforms/channels 225A-C (e.g., media channel(s) 225A, social media channel(s) 225B, search browser interface(s) 225C, etc.), useful for facilitating sophisticated advertising campaigns.

Instead, merchants 110 with access to valuable customer information rely on third-party advertising platforms 115A-C to inform customers such as customer 140 of their products. Third-party advertising platforms 115A-C typically do not sell products to customers and thus do not have access to customer information. Customer information includes intimate details for customers that are private to each respective customer. Therefore, the merchant 110 may be reluctant to provide customer information to third-party advertising platforms 115A-C due to concerns with revealing private information of its customers to third parties, otherwise unaffiliated with respective customers. Moreover, if communicated without taking proper security measures, communications with intimate details for a respective customer (e.g., customer 140) could be intercepted by malicious parties allowing unintended recipients of a communication to gain personal insights for the respective customer. As a result, third-party advertising platforms 115A-C such as platform services, advertising agencies, etc. are forced to gain insights for their users through other means.

A traditional prevalent means for third-party advertising platforms 115A-C to generate insights for users is through the collection and analysis of digital signals such as those collected by third-party cookies as described herein with reference to FIG. 1A. Digital signals describe digital interactions between the customer 140 (e.g., user device 120) and a platform, service, or advertisement (e.g., content provided to a user) offered by a third-party. The digital signals can be descriptive of a user clicking on an advertisement, browsing for different products, or any other digital activity associated with a user's interests. These signals can be recorded by internet cookies (e.g., software packets downloaded through a search browser). Cookies can be designed to record digital signals and store information associated with the digital signals on the user device 120 such that the information can be accessed by advertising platforms 115A-C for generating insights for their users. Cookies, and digital signals, can be unreliable and provide different insights for the customer 140 across different channels 125A-C. Thus, cookie based advertisements generated by different advertising platforms 115A-C can be inconsistent and, in some cases, irrelevant for the customer.

The market intelligence service 205 described herein empowers the merchant 110 to determine insights for its customers based on first-party information gathered directly from its customers and provide those insights to third-party advertising platforms 115A-C (e.g., using communication standards developed by the orchestration service 165, etc.) for marketing campaigns in a “cookie-less,” secure, privacy conscious manner. The market intelligence service 205 enables privacy conscious marketer-to-advertiser communications 130 by providing tools to the merchant 110 for generating customer insights based on first-party information, thereby enabling the merchant 110 to provide valuable information derived from first-party information without directly communicating first-party information to a third-party.

As described in further detail herein, the merchant 110 can facilitate a sensing environment 255 for gathering reliable physical information associated with a customer 140. The sensing environment 255 can be a store or other physical location including products 240 sold by the merchant 110. The sensing environment 255 can be outfitted with a number of physical device(s) 235 located relative to different products 240 within the store (and/or other physical location). The physical device(s) 235 can detect and record a customer's proximity to and/or interaction with a respective product 240. This information can be provided to the market intelligence service 205 by the physical device(s) 235 and/or a user device 120 using the secure communication techniques described herein. A first party secure communication 250 including the physical information, for example, can reference a corresponding customer 140 such that the customer 140 can only be referenced by a recipient that is independently affiliated with the customer 140.

The market intelligence service 205 can provide for the secure communication techniques described herein for referencing customers in a manner that prevents a third-party from referencing customers with which it is not already affiliated. Marketing intelligence service 205 may be implemented by merchant 110 in some examples, such as by one or more computing devices operating by the merchant. In another example, marketing intelligence service 205 can be implemented by another party, such as orchestration service 165. For instance, the market intelligence service 205 can include the orchestration service 165. In addition, or alternatively, the market intelligence service 205 can communicate with the orchestration service 165 to obtain privacy secure communication standards described herein. The privacy secure communication standards, in combination with the platform tools of the market intelligence service, can enable the merchant to reference customers through irreversibly hashed groups. The hashed groups can be created by hashing personal identifiers associated with the respective customers that are accessible to the merchant 110. Each hashed group can include a dataset of indecipherable variables such that the recipient of a secure communication 250 including a hashed group (whether that recipient is the intended recipient or a malicious intercepting party) will be unable to identify customers referenced by the group of hashed identifiers. Upon receiving the secure communication 250 with a group of hashed identifiers, a third-party advertisement platform 115A-C can determine whether any of its users are referenced by the hashed group by applying the same hash function (as prescribed by the secure communication standards of the orchestration service 165) used to create the hashed group to a number of identifiers corresponding to each of the third-party's users. The third-party advertisement platforms 115A-C can determine that a respective user is referenced by the message 250 by matching a respective hashed user identifier with an individual hashed user identifier included in the hashed group of identifiers. In this way, insights for a customer can be sent to a number of parties, but only deciphered by those parties that independently received a user identifier corresponding to a customer identifier hashed by the merchant 110. This allows a first-party merchant to orchestrate coordinated and personalized messaging campaigns for its customers (or potential customers) across a number of different third-party platforms 115A-C and advertising channels 125A-C without exposing intimate details entrusted to it by its customers (or potential customers).

In this regard, the market intelligence service 205 can provide a merchant 110 with tools for generating customer insights based on first-party information collected by merchant 110. The tools can be used for inventory awareness, customer awareness, and/or any other self-analysis that can empower the merchant 110 to make decisions on how to message customers, which customers to message, etc. Example tools can include a suite of algorithms (e.g., machine-learning models, etc.) for predicting a customer's lifetime value, predicting a customer's churn rate, predicting a customer's interest in products offered by the merchant 110, or predicting characteristics shared by potential customers. Using tools provided by the market intelligence service 205, a merchant 110 can segment its customers according to a customer value or churn rate, provide relevant product recommendations to customers, provide inventory-aware recommendations to customers, identify potential customers for customer acquisition, etc. The merchant 110 can activate (e.g., act on, etc.) these insights by providing privacy secure service requests 250 to a number of different third-party platforms 115A-C. This can enable the merchant 110 to orchestrate a customer journey for each of its customers by instructing (e.g., through service requests to affiliated third-party platforms) third-party platforms 115A-C to provide consistent, personalized, and relevant advertisements 155 through various channels 125A-C based on insights derived from first-party information.

For example, merchant 110 can collect first-party data 230 (e.g., transaction history, account information, etc.) from a number of first-party users, such as customer 140, that interact with the merchant 110. The information can be stored in a secure server (e.g., a unified data repository of the market intelligence service 205) where machine-learning models can be leveraged to gain insights for the number of first-party users based, at least in part, on the first-party data 230. The first-party users can be grouped into different groups according to insights gained thereof. The merchant 110 can create a secure message 250 that securely references each member of a group of its first-party users by individually hashing a first-party user identifier (e.g., a username, a first/last name, an email, phone number, zip code, etc.) corresponding to each first-party user in the group. The message 250 can be provided to advertising platforms 115A-C with a request to provide an advertisement service on behalf of the merchant 110. The advertising platform 115A-C can create a hashed list including a number of hashed third-party user identifiers corresponding to a number of third-party users, such as the customer 140, affiliated (e.g., has an account with, etc.) with the third-party advertising platform 115A-C. The hashed list can be compared to the hashed first-party user identifiers to reference first-party users within the message 250, such as the customer 140, that are also affiliated with the third-party advertising platforms 115A-C. The advertising platforms 115A-C can perform the requested advertisement service for the merchant 110 based, at least in part, on the referenced users. In this way, a merchant 110 can securely send information across different networks to another party without endangering the privacy of its first-party users. For example, by hashing first-party user identifiers associated with its customers, the merchant 110 can prevent the recipient of the message 250 (e.g., a third-party, an adverse party, etc.) from gaining insights for customers that are not affiliated with the recipient. Meanwhile, affiliated parties such as the third-party advertising platform(s) 115A-C can have the ability to hash the same information as the first-party (e.g., third-party identifiers corresponding to a first-party identifier), thereby enabling affiliated parties to gain insights for first-party users without requiring the merchant 110 to directly disclose the identity of the first-party users. Ultimately, this enables the merchant 110 to determine insights for a number of first-party customers based on first-party information and provide such information to a third-party in a privacy conscious manner.

The technology of the present disclosure can enable merchant 110 and third-party advertiser(s) 115A-C to determine and securely distribute insights without the use of cookies or other digital signals that track a user's internet activity. As described herein, cookies are designed to record digital signals and store information associated with the digital signals on potentially non-secure personal devices such that the information can be accessed by third parties (e.g., for creating personal websites, presenting targeted content, etc.). By way of example, when a user visits a website for the first time, a cookie is created by a web server hosting the site and is sent to a browser used to access the website. This initial cookie includes identifiable information (e.g., a name-value pair) for the user and instructs the browser to record information (e.g., internet activity, transaction activity, etc.) and store the information in a particular location on the user's personal device. When the user later visits the same site, the web browser passes the recorded digital information back to the web server. This information is typically not encrypted and is vulnerable to malicious parties. The technology of the present disclosure provides a more privacy conscious alternative to cookies by leveraging customer information (e.g., information gained by a merchant 110 through interaction with a first-party user such as the customer 140) recorded to a market intelligence service 205. The market intelligence service 205 can enable the merchant 110 to determine and securely distribute insights for users without the use of cookies or other digital signals that track a user's internet activity because it has access to data obtained through an actual interaction with the merchant 110. Moreover, identifiable information for a user of the merchant 110, such as the customer 140, is hashed before distribution; thereby, preventing malicious parties or unaffiliated third parties from accessing user information.

The merchant 110 includes a first-party with firsthand knowledge of a plurality of first-party users (e.g., customers or potential customers of the merchant 110). By way of example, the merchant 110 can include an entity involved in the supply of items or services to one or more first-party users of the merchant's services, products, etc. For example, the merchant 110 can include a product manufacturer, designer, etc. that develops and/or offers for sale one or more products. In addition, or alternatively, the merchant 110 can include a retail establishment offering a plurality of items produced, manufactured, and/or designed by a number of different entities. In some implementations, the merchant 110 can include a service provider that offers one or more services (e.g., landscaping, marketing, etc.) to a plurality of first-party users.

The plurality of first-party users can include customers and/or potential customers of the merchant 110 that purchase products from the merchant 110, use products provided by the merchant 110, subscribe to services offered by the merchant 110, and/or otherwise interact firsthand with the merchant 110. By way of example, the plurality of first-party users can include a number of customers (and/or potential customers) that have purchased, shown interest in purchasing, or are otherwise associated (e.g., via a first-party account, subscription, etc.) with at least one product or service offered by the merchant 110.

First-party data 230 can be collected, maintained, and/or acted upon by the merchant 110 through the market intelligence service 205. The market intelligence service 205, for example, can import first-party data 230 from merchant 110 and/or provide one or more software service(s) for generating insights based on imported information. By way of example, the market intelligence service 205 can offer one or more application programming interfaces (“APIs”) that enable the merchant 110 to securely collect, store, and/or transfer first-party data 230 (and/or one or more insights derived thereof) associated with one or more of its first-party users. As described in further detail herein, the market intelligence service 205 can include a cloud environment hosted by an intermediary cloud computing platform. In addition, or alternatively, the market intelligence service 205 can include a standalone software application running on one or more backend servers associated with the merchant 110.

The first-party data 230 can be analyzed by the merchant 110 using tools provided by the market intelligence service 205. For example, the software tools provided by the market intelligence service 205 can be used to generate customer and/or inventory aware insights based on the first-party data 230. The tools, for example, can include a plurality of predictive machine-learning model(s). In some implementations, the machine-learning model(s) can include one or more deep neural networks. Access to the deep neural networks can be provided through one or more interfaces (e.g., API(s), etc.) associated with the market intelligence service 205.

The merchant 110 can generate one or more user groups based, at least in part, on the first-party data 230. The user groups can include a subset of the plurality of first-party users associated with common attributes that can provide particular insights for a respective subset of first-party users. The common attribute(s) can include common purchase histories, user preferences, etc. with which one or more insights (e.g., a product interest, a value to the merchant 110, etc.) have been (and/or can be) derived. By way of example, the common attribute(s) can be identified through one or more machine-learned model(s) configured to identify correlations between first-party user attributes and corresponding insights.

As one example, the common attribute(s) for a subset of first-party users can be indicative of a common interest level for a respective product 240. The attribute(s), for example, can include one or more transactional attributes indicative of a transaction associated with a respective product (e.g., a past transaction including the item, a related item, etc.) and at least one respective first-party user. In addition, or alternatively, the common attribute(s) can include contextual attribute(s) indicative of an association between the respective product and at least one respective first-party user of the subset of the plurality of first-party users. The contextual attribute(s), for example, can be descriptive of one or more physical interaction(s) (e.g., picking up a product, analyzing a product, etc. in a brick and mortar store) between the respective product 240 (and/or related product) and the at least one respective first-party user 140 of the subset of the plurality of first-party users. As other examples, the contextual attribute(s) can include user preference(s), demographic information, and/or any other information associating a respective user with a respective product. In some implementations, the common attributes can be identified by a product recommendations engine based, at least in part, on the first-party data.

As described in further detail herein, the contextual attributes can be descriptive of a physical interaction between a customer 140 and a respective product 240. For instance, physical signals indicative of the physical interaction can be obtained, stored, analyzed, and transmitted, in a privacy conscious manner to protect customer information from malicious or unintended parties. For instance, the contextual information can be derived from a number of sensor communication(s) 210 transmitted by physical device(s) 235 and/or user communications 280 transmitted by user device(s) 120. The sensor communication(s) 210 can include a sensor identifier 265, interaction data 270, and/or a time stamp 275. The sensor identifier(s) 165 can refer to any sensor identifier including, for example, beacon identifiers corresponding to radio (e.g., Bluetooth) beacons. The user communications 280 can include a respective sensor identifier 265, a hashed user identifier 285 corresponding to the respective customer 140, and/or respective time stamp 275. As described in further detail herein, the respective time stamp 275 and sensor identifier(s) 265 of the communication(s) 210, 280 can be correlated by the market intelligence service 205 to associate interaction data 270 recorded by physical device(s) 235 corresponding to the sensor identifier(s) 265 with the customer 140 referenced by the hashed identifier 285. The interaction data 270 can include contextual information descriptive of a customer's interaction (e.g., an interaction time with which the customer picked up and/or otherwise interacted with a product, a manner in which the customer interacted with the product, etc.) with a respective product 240.

The market intelligence service 205 can create a hashed list including a number of hashed first party user identifiers for each of a number of customers that have previously interacted with the merchant 110. The hashed list can be compared to the hashed user identifier 285 of the user communication 280 to determine whether the user communication 280 is associated with a customer affiliated with the merchant 110. For example, in the event that the hashed user identifier 285 matches at least a portion of the hashed list, the merchant/marketer can determine that the customer 140 associated with the user communication 280 is an affiliated customer. The sensor identifier 265 can be correlated with a respective product 240, product type, or area of the physical location 255 to determine an association between the customer 140 and the respective product 240, product type, or area.

A customer-product association can be determined that is descriptive of a physical interaction between the customer 140 and the respective product 240 based on the communications 210, 280. The merchant 110 can leverage this information to communicate an advertisement 155 directly to a device 120 associated with the customer 140 or transmit the information to a third party advertising platform 115A-C for use in generating advertisements 155 across different third party platforms 225A-C. For example, information associated with the user groups, the first-party users, and/or insights or common attributes linking the first-party users can be provided to one or more third-party advertising platform(s) 115A-C to enable the third-party platform(s) 115A-C to provide personalized advertisements 155 to third-party users such as, for example, the customer 140. To do so in a privacy conscious manner, the market intelligence service 205 can generate a hashed user group based on a user group and a hashing algorithm (e.g., the hashing algorithm prescribed by the orchestration service 165). The hashed user group can include a hashed list referencing a subset of first-party users within a user group. For instance, the hashed list can include one or more hashed identifiers for each respective user within the user group. The hashed identifiers for each respective user can include at least one of a hashed email, a hashed phone number, and/or a hashed first name, last name, and/or zip code.

The market intelligence service 205 can generate the first-party secure communication 250 for one or more third-party advertising platform(s) 115A-C based, at least in part, on the hashed user group. The first-party secure communication 250 can include and/or otherwise identify the hashed user group. For example, an identification of the user group (e.g., common interest in a particular shoe) can be provided as a payload of communication 250. In addition, the market intelligence service 205 can include one or more service requests for the third-party advertising platform(s) 115A-C.

The third-party advertising platform(s) 115A-C, for example, can be associated with third-party advertising channels 125A-C. The third-party advertising platform(s) 115A-C can be in collaboration with the merchant 110, for example, to advertise one or more products or services offered by the merchant 110 across one or more different advertising channels 125A-C such as, for example, media channels 125A, social media channels 125B, search browser channels 125C, etc. By way of example, the third-party advertising platform(s) 115A-C can be configured to provide advertising services to, for example, acquire customers for the merchant 110, provide personalized messaging to customers of the merchant 110, etc. The first-party secure communication 250 can include a service request to perform one or more service operations for the merchant 110. The service operations, for example, can include a user acquisition operation for acquiring new customers for the merchant 110, a user servicing operation for providing customer specific information to one or more customers of the merchant 110, a product offering operation for providing product specific information to one or more third-party users of the third-party advertising platform(s) 115A-C, and/or merchant 110 informational operations for providing merchant information (e.g., for a respective product, etc.) to one or more third-party users of the third-party advertising platforms 115A-C.

The market intelligence service 205 can communicate the first-party secure communication 250 to the third-party advertising platforms 115A-C. The third-party advertising platforms 115A-C can reference at least one third-party user corresponding to the user group (e.g., using the secure communication standards prescribed by the orchestration service 165). For instance, the third-party advertising platforms 115A-C can compare the hashed user group to third-party data to reference one or more third-party users associated with the first-party secure communication 250 without any prior knowledge of the market intelligence service 205 or the first-party users of the merchant 110. For example, in the event that the same user is affiliated with both the merchant 110 and the third-party advertising platform(s) 115A-C, the third-party data can include third-party user identifiers corresponding to a respective first-party user identifier for the affiliated user. This enables the third-party advertising platform(s) 115A-C to reference an affiliated user of the hashed user group by hashing the same information hashed by the merchant 110 (e.g., corresponding user identifiers) and matching the hashed information to at least a portion of the hashed user group. In this manner, the market intelligence service 205 can securely transmit hashed information associated with its first-party user over one or more networks (e.g., secure, or unsecure) without exposing customer information such as transaction history, value to the merchant 110, etc. to malicious parties.

More particularly, the third-party advertisement platform(s) 115A-C can include and/or be associated with a plurality of third-party users. The third-party users can have an account with and/or otherwise utilize one or more services, platforms, etc. of the third-party advertisement platform(s) 115A-C. For example, the third-party advertisement platform(s) 115A-C can include and/or be associated with an internet browser (e.g., with a search browser marketing channel 125C), a social media platform (e.g., with a social networking marketing channel 125B), a media platform (e.g., with a video marketing channel 125A), an advertising agency, and/or any other interactive interface for engaging with third-party users.

The third-party advertisement platform(s) 115A-C can include and/or have access to third-party user data. The third-party user data can include information associated with the plurality of third-party users. By way of example, the third-party user data can be indicative of a plurality of third-party user accounts associated with the third-party advertisement platform(s) 115A-C. For instance, the third-party user data can include one or more user preferences, user identifiers, activity information, etc. for each of the plurality of third-party users. In some implementations, each of the plurality of third-party user accounts can include one or more user identifiers (e.g., a name, email, phone number, physical address, etc.).

The third-party advertisement platform(s) 115A-C can generate a third-party hashed list based, at least in part, on the third-party user data and a hashing algorithm (e.g., as prescribed by the orchestration service 165). The third-party advertisement platform(s) 115A-C can apply the hashing algorithm to at least one of the one or more user identifiers for each of the plurality of third-party user accounts to generate the third-party hashed list. The third-party hashed list can include a plurality of hashed third-party identifiers corresponding to a plurality of third-party user identifiers. For example, each hashed third-party identifier can correspond to a respective third-party user identifier. Each hashed third-party identifier can reference a respective third-party user based, at least in part, on the corresponding third-party user identifier. The plurality of third-party user identifiers corresponding to the third-party hashed list can at least in part overlap the plurality of first-party user identifiers corresponding to the hashed user group. By way of example, a user affiliated with both the merchant 110 and the third-party advertisement platform(s) 115A-C (e.g., customer 140) can provide at least one of the same user identifiers to each party. This, in turn, enables the third-party advertisement platform(s) 115A-C to hash at least part of the same information used by the market intelligence service 205 as a basis for the hashed user group. The third-party advertisement platform(s) 115A-C can generate a third-party hashed list that at least partially matches the hashed user group by applying the same hash function as the market intelligence service 205 to the at least partially overlapping information used as a basis for the hashed user group. By doing so, the third-party advertisement platform(s) 115A-C can reference a third-party user associated with the hashed group despite the irreversibility of hashed information.

The third-party advertisement platform(s) 115A-C can determine one or more actions to be taken in response to the first-party secure communication 250 based, at least in part, on the list of third-party users determined based on the hashed user group included in the first-party secure communication 250, third-party user data accessible to the advertisement platform(s) 115A-C, and/or the requested service operations of the first-party secure communication 250. For example, the third-party advertisement platform(s) 115A-C can initiate one or more personalized advertisements 155 to the customer 140 based on the secure communication 250. By way of example, the customer 140 can be determined from the hashed user group and the requested service operation can request the provisioning of a personalized advertisement to the customer 140. In such a case, the third-party advertisement platform(s) 115A-C can generate one or more personalized advertisements based, at least in part, on third-party data and/or first-party data provided by the first-party secure communication 250 and provide data indicative of at least one of the one or more advertisements 155 to one or more user device(s) 120 associated with the customer 140.

By way of example, the advertisement 155 can be provided for display to the customer 140 through one or more marketing channels 125A-C accessible to the user device 120. For example, the third-party advertisement platform(s) 115A-C can provide the data indicative of the one or more advertisement 155 for display within a social media platform 125B hosted by the third-party advertisement platform(s) 115A-C. In addition, or alternatively, the third-party advertisement platform(s) 115A-C can receive input data indicative of a website and the customer 140. In such a case, the third-party advertisement platform(s) 115A-C can provide data indicative of a customized website 125C for display to the user based, at least in part, on the third-party data and/or first-party data included in the secure communication 250 for the customer 140. In some implementations, the third-party advertisement platform(s) 115A-C can provide the data indicative of the one or more advertisement 155 for display within a video channel 125A hosted by the third-party advertisement platform(s) 115A-C.

The user device 120 described herein can refer a plurality of different computing devices associated with the user. By way of example, the user device 120 can include a mobile device (e.g., a smart watch, smart phone, etc.), a personal desktop, one or more smart home devices (e.g., smart displays, smart audio devices, smart lights, etc.), and/or any other device owned, maintained, or otherwise associated with the user. The user device 120, for example, can include a device that is carried with the user as the user enters a store. In addition, the user device 120 can include a stationary device that has not entered the store. In this manner, physical information associated with a customer 140 can be used to provide an advertisement 155 to the customer 140 through a number of different device(s) (e.g., mobile, stationary, etc.) and/or a number of different channels associated with the customer 140 regardless of the device(s) and/or channel(s) affiliation with a location (e.g., a physical store) in which the physical information is obtained.

The present disclosure provides a number of technical effects and benefits. For example, the disclosed technology can replace previous techniques of relying on internet cookies to gain insights for customers by leveraging first party data gathered directly from interactions with customers (and/or potential customers). Such interactions, for example, can include physical interactions between a customer and a product (e.g., and product, service, etc.) associated with a merchant/marketer. In this regard, the present disclosure can bridge the gap between the digital and physical world using specifically placed beacons throughout a physical location 155. The first party data can be gathered by user devices 120 or physical sensors 135 and directly transmitted to a merchant/marketer cloud computing platform 105 without requiring the data to be stored at the user device 120 or sensor 135. This, in turn, can help save computational resources (e.g., processing, memory, power, etc.) on personal computers (e.g., user devices 120) that are otherwise wasted observing and storing personal data using conventional techniques such as browser cookies. Moreover, unlike conventional techniques, the present disclosure can enable a merchant/marketer to securely receive, store, analyze, and distribute customer information in a privacy conscious manner that protects customer information from malicious parties or parties that are unaffiliated with a respective customer. Ultimately, the technology of the present disclosure provides effective, computationally efficient, and secure data encryption and communication processes, systems, and devices.

The present disclosure provides a number of improvements to computing technology such as, for example, storage, encryption, and communication technologies. For instance, the present disclosure describes secure data storage and communication techniques (e.g., using hashed user lists, beacon broadcasts, etc.) to provide practical improvements to data security and user engagement especially relevant in the realm of internet privacy. The present disclosure employs improved collaboration techniques between customers and affiliated parties (e.g., a collaboration of first and third entities) that allow a merchant/marketer to receive and provide customer information descriptive of physical signals while preserving the privacy of the information associated with the merchant/marketer's customers. To do so, the systems and methods described herein accumulate and distribute newly available information such as, for example, hashed lists of user identifiers, beacon broadcasts from a number of specifically placed beacons, interaction data, movement data, etc. that can be used by an affiliated party to identify physical interactions between customers and products associated with the affiliated party. By encrypting the information in the manner described herein, the information can only be used to determine insights for customers that are affiliated with a recipient party. In this way, the systems and methods described herein can generate secure communications indicative of physical interactions between a customer and a merchant/marketer. Ultimately, this enables privacy conscious insight driven user engagement while preserving the privacy of customer information over the internet.

In some implementations, in order to obtain the benefits of the techniques described herein, the user may be required to allow the collection and analysis of sensor data associated with the user or their device. For example, in some implementations, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed. As an example, a computing system can obtain sensor data which can indicate a scan, without identifying any particular user(s) or particular user computing device(s).

FIG. 2B depicts an example marketing environment 260 according to example aspects of the present disclosure. The marketing environment 260 includes the market intelligence service 205 which acts as an intermediary between a merchant with firsthand knowledge of customer(s) and/or product(s) and advertisement platform(s) 115 that interact with users to advertise products for the merchant. The market intelligence service 205 can be a trusted server that hosts cloud environments for a number of affiliated merchants. In addition, or alternatively, the market intelligence service 205 can be hosted by one or more first-party servers maintained and/or operated by a merchant. For example, operations and/or benefits of the market intelligence service 205 can be performed and/or enabled by a standalone software application executed by one or more first-party device(s).

A respective merchant can create an account with the market intelligence service 205 to access software tools provided by the market intelligence service 205 such as, for example, tools to import customer or product information from various siloed datacenters, tools to generate complex insights for customers based on firsthand information, and/or tools to securely facilitate marketing campaigns across a number of third-party platforms 115. In this way, the market intelligence service 205 can empower merchants to efficiently use valuable first-party information gained through the course of business to facilitate personalized marketing across a number of different platforms without endangering the privacy of their customers.

A merchant gathers valuable first-party data 230 during the course of developing, selling, and providing maintenance for products to a number of customers. This “first-party information” can include first-party user information 265 (e.g., customer preferences, etc.), transactional information 270 (e.g., transaction records, etc.), and/or inventory information 275 (e.g., inventory/supply chain information, etc.). By way of example, the merchant can be associated with a plurality of marketing silos (e.g., dedicated servers, marketing service applications, third-party marketing tools, etc.) configured to obtain, maintain, catalogue, analyze, etc. first-party data 230 gathered by the merchant during the course of business. At least one of the marketing silos can handle first-party user information 265 (e.g., user accounts created for a first-party application hosted by the merchant, etc.). Another (and/or the same) marketing silo can handle transaction information 270. While a further (and/or the same) marketing silo can handle product inventory information 275.

The first-party user information 265 can include customer preferences and/or other customer information gained through interaction with first-party users. As an example, the first-party user information can include information (e.g., preferences, likes, saves, etc.) input to a first-party application hosted by the merchant. As another example, the first-party user information can include information descriptive of customer service requests, product inquiries, product returns, customer reviews, etc. The transactional information 270 can include transactional records and/or other information descriptive of products purchased by a customer such as, for example, a number of products purchased, a frequency of purchases, a monetary value of each purchase, etc. The inventory information 275 can include product availability information such as, for example, an availability of a product at one or more different stores or geographic regions, a production rate/plan for a product, an expected demand for a product, a current demand for a product, etc.

First-party data 230 can be leveraged to make informed production and marketing decisions including decisions to market different products to different customers. Merchants can contact customers (e.g., via a user device 120). However, merchants typically do not have access to advertisement tools, such as advertising platforms, necessary to facilitate sophisticated advertising campaigns. Instead, merchants with access to valuable first-party data rely on third-party advertising platforms 115 to inform first-party users of their products. Third-party advertising platforms 115 typically do not sell products to customers and thus do not have access to first-party data 230. First-party data 230 includes intimate details for customers that are private to each respective customer. Therefore, the merchant may be reluctant to provide this information to third-party advertising platforms 115 due to concerns with revealing private information of its customers as it would give third parties, otherwise unaffiliated with respective customers, valuable information concerning the respective customers. Moreover, if communicated without taking proper security measures, communications with intimate details for a respective customer could be intercepted by malicious parties 215 allowing unintended recipients of a communication to gain personal insights for the respective customer.

As a result, third-party advertising platforms 115 such as platform services, advertising agencies, social media services, etc. typically gain insights for their users (e.g., third-party users) through other means. A prevalent means for third-party advertising platforms 115 to generate insights for its users is through the collection and analysis of digital signals. Digital signals describe digital interactions between a user and a platform, service, or advertisement (e.g., content provided to a user) offered by a third-party. The digital signals, for example, can be descriptive of a user clicking on an advertisement, browsing for different products, or any other digital activity associated with a user's interests. These signals can be recorded by internet cookies (e.g., software packets downloaded through a search browser). Cookies can be designed to record digital signals and store information associated with the digital signals on a personal device 120 such that the information can be accessed by advertising platforms 115 for generating insights for their users. Cookies, and digital signals, can be unreliable and provide different insights for a single user across different platforms. Thus, cookie based advertisements generated by different advertising platforms can be inconsistent and, in some cases, irrelevant for a user. Moreover, internet cookies can pose privacy risks to users as they are generally unsecure and susceptible to cyberattacks by malicious parties 215.

The market intelligence service 205 described herein empowers merchants and marketers to determine insights for their customers based on first-party data 230 gathered directly from their customers and provide those insights to third-party advertising platforms 115 for marketing campaigns in a “cookie-less,” secure, privacy conscious manner. The market intelligence service 205 enables privacy conscious marketer-to-advertiser communications (e.g., first party secure communications 250) by (1) providing secure communication techniques for referencing first-party users in a manner that prevents a third-party 215, 115 from identifying first-party users with which it is not already affiliated; and (2) providing tools to the merchant for generating customer insights based on first-party data 230, thereby enabling the merchant to provide valuable information derived from first-party data 230 without directly communicating first-party data 230 to a third-party 215, 115.

As described in further detail herein, the market intelligence service 205 can include and/or be associated with an orchestration service that provides secure communication techniques for referencing first-party users. The secure communication techniques can include referencing first party users of a respective message (e.g., first party secure communication 250) through irreversibly hashed groups made up of a plurality of individually hashed user identifiers 285. The hashed groups can be created by individually hashing personal identifiers associated with the respective first party users that are accessible to the merchant. Each hashed group can include a dataset of indecipherable variables such that the recipient 215, 115 of the message (e.g., first party secure communication 250) including a hashed group (whether that recipient is the intended recipient 115 or a malicious intercepting party 215) will be unable to identify first party users referenced by the hash. Upon receiving a message with a hashed group, the third-party advertisement platform(s) 115 can determine whether any of its users (e.g., third-party users) are referenced by the hashed group by individually applying the same hash function used to create the hashed group to a number of identifiers corresponding to each the third-party's users. The third-party advertising platform(s) 115 can determine that a respective user is referenced by the message (e.g., first party secure communication 250) by matching a respective hashed user identifier with a portion of the hashed group. In this way, insights for a first party customer can be sent to a number of parties, but only used by those parties that independently received a user identifier corresponding to a user identifier hashed by the merchant. This allows a “first-party” merchant to orchestrate coordinated and personalized messaging campaigns for its customers (or potential customers) across a number of different third-party platform(s) 115 without exposing intimate details entrusted to it by its customers (or potential customers).

In this regard, the market intelligence service 205 can provide the merchant with tools for generating customer insights based on first-party data 230. The tools can be used for inventory awareness, customer awareness, and/or any other self-analysis that can empower the merchant to make decisions on how to message customers, which customers to message, etc. Example tools can include a suite of algorithms (e.g., machine-learning models, etc.) for predicting a customer's lifetime value, predicting a customer's churn rate, predicting a customer's interest in products offered by the merchant, or predicting characteristics shared by potential customers. Using tools provided by the market intelligence service 205, the merchant can segment its first party users according to a customer value or churn rate, provide relevant product recommendations to customers, provide inventory-aware recommendations to customers, identify potential customers for customer acquisition, etc. The merchant can activate (e.g., act on, etc.) these insights by providing privacy conscious messages (e.g., first party secure communication 250) with service request(s) 290 to a number of different third-party platforms 115. This can enable the merchant to orchestrate a customer journey for each of its customers by instructing (e.g., through service request(s) 290 to affiliated third-party platforms 115) third-party platforms 115 to provide consistent, personalized, and relevant advertisements 155 based insights derived from first-party data 230.

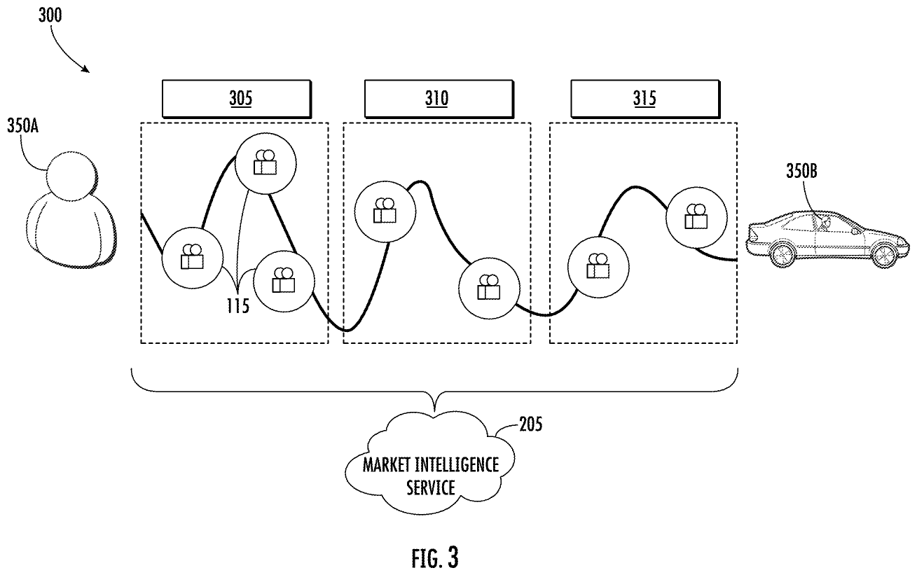

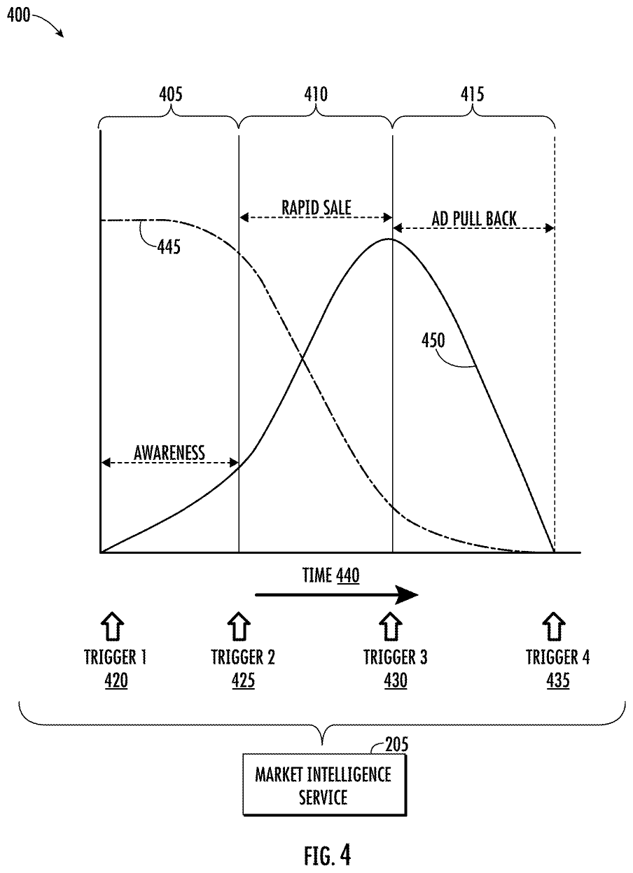

FIGS. 3 and 4 depict example marketing campaigns enabled by the present disclosure.

As one example, FIG. 3 depicts an example customer journey 300 according to example aspects of the present disclosure. A customer journey 300 can include a number of stages 305, 310, 315 for a first party user 350 during which the first party user 350 transitions from a potential first party user 350A to a buying first party user 350B. A first stage 305, for example, can include an exploratory phase for the first party user 350. During the first stage 305, the first party user 350 may not know about the merchant or one or more products offered by the merchant. A second stage 310 can include a testing phase for the first party user 350. During the second stage 310, the first party user 350 can have knowledge of the merchant and/or product(s) offered by the merchant and may be testing or sampling (e.g., through a free subscription, a trial product, a demo, etc.) the product(s). A third stage 315 can include a purchasing stage for the first party user 350 during which the potential first party user 350A becomes a buying first party user 350B.

The efficacy of a type of message and/or information provided to a first party user 350 can depend on the stage 305, 310, 315 the first party user 350 is in in the customer journey 300. For example, general messages providing information about the first-party and/or benefits/comparisons of the first-party's product(s) relative to competing products may be effective during the first stage 305 and lose efficacy as the customer progresses along the customer journey 300 (e.g., by providing redundant information, providing information about competing products, etc.). Moreover, messages providing information for testing products may be effective during the second stage 310 but lose efficacy after a first party user 350 buys the product. As another example, messages providing purchasing information may be effective after the first party user 350 reaches the third stage 315 of the customer journey 300. However, such messages may be irrelevant or too narrow while the first party user 350 is in the first stage 305 of the customer journey 300.

The market intelligence service 205 can enable the merchant to synchronize personalized messages provided to the first party user 350 at each stage 305, 310, 315 of the customer journey 300 ensuring the first party user 350 is provided consistent, personalized, and relevant messaging regardless of the message's source. For example, the market intelligence service 205 can provide tools to the merchant for the creation of a customer journey 300 specific to the merchant and/or product(s) of the merchant. Although three stages 305, 310, 315 are illustrated by FIG. 3, a customer journey 300 can include any number of stages depending on the merchant or types of products offered by the merchant. The customer journey 300 can be informed by state-based transitions of the first party user 350. The state-based transitions can be triggered based on first-party information (e.g., first-party data 230, etc.). In some implementations, the state-based transitions can be triggered based on advertisement engagements or other information obtained by a third-party advertising platform(s) 115. Each transition can advance (or demote) the first party user 350 to the next stage (or previous) of the customer journey 300. The market intelligence service 205 can enable the merchant to instruct a number of third-party advertising platform 115 to provide different messages to the first party user 350 depending on the customer's position within the customer journey. In this manner, in each stage 305, 310, 315 of the customer journey 300, the first party user 350 can receive consistent messages across a plurality of different platforms 115.

As another example, FIG. 4 depicts example inventory-aware messaging scenario 400 according to example aspects of the present disclosure. The inventory-aware messaging scenario 400 illustrates an example product lifecycle including a number of product stages 405, 410, 415. Each stage 405, 410, 415 can represent an expectation of demand and/or supply for a respective object based on, for example, historical inventory information, one or more machine-learned insights provided by inventory specific machine-learned models, etc.

As examples, the first stage 405 can include an announcement stage during which a product has been announced but is not yet available for purchase, the second stage 410 can include an initial sale phase during which products are offered for sale and supply is high, and the third stage 415 can include an extended sale phase during which products are offered for sale and supply is low. A product can advance between stages 405, 410, 415 based on one or more triggers 420, 425, 430, 435. The triggers 420, 425, 430, 435, for example, can include an announcement trigger 420 (e.g., triggered by a product announcement) that advances the product to the first stage 405, an on sale trigger 425 (e.g., triggered by a product being made available for purchase) that advances the product to the second stage 410, a low inventory trigger 430 (e.g., triggered based on inventory information for the product) that advanced the product to the third stage 415, and an out of inventory trigger 435 (e.g., triggered based on inventory information for the product) that can end the product lifecycle (or return the product lifecycle to the first stage 405 during which new inventory can be announced).

The purpose for providing messages to first party users can depend on the stage 405, 410, 415 of a product's lifecycle. For example, awareness messages including a media-mix based on driving awareness to grow audiences can be preferable in the first stage 405 of a product's lifecycle. Rapid-sale messages including personalized offers or messaging can be preferable in the second stage 410 when the product inventory is high. These messages, for example, can be guided by predictive inventory models. Advertisement pull-backs in which the messages are reduced to certain locations (e.g., with inventory) can be preferable as the product enters the third stage 415 and inventory begins to decrease. Finally, messages can automatically stop in the fourth stage when inventory runs out.

The market intelligence service 205 can enable the merchant to synchronize personalized messages provided to first party users at each product's stage 405, 410, 415 to provide consistent, inventory-aware messaging regardless of the message's source. For example, the market intelligence service 205 can provide tools to the merchant for the creation of a product lifecycle specific to the merchant and/or a respective product of the merchant. Using the market intelligence service 205, the first-party can orchestrate messaging campaigns that alter messages over time 440 to increase/decrease demand (e.g., represented by line 450) based on the inventory levels (e.g., represented by line 445) of a particular product. In this manner, the market intelligence service 205 can enable the merchant to manage advertising spending and product inventory more efficiently by orchestrating consistent inventory-aware advertising campaigns through a number of third-party advertising platforms (e.g., platform(s) 115).

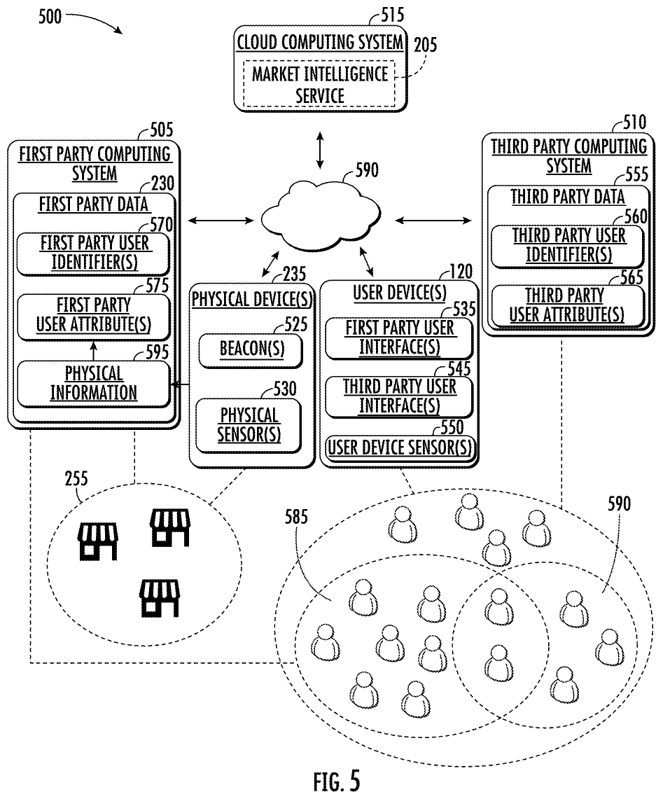

FIG. 5 depicts an example multi-party ecosystem 500 according to example aspects of the present disclosure. The multi-party ecosystem 500 can include a first-party computing system 505 and a third-party computing system 510 communicatively connected through one or more network(s) 590. The first-party computing system 505 can include one or more computing devices associated with the merchant (e.g., merchant 110) described herein. By way of example, the first party computing system 505 can include one or more computing device(s) utilized by a merchant to perform one or more merchant operations. The third-party computing system 510 can include one or more computing devices associated with the third-party advertisement platform(s) (e.g., advertisement platforms 115) as described herein. By way of example, the third party computing system 510 can include one or more computing device(s) utilized by the advertisement platforms to perform one or more advertising operations.

The first party computing system 505 and/or the third party computing system 510 can be associated with and/or communicatively connected (e.g., through network(s) 590) to one or more physical device(s) 520 and/or user device(s) 120 (e.g., such as the user device 120 described with reference to customer 140). As described herein, the multi-party ecosystem 500 can include a cloud computing system 515 that can act as an intermediary between the first party computing system 505 and the third party computing system 510. The cloud computing system 515 can include the market intelligence platform 205. In addition, or alternatively, the market intelligence service 205 can be executed on one or more first party servers of the first party computing system 505.

The one or more network(s) 590 can include any combination of various wired (e.g., twisted pair cable) and/or wireless communication mechanisms (e.g., cellular, wireless, satellite, microwave, and/or radio frequency) and/or any desired network topology (or topologies). For instance, the network(s) 590 can include a local area network (e.g., intranet), wide area network (e.g., the Internet), wireless LAN network (e.g., via Wi-Fi), cellular network, and/or any other suitable communications network (or combination thereof) for transmitting data to/from/between the first party computing system 505, the third party computing system 510, the cloud computing system 515, and/or the device(s) 520, 120.

The first party computing system 505 can be associated with a plurality of products and/or services offered by an associated merchant (e.g., a “first party”). The plurality of products can include first party items. For example, the associated first party items can include any number of items sold, manufactured, and/or otherwise affiliated with the merchant. In some implementations, the first party computing system 505 can include and/or be associated with one or more physical location(s) 580 (e.g., brick and mortar stores, etc.). Each physical location 580 can include a plurality of onsite items associated with the merchant. For instance, the onsite items can include a subset of the plurality of first party items associated with the merchant. The physical location(s) 580 can include building(s), showroom(s), supermarket(s), vending station(s), and/or any other area and/or structure in which a merchant can provide (e.g., for sale, for display, etc.) product(s) and/or service(s) to first party users 585 of the merchant.

In some implementations, the physical location(s) 515 can include one or more physical device(s) 520. The physical device(s) 520 can include computing devices located with a physical location for the purpose of gathering physical information 595 and/or facilitating transactions. For instance, the physical device(s) 520 can include point of sale systems and/or configurable display/audio configured to provide product information, physical location information, etc. In addition, or alternatively, the physical device(s) 520 can include data gathering device(s) configured to record one or more instore observations. For instance, the physical device(s) 520 can include one or more beacon(s) 525 and/or physical sensor(s) 530. The beacon(s) 525 and/or sensor(s) 530 can be configured to record observations for respective customers and/or products at the physical location(s) 580.

By way of example, a physical location 515 for the merchant can include the one or more beacon(s) 525 and/or sensor(s) 530 disposed within and/or around the physical location 515. The beacon(s) 525 and/or sensor(s) 530 can include any number and/or type of sensor such as, for example, one or more image sensors (e.g., camera, video camera, etc.), one or more audio sensors (e.g., microphone, etc.), one or more radio sensors (e.g., RADAR assemblies, Bluetooth transmitters/receptors, etc.), one or more tactile sensor(s) (e.g., capacitive touch sensors, etc.), etc. The one or more beacon(s) 525 and/or sensor(s) 530 can be configured to provide contextual data associated with at least one first party user and at least one first party item (e.g., a product) of the merchant. For instance, the one or more beacon(s) 525 and/or sensor(s) 530 can correspond to at least one first party item, one or more item type(s) associated with the at least one first party item, and/or an area of the physical location 515 associated with the first party item or item type(s).

As an example, in some implementations, each of the beacon(s) 525 and/or sensor(s) 530 can correspond to at least one first party item of a plurality of first party items associated with a respective physical location. A respective beacon 525 or sensor 530 can be disposed proximate to a corresponding item presented within the physical location 515. The corresponding item, for example, can be positioned on a podium, in a display case, and/or otherwise presented within the physical location 515. As another example, one or more of the one or more beacon(s) 525 and/or sensor(s) 530 can correspond to at least one area of the physical location 515. A respective beacon 525 and/or sensor 530 can be disposed proximate to a corresponding area associated with at least one of a plurality of different item types (e.g., sports, clothing, media entertainment, etc.) within the physical location 515. In some implementations, the one or more beacon(s) 525 and/or sensor(s) 530 can correspond to the at least one item type associated with the corresponding area and/or one or more first party items within (e.g., presented within) the corresponding area.

The one or more of first party beacons 525 can include (and/or be included as a part of) can include (and/or be included in a device that includes) one or more radio beacons configured to broadcast one or more radio frequencies. The physical sensors 530 can include one or more tactile sensors (e.g., to detect motion of an item placed relative to the tactile sensor, etc.), one or more radar sensor(s) (e.g., as described herein), and/or any other sensor described herein. The first party beacons 525 and/or the physical sensors 530 can be positioned throughout a respective physical location 515 such as, for example, in one or more podiums, display cases, and/or any other structure and/or device with which an onsite item is presented within the physical location 515. The first party beacons 525 and/or the physical sensors 530 can be configured to receive sensor data measured by the one or more sensor(s) 520, 530 and provide the physical information derived from the sensor data to the first party computing system 505.

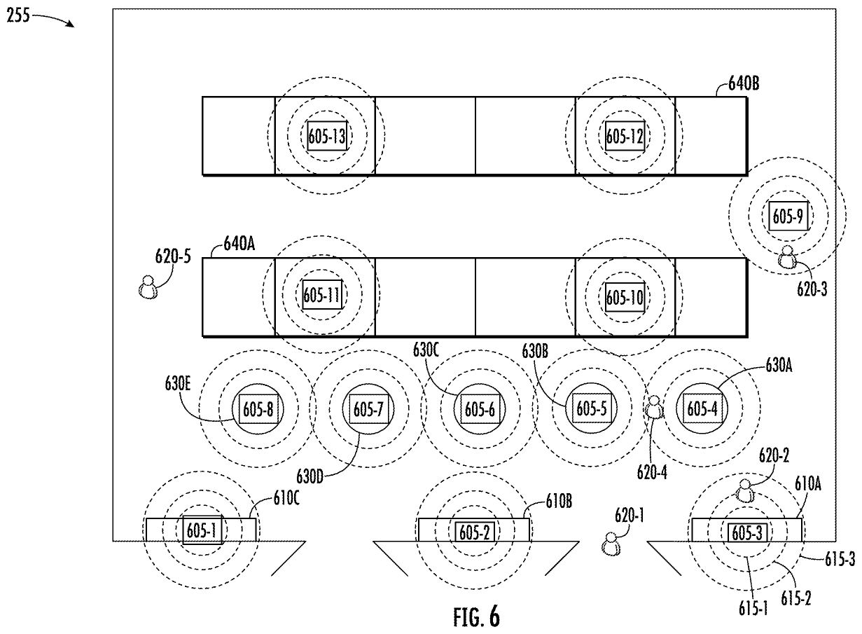

FIG. 6, for example, depicts a physical location 600 according to example aspects of the present disclosure. As described herein, a physical location 600 can include a brick and mortar store and/or any other physical location (e.g., a retail stall, a museum, subway station, etc.) in which a merchant or marketer can provide a product or service for display to a number of customers and/or potential customers. The physical location 600 can include a plurality of onsite items that can be available for purchase and/or viewing by first party customers 620-1-5. For instance, at least a portion of the onsite items can be provided for display to first party users 620-1-5. The physical location 600 can include a number of display cases 610A-C, a number of product placement stands 630A-E (e.g., clothing racks, display tables, etc.), number of aisles 640A-B and/or any other form and/or device for providing products (e.g., at least the portion of onsite items, etc.) for display.

In addition, in some implementations, the physical location 600 can include one or more sensors for making observations associated with a product (e.g., an onsite item, etc.), display case 610A-C, product placement stand 630A-E, aisle 640A-C, etc. The sensor(s), for example, can include beacons 605-1-13 (e.g., first party beacons 525, etc.). The beacons 605-1-13 can be positioned throughout a respective physical location 600. By way of example, the beacons 605-1-13 can include and/or be included in/on one or more podiums 630A-E, display cases 610A-C, aisle(s) 640A-B and/or any other structure and/or device with which an onsite item can be presented within the physical location 600.

The beacon(s) 605-1-13 can correspond to a respective product, product type, and/or area of the physical location 600. By way of example, each of beacons 605-1-3 can correspond to a respective product (and/or products) disposed relative to the display cases 610A-C. As another example, each of beacons 605-4-8 can correspond or a respective product type associated with one or more products disposed relative to the respective podiums 630A-E. As yet another example, each of beacons 605-9-13 can correspond or a respective product type and/or area associated with the physical location 600 relative to aisles 640A-B.

The first party beacons 605-1-13 can be configured to collect sensor data within a respective sensing range 615 of each of the first party beacons 605-1-13. In some implementations, for example, the first party beacons 605-1-13 can include Bluetooth beacons configured to emit a radio signal 615. The radio signal 615 can be associated with a signal strength. The signal strength can increase/decrease depending on the distance from a respective beacon 605-1-13. For example, the signal strength within the sensing area 615-3 can be less than the signal strength within the sensing area 615-2 and the signal strength within the sensing area 615-2 can be less than the signal strength within sensing area 615-1.

The physical location 600 can include a plurality of first party users 620-1-5. The first party users 620-1-5, for example, can include a plurality of customers and/or potential customers browsing one or more products offered by the merchant/marketer within the physical location 600. The beacons 605-1-13 can be configured to collect sensor data indicative of a proximity of the users 620-1-5 to one or more products, product types, and/or areas within the physical location 600. The first party beacons 605-1-13 and/or first party device(s) can be configured to receive sensor data measured by the one or more sensor(s) and provide the sensor data to the first party (e.g., via merchant/marketer cloud computing platform 105, intermediary cloud computing platform 240, first party computing system 505, etc.).

By way of example, beacon 605-3 can collect sensor data indicative the user's 620-2 proximity to display case 610A. The sensor data can be provided to the first party to identify a correlation between the first party user 620-2 and an item provided for display at the display case 610A. As another example, beacon 605-9 can collect sensor data indicative the user's 620-3 proximity to an area of the physical location 600 relative to aisles 640A-B. The sensor data can be provided to the first party to identify a correlation between the first party user 620-3 and an item, item(s), and/or item types provided for purchase and/or display relative to aisles 640A-B. For instance, the aisles 640A-B can include one or more sports aisles, food aisles, and/or aisles associated with any other type of items. The sensor data can be provided to the first party to identify a correlation between the user 620-3 and the product types associated with the aisles 640A-B. In some implementations, a number of beacons (e.g., beacons 605-4 and 605-5) can collect overlapping sensor data indicative the user's 620-4 proximity between two display cases, podiums, and/or areas of a physical location (e.g., podium(s) 630A and 630B). The sensor data can be provided to the first party to identify a correlation between the first party user 620-4 and the items associated with both the proximate display cases, podiums, and/or areas of the physical location 600 (e.g., podium(s) 630A and 630B). In addition, or alternatively, a signal strength associated with the overlapping sensor data can be used to determine a display case, podium, and/or area of a physical location closest to the user 620-4 (e.g., podium(s) 630B). In such a case, a correlation can be determined for the user 620-4 and a product, product type, and/or area closest to the user 620-4.

The merchant can be associated with a plurality of first party users 585. The plurality of first party users 585 can include a number of customers and/or potential customers that have purchased, shown interest in purchasing, and/or are otherwise associated (e.g., via a first party account, subscription, etc.) with the merchant. For example, the merchant can have a register of one or more of a plurality of users 585. The register, for example, can include a list of user accounts with the merchant, a list of customers that have previously purchased a product from the merchant, a list of potential customers that have expressed interest (e.g., through a free subscription, a customer service request for product information, etc.) in a product, etc.

In some implementations, the merchant can include and/or otherwise be associated with a first party software application (e.g., configured to provide first party user interface(s) 535). The first party software application can be accessible to one or more of the plurality of first party users 585, for example, via a user device 120 associated with a respective user. The user device 120, for example, can include one or more processors and a memory storing instructions that when executed by the one or more processors cause the device to perform operations. By way of example, as described herein, the user device 120 can include a user's mobile phone, personal laptop, smart watch, and/or any other device associated with a respective customer such as customer 140.

The first party software application can be configured to present one or more first party user interface(s) 535 associated with one or more of the first party items, physical locations 515, etc. to the plurality of first party users 585 through the user device 120 (e.g., through one or more display device(s) of the user device 120). For instance, a first party user interface 535 can provide, for display, a content item (e.g., an advertisement, coupon, etc.) descriptive of a particular first party item, one or more first party items of a particular item type, and/or one or more areas within a physical location 515. A first party user can engage with the first party software application to receive information for first party items/physical locations associated with the merchant, provide information to the merchant (e.g., through a first party user account, etc.), and/or interact (e.g., purchase, favorite, dislike, review, etc.) with a particular first party item.

In some implementations, the user device 120 can include one or more user device sensor(s) 550. The user device sensor(s) 550 can include any type of sensor capable of detecting user activity and/or information associated with user activity. By way of example, the user device sensor(s) 550 can include one or more location sensor(s) (e.g., Global Positioning Systems, etc.), one or more motion sensor(s) such as, for example, accelerometer(s), inertial measurement unit(s), image sensors (e.g., camera, video camera, etc.), one or more audio sensors (e.g., microphone, etc.), and/or any other sensor capable of generating data for determining a motion, location, image, or other data relating to a respective user/user device 120. In some implementations, the user device 120 can be communicatively connected to one or more ancillary user device(s) (e.g., a smart watch, etc.) including at least one of the user device sensor(s) 550. The user device 125 can receive movement data associated with a user of the user device 120 via the user device sensor(s) 550. In some implementations, the movement data can be indicative of a physical interaction (e.g., an approaching action, a viewing action, a touching action, a holding action, etc.) with respect to a first party item and/or physical location 515 associated with the merchant.

As described in further detail herein, the first party computing system 505 can include one or more processors and a memory storing instructions that when executed by the one or more processors cause the first party computing system 505 to perform operations. Moreover, the first party computing system 505 can include and/or have access to one or more secure servers. For example, the first party computing system 505 can be associated with the cloud computing environment hosted by the cloud computing system 515. In this way the first party computing system 505 can access the market intelligence service 205 through the cloud computing system 515. In addition, or alternatively, the first party computing system 505 can include one or more servers configured to perform one or more operations of the market intelligence service 205.

The market intelligence service 205 can provide one or more marketing service(s) (e.g., software services, etc.) for use by the first party computing system 505 (through the cloud computing system 515 and/or a standalone application running at the first party computing system). By way of example, the market intelligence service 205 can offer one or more application programming interfaces (“APIs”) to the first party computing system 505. The one or more API(s) can enable the merchant to securely collect, store, and/or transfer first party data 230 (and/or one or more insights derived thereof) associated with one or more of the plurality of first party users 585.

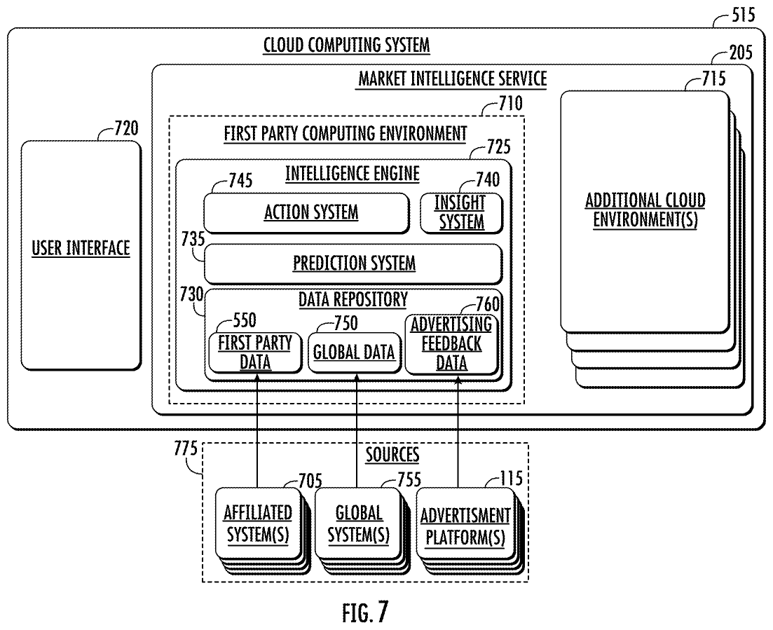

By way of example, FIG. 7 depicts an example cloud computing system 515 according to example aspects of the present disclosure. FIG. 7 illustrates one example in which the market intelligence service 205 is offered by the cloud computing system 515. As noted herein, the market intelligence service 205 can be run and/or accessed by the first party computing system 505 in a variety of manner including, for example, as a standalone application executed by the first party computing system 505 (and/or one or more servers thereof). The example depicted by FIG. 7, the cloud computing system 515 includes a trusted server that hosts a plurality of cloud environments 710, 715 for a plurality of merchants (e.g., apparel, sporting goods, etc.), retailers (e.g., department stores, etc.), marketers (e.g., marketing departments of various retailers, etc.), and/or any other entity with firsthand customer information. Each cloud environment 710, 715 can correspond to a respective first party entity. For example, the respective first party entity (e.g., the merchant associated with first party computing system 505) can create an account with the cloud computing system 515 to enable access to a first party entity specific computing environment 710 hosted by the cloud computing system 515.

The merchant associated with the first party computing system 505 can create and/or access the first party computing environment 710, whereas a plurality of other merchant entities can create and/or access a respective additional cloud environment 715. Each cloud environment 710, 715 can include separate storage space on a secure server accessible only to a respective merchant. In this manner, each first party entity associated with the cloud computing system 515 can independently import respective first party data and utilize one or more API(s) and/or other software tools provided by the cloud computing system 515.

The cloud computing system 515 can include online portal (e.g., user interface 720) that can provide a respective first party entity access to a respective cloud environment for use in collecting, analyzing, and acting on first party data information. The online portal (e.g., user interface 720) can provide access to a separate cloud environment 710, 715 for each participating first party such that information associated with customers of a participating first party can be securely stored without jeopardizing customer privacy.

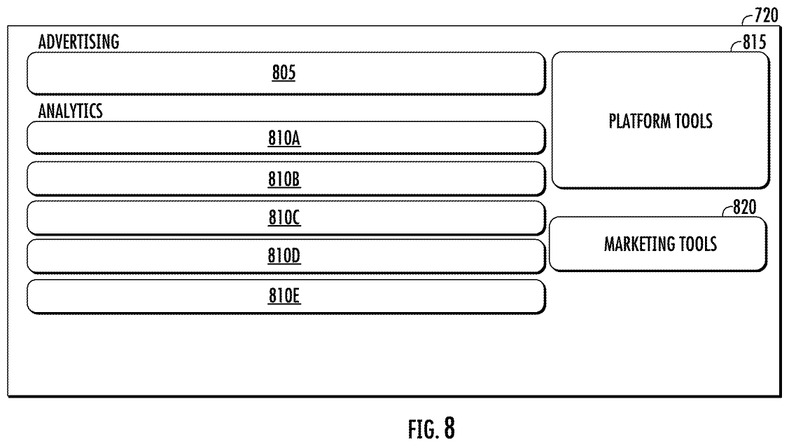

As one example, the first party computing environment 710 can include a user interface 720 (e.g., an online portal to log in, import data, set preferences, generate insights, etc.) and an intelligence engine 725. FIG. 8 depicts an example user interface 820 according to example aspects of the present disclosure. The user interface 820 can provide access to a number of advertising tools 805, analytical tools 810A-E, platform tools 815, and/or marketing tools 820 provided by the cloud computing system. The advertising tools 805 can provide access to one or more customer and/or product insights for the merchant. The analytical tools 810A-E can provide access to one or more data insights for the merchant. For instance, the tools 810A-E can include an analytics tool 810A for gaining historical insights from first party data, data studio tools 810B for gaining insights on data management, an optimization tool 810C for optimizing data mappings and/or management, a survey tool 810D for creating management surveys, and/or a tag manager tool 810E for management of tags, labels, and/or other correlations of imported first party data. The platform tools 815 can provide access to one or more data importations services for importing first party data to the cloud computing system. The marketing tools 820 can provide access to one or more customer insight engines configured to generate customer and/or product insights for the merchant based on the first party information.

Turning back to FIG. 7, the first party computing environment 710 can include an intelligence engine 725 configured to ingest and map data associated with a plurality of first party users of the merchant, gather insights based on the mapped data, and export the insights to one or more third parties (e.g., advertisement platforms, etc.). The intelligence engine 725 can enable merchants to unlock the full potential of their data. For example, the intelligence engine 725 can include a data repository 730, a prediction system 735, an insight system 740, and/or an action system 745. The data repository 730 can be configured to collect data (e.g., through interaction with source(s) 775), the prediction system 735 can be configured to analyze the data, the insight system 740 can be configured to generate one or more insight(s) based, at least in part, on the analysis, and the action system 745 can be configured to initiate an action based, at least in part, on the analysis and/or insight(s).

The informational source(s) 775 can include the plurality of first party device(s), user device(s), and/or any other device, system, or source that provides and/or maintains data relevant to customers (e.g., first party users) of the merchant. For example, with reference to FIG. 5, the first party computing system 505 can receive (and/or import to the first party cloud computing environment 710) first party data 230 associated with the plurality of first party users 585 (e.g., customers, potential customers, etc.) and/or first party products. The first party data 230 can include customer information and/or inventory information for a merchant. The customer information, for example, can include first party user account information (e.g., user preferences, activity information, etc.), transaction records (purchase history, etc.), contextual data (e.g., customer support, physical signals, etc.), and/or any other information related to a first party user 585 of the merchant. The inventory information can include product availability information, product demand information, product specifications, or any other information related to products offered by the merchant.

The customer information can include one or more first party user identifier(s) 570 and/or one or more first party user attribute(s) 575 for each of the plurality of first party users 585. The first party user identifier(s) 570, for example, can include identifiable information for one or more of the plurality of first party users 585. User identifier(s) for a respective user can include a user's name (e.g., first, last, middle, etc.), an electronic address (e.g., email, account number, etc.), a phone number, a physical address (e.g., street, zip code, city, country, etc.), and/or any other identifying information for the first party user 585. The customer information can be obtained directly from a respective first party user, for example, in the event that the respective first party user creates an account with the merchant, purchases a product from the merchant, contacts customer service regarding a promotion, and/or otherwise interacts with the merchant. By way of example, in order to fulfill a transaction, obtain a coupon, etc. the first party user may provide a name, address, and/or other identifying information directly to the merchant.

The first party user attribute(s) 575 can be descriptive of transactions between a first party user and the merchant, preferences and/or interests of the first party user, or other observations for the first party user with respect to the merchant. As an example, the first party user attribute(s) 575 can include transactional attributes indicative of purchase(s) (e.g., a recency of purchases, a frequency of purchases, a monetary value of purchases, etc.) of product(s)/service(s) offered by the merchant. The first party user attribute(s) 575 can also include contextual attribute(s) indicative of observations of a first party user that are not tied to actual transactions. The contextual attributes, for example, can include demographic information (e.g., age, gender, education-level, income-level, etc.), user preferences (e.g., set by a user account, inferred by customer interactions, etc.), user activity (e.g., customer service requests, physical interaction with products, subscriptions, etc.), and/or any other information associated with a respective first party user or potential first party user of the merchant. The contextual attribute(s) can be indicative of an expressed interest from a first party user with respect to a product offered by the merchant. For example, the contextual attributes can describe customer inquiries about a product or related products and/or other expressions of interest by the customer. In some implementations, the contextual attribute(s) can be descriptive of physical interactions (e.g., picking up an item, looking at an item, etc.) between a product and a (potential) first party user.

Turning back to FIG. 7, the first party data 230 can be collected and/or stored through a data repository 730 of the first party computing environment 710. The merchant can leverage one or more API(s) provided by the market intelligence service 205 to obtain, store, analyze, and/or act on the first party data 230 and, in some implementations, supplemental global data 750 and/or advertising feedback data 770. The data repository 730 can be configured to collect the first party data 230 and global data 750 associated with the plurality of first party users from a variety of sources 775 (e.g., affiliated system(s) 705, global system(s) 755, etc.). This enables the data repository 730 to onboard and consolidate data from a plurality of different marketing silos used by the merchant. In some implementations, the data repository 730 can also ingest information provided by affiliated third parties (e.g., the third party computing system 510, etc.). For example, the data repository 730 can receive advertising feedback data 770 provided by affiliated third party, advertisement platform(s) 115.

The source(s) 775, for example, can include a plurality of affiliated system(s) 705 (e.g., third party servers, first party system(s), etc.) configured to run software, platforms, etc. accessible to the first party computing system 505. By way of example, the first party data 230 can include data received through the one or more affiliated system(s) 705. The affiliated system(s) 705, for example, can include customer relationship management software (“CRM system”), customer data platforms (“CDP system”), enterprise resource planning software (“ERP system”) and/or any other software or service accessible to the first party computing system 505. As an example, the CRM systems can include a collection of software accessible to the merchant that is configured to record interactions with users (e.g., customers) of the merchant. The interactions, for instance, can include transactions (e.g., sales, purchases, etc.), technical support, marketing, customer service, and/or any other interaction between a customer/user and merchant. The CDP systems can include a collection of software accessible to the first party computing system 505 configured to create a persistent, unified customer database for the first party computing system 505. For instance, the customer database can include a register of a customer account/profile (e.g., user account/profile) for each of a plurality of customers and/or users affiliated with the merchant. Each account/profile can include recorded information (e.g., transaction history, observed preferences, etc.) compiled for a respective user/customer of the merchant. The ERP systems can include a collection of software accessible to the merchant that is configured to consolidate supply chain information such as physical location information (e.g., location of brick and mortar stores, supply of items at each brick and mortar store, location of warehouses, relative location and supply of items at each store and/or warehouse affiliated with the merchant, etc.), inventory information (e.g., location, availability, supply, demand, etc. of first party products), and/or other information associated with the supply of first party products to customers of the merchant.

The first party computing system 505 can make the data gathered by each of the affiliated system(s) 705 (e.g., CRM systems, CDP systems, ERP systems, etc.) available to the first party computing environment 710. For example, the cloud computing system 515 can be configured to pull data (e.g., with one or more permissions from the first party computing system 505, etc.) from each of the affiliated system(s) 705 to populate the data repository 730. In this manner, the data repository 730 can record first party data 230 from a plurality of different enterprise systems associated with the first party computing system 505.

In addition, or alternatively, the cloud computing system 515 (e.g., first party computing environment 710, etc.) can be configured to pull global data 750 from one or more global system(s) 755 (e.g., third party servers, first party device(s) configured to run globally available software, etc.) accessible to the first party computing system 505 and/or advertising feedback data 770 from one or more advertisement platform(s) 115.

The global data 750 can include publicly accessible datasets related to first party users of the first party computing system 505. By way of example, the global data 750 can be pulled from publicly accessible global system(s) 755 configured to maintain global information. The publicly accessible global system(s) 755, for example, can include weather forecasting system(s) (e.g., national oceanic atmospheric administration, etc.), consumer index system(s) (e.g., consumer confidence index, etc.), and/or any other publicly accessible system or dataset. In this manner, the cloud computing system 515 can populate the data repository 730 with global data 750 indicative of future weather forecasts, measures of consumer confidence, etc.

The advertising feedback data 770 can include data provided by one or more advertisement platform(s) 115 associated with the merchant. By way of example, the advertising feedback data 770 can include at least a portion of the third party data 555 of FIG. 5. In addition, or alternatively, the advertising feedback data 770 can include data gathered and made available to the first party computing system 505 by an affiliated advertisement platform 115. By way of example, the advertising feedback data 770 can include advertisement data collected by one or more advertisement platform(s) 115 such as, for example, marketing analytics, customer acquisitions, advertisement realization events, and/or any other marketing information provided by a collaborative advertisement platform 115.

In some implementations, the data repository 730 can include one or more insights and/or analytics generated by the intelligence engine 725. For example, the intelligence engine 725 can leverage the prediction system 735 to perform analytics on the collected data (e.g., first party data 230, global data 750, advertising feedback data 770, etc.). The prediction system 735 can include a layer of artificial intelligence including a plurality of machine-learning models and/or other predictive algorithms optimized to the merchant.

The machine-learning model(s) can include any type of machine-learning model configured to learn one or more insights from the first party data 230 (e.g., demographic attributes, physical signal information, location attributes, transactional attributes, etc.), global data 750, and/or advertising feedback data 770. As examples, the model(s) can be or can otherwise include various machine-learned models such as neural networks (e.g., deep neural networks), support vector machines, decision trees, ensemble models, k-nearest neighbors models, Bayesian networks, generative adversarial networks, and/or other types of models including linear models or non-linear models. Example neural networks can include feed-forward neural networks, recurrent neural networks (e.g., long short-term memory recurrent neural networks), convolutional neural networks, or other forms of neural networks.

In some implementations, the machine-learning model(s) can include one or more deep neural networks offered by the cloud computing system 515. Access to the deep neural networks, for example, can be provided through one or more interfaces (e.g., API(s), etc.) associated with the cloud computing system 515. The model(s) can include value-based model(s) configured to output value segmentations (e.g., high, medium, low value segmentations, etc.) based on first party data 230, global data 750, and/or advertising feedback data 770. As other examples, the model(s) can include predictive churn model(s) configured to output churn segmentations (e.g., high, medium, low churn rate, etc.), predictive item specific model(s) configured to output item interest segmentations (e.g., high, medium, low interest with respect to respective item(s), etc.) based on first party data, and/or any other model or combinations thereof.

In some implementations, the value-based model(s) can include a predicted lifetime value model configured to output a predictive lifetime value (e.g., high, medium, low) for one or more first party users. The predicted lifetime value model, for example, can include a deep neural network configured to take a plurality of user attributes for a first party user as input and, based on the input, learn to predict a lifetime value for the first party user. The user attributes, for example, can include transactional information and/or contextual data. The transaction information can include information indicative of a recency of the first party user's latest transaction, a frequency of the user's transactions, and/or monetary value (e.g., total, average, etc.) of transaction made by the first party user from the merchant. The contextual attributes can include information indicative of user demographics, location information, and/or information associated with one or more product interactions. In some implementations, the predicted lifetime value model can take in additional data and learn to weigh the additional data based, at least in part, on future transactions between the merchant and first party users. In this manner, the predictive lifetime value model can learn to generate accurate predictions of customer value based, at least in part, on the first party data 230, the global data 750, and/or the advertising feedback data 770 over time.

In addition, or alternatively, the predictive churn model(s) can include deep neural networks configured to output churn segmentations (e.g., high, medium, low churn rate, etc.) for one or more first party users. The predictive churn model(s), for example, can be configured to take a plurality of user attributes for a first party user as input and, based on the input, learn to predict a likelihood that the first party user will stop buying products from the merchant. The predictive churn model(s) can take in the first party data 230, the global data 750, and/or the advertising feedback data 770 learn to weigh different attributes of the data based, at least in part, on future transactions between the merchant and first party users. In this manner, the predictive churn model(s) can learn to generate accurate predictions of customer churn likelihood based, at least in part, on the first party data 230, the global data 750, and/or the advertising feedback data 770 over time.

The predictive item specific model(s) can include product recommendation model(s) configured to output product recommendations (e.g., for up-selling, cross-selling, etc. first party items) for one or more first party users. The product recommendation model(s), for example, can include a deep neural network (and/or any other type of recommendation engine) configured to take a plurality of user attributes (e.g., digital signals indicative of internet activity, physical signals indicative of physical interactions with an item, transaction history, etc.) for a first party user as input and, based on the input, learn to predict interest levels in respective products. In some implementations, the product recommendation model(s) can be configured to output recommended item list(s) (e.g., identifying the top five first party items for each first party user) for one or more of a plurality of first party users.

The merchant can input the first party data 230, the global data 750, and/or the advertising feedback data 770 to the prediction system 735 (and/or one or more model(s) thereof) to receive the one or more insights (and/or group segmentations) associated with the plurality of first party users. The merchant can generate the one or more groups based, at least in part, on such insights. In this manner, the merchant can utilize one or more pre-packaged machine-learning models (e.g., of the prediction system 735) to generate one or more user subsets (e.g., user groups) based, at least in part, on actionable predictive analytics.

For instance, the prediction system 735 can generate the one or more user groups (e.g., segmentations of first party users, etc.) based, at least in part, on the first party data 230, the global data 750, the advertising feedback data 770 and/or one or more insights derived from the predictive model(s). Each of the one or more user groups can include a subset of the plurality of first party users associated with one or more common attributes. The common attribute(s), for example, can include attribute(s) that provide one or more insights for a respective subset of users. For instance, the common attribute(s) can include common demographic attributes, purchase histories, user preferences, etc. with which one or more insights (e.g., a product interest, a value to the merchant, etc.) have been (and/or can be) derived.

For example, the user groups can be generated by leveraging one or more insights of the predictive machine-learning models provided by the market intelligence service 205 (e.g., the prediction system 735). As an example, the user groups can include high-value groups including first party users associated with a high predictive lifetime value (e.g., a lifetime value that achieves a high value threshold, etc.); medium-value groups including first party users associated with a medium predictive lifetime value (e.g., a lifetime value that achieves a medium value threshold, etc.); and/or low-value groups including first party users associated with a low predictive lifetime value (e.g., a lifetime value that achieves a low value threshold, etc.). In addition, or alternatively, the user groups can include high-churn groups including first party users associated with a high predictive churn rate; medium-churn groups including first party users associated with a medium predictive churn rate; and/or low-churn groups including first party users associated with a low predictive churn rate. Moreover, in some implementations, the user groups can include a plurality of similar interest groups. Each of the plurality of similar interest groups can include a subset of first party users with interests in similar items (e.g., a similar top five item list, etc.).

In some implementations, the prediction system 735 can determine group segmentation based, at least in part, on a combination of user insights. By way of example, the prediction system 735 can determine high-value-low-churn rate groups including first party users associated with a high predicted life-time value and a low churn rate; high-value-similar-interest groups including first party users associated with a high predicted life-time value and similar item interests; high-value-high-churn rate groups including first party users associated with a high predicted life-time value and a high churn rate; and/or any other group including any other combination of insights.

The one or more insights can be provided to the insight system 740 and/or the action system 745. The insight system 740 can be configured to store, analyze, and/or report the one or more insights. By way of example, the insight system 740 can generate one or more first party user profiles indicative of one or more insights (e.g., and/or user groups) determined for one or more first party users. The user profile(s), for example, can be indicative of the one or more insights and/or one or more user attribute(s) related to each of the one or more insights. In addition, or alternatively, the insight system 740 can generate one or more user report(s) including a holistic review of a plurality of insights generated for the plurality of first party users over time. The user report(s), for example, can include information indicative of a number, growth over time, etc. of high-value users, expected churn rates, historical churn rates, etc. for the high-value users, etc. The insight system 740 can provide the one or more user profile(s) and/or report(s) for display to a first party user through the user interface 720. In addition, or alternatively, the insight system 740 can provide the one or more user profile(s) and/or report(s) to the data repository 730 for use in generation one or more additional insights.

The action system 745 can be configured to initiate an action based, at least in part, on the one or more insights and/or user groups derived thereof. By way of example, the action system 745 can activate one or more user insights by providing personalized messages (e.g., content items such as advertisements, etc.) to one or more of the first party users and/or by providing instructions to one or more third party system(s) (e.g., advertisement platforms, etc.) to provide specific messages (e.g., content items) to the one or more first party user(s). In some implementations, the action system 745 can create a customer journey (e.g., customer journey 300, etc.) for each of the first party users by correlating activations of insights based on one or more different stages of a first party user's involvement with the merchant. In this manner, the action system 745 can enable a merchant to provide consistent, personalized, and relevant messaging to first party users across a plurality of different user device(s) and/or platform(s) (e.g., third party computing system(s), etc.).

Turning back to FIG. 5, in some implementations, the first party user attribute(s) 575 can include contextual data indicative of an interest level between a respective user and a product and/or service offered by the merchant. For instance, the first party user attribute(s) 575 can include one or more contextual attribute(s). The contextual attribute(s) can be indicative of an expressed interest from a first party user 585 with respect to one or more products(s)/service(s). As examples, the contextual attribute(s) can be descriptive of one or more physical interactions (e.g., picking up an item, looking at an item, etc.) between a product/service and a first party user 585. In addition, or alternatively, the contextual attribute(s) can include a documented user preference (e.g., set by a user account with the merchant), user activity (e.g., browsing history, etc.), and/or any other information descriptive of an interaction between the merchant and the first party user 585.

By way of example, the first party user attribute(s) 575 can include and/or be derived from contextual data indicative of an expressed interest from a first party user 585 with respect to one or more product(s)/service(s) of the merchant. For instance, the contextual data can include physical information 595 descriptive of one or more physical interactions (e.g., picking up an item, looking at an item, etc.) between a product/service and a first party user 585. The contextual data, for example, can include and/or be derived from real-time sensor data indicative of a user's activity (e.g., if the user has opted into a first party program) within a physical location 255 associated with the merchant. For instance, the sensor data can include interaction data, movement data, gesture data, etc. descriptive of physical signals indicative of an interest level between a first party user 585 and a product/service associated with the merchant. The contextual data, for example, can be associated with at least one first party user and at least one first party product of the merchant. For example, the contextual data can be indicative of a location of the first party user relative to one or more of the plurality of first party products associated with the first party. In addition, or alternatively, the contextual data can be indicative of a physical interaction between the first party user and the at least one product.

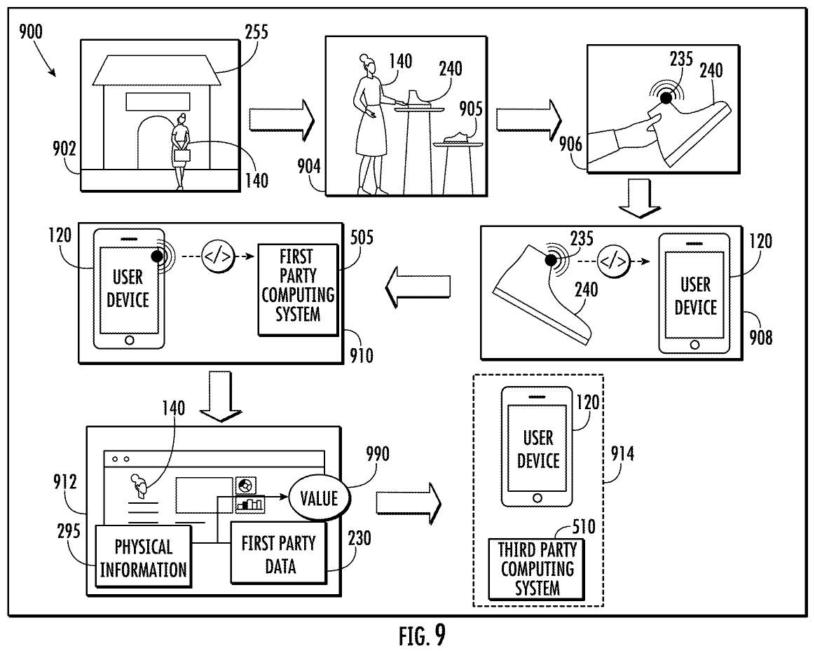

FIG. 9 depicts an example scenario 900 for capturing physical signals according to example aspects of the present disclosure. As depicted, a customer 140 can enter a physical location 255 and interact with one or more product(s) 140, 905 (e.g., a respective product 140, a secondary product 905, etc.) displayed within the physical location 255.

For example, at step (902), the customer 140 can arrive at a physical location 255 (e.g., a store associated with a merchant, etc.). The customer 140 can arrive at the physical location 255, for example, to shop for one or more product(s) 140, 905 (e.g., shoes, etc.) provided by a merchant. In some implementations, the customer 140 can open a first party software application (e.g., associated with first party user interface(s) 535 of FIG. 5) upon arrival, after arrival, and/or during the customer's trip to the physical location 255.

At step (904), the customer 140 can stop at a location relative to the one or more product(s) 140, 905. While stopped at the product(s) 140, 905, at step (906), the customer 140 can signal interest in the respective product 240 by picking up the respective product 240. Upon interacting with the respective product 240, the respective product 240 and/or one or more physical device(s) 235 associated with the respective product 240 can be activated. For example, the physical device(s) 235 can include one or more item sensor(s) (e.g., shoe sensors, etc.) positioned within and/or on the respective product 240. In addition, or alternatively, the physical device(s) 235 can be positioned relative to the respective product 240 such as, for example, on one or more podiums, display cases, hangers, and/or any other area relative to the respective product 240. Upon activation, the physical device(s) 235 can record physical information 595 indicative of the movement of the respective product 240 (e.g., the removed shoe), the duration of the movement, and/or any other information associated with physical actions of the customer 140 and/or the first party item 240.

The physical information 595 can include sensor data and/or communication data derived from the sensor data. For example, the physical information 595 can include sensor data descriptive of the location of the customer 140 relative to the products 140, 905 associated with the merchant. In addition, or alternatively, the physical information 595 can include sensor data descriptive of the physical interaction between the customer 140 and the respective product 240. The physical interaction, for example, can include one of a plurality of different and identifiable interaction types. For example, the interaction types can be indicative of at least one of an approaching action, a viewing action, a touching action, a holding action, and/or any other action descriptive of a customer 140 interacting with the respective product 240.

As one example, the sensor data can include radar data descriptive of one or more user movements (e.g., posture (e.g., lean, etc.), picking up motions, etc.) relative to one or more of product(s) 240, 905 associated with the merchant. For instance, the physical device(s) 235 can include radar sensor(s) associated with the merchant. The sensor data can be generated via the one or more radar sensor(s). By way of example, a radar sensor can emit electromagnetic waves in a broad beam that can be scattered by objects such as product(s) 240, 905, customer 140, etc. and reflected back to the radar sensor. The reflected waves and/or data derived thereof (e.g., an energy, time delay, and/or frequency shift) can be used to determine object characteristics such as, for example, an object size, shape, orientation, material, distance, velocity, etc. In some implementations, the radar signals can be processed to determine temporal signal variations and/or other captured characteristics of a signal. The signal information can be used to identify one or more user movements (e.g., posture (e.g., lean, etc.), picking up motions, etc.) relative to one or more of the product(s) 240, 905 associated with the merchant.

At step (908), physical device(s) 235 can connect to a user device 120 associated with the customer 140. The physical device(s) 235 can automatically communicate the physical information 595 indicative of the movement of the respective product 240 (e.g., the removed shoe), the duration of the movement, and/or any other information associated with physical actions of the customer 140 and/or the respective product 240 to the user device 120. In some implementations, the physical information 595 can be sent with a hashed personal identifier (e.g., hashed via a SHA256 function).

At step (910), the user device 120 can transmit the physical information 595 to the market intelligence service 205. In this manner, the market intelligence service 205 can receive physical information 595 associated with the customer 140 and the physical location 255 associated with the merchant. The physical information 595 can include any data descriptive of a relative location and/or movement of the customer 140 with respect to the respective product 240, item type associated with the respective product 240, and/or area associated with the physical location 255.

At step (912), the market intelligence service 205 can store the physical information 595 (e.g., as first party data 230, etc.). The market intelligence service 205 can analyze the physical information 595 with context the first party data 230 to determine an action for the customer 140. By way of example, the market intelligence service 205 can determine a customer value 990 (e.g., high value, medium value, etc.) for the customer 140 based, at least in part, on the first party data 230 (e.g., a transaction history, etc.) associated with the customer 140 and the physical information 595 (e.g., a duration of time spent with the respective product 240, etc.).

At step (914), the market intelligence service 205 can initiate an action. By way of example, the market intelligence service 205 can provide a content item (e.g., an advertisement such as, for example, a 20% discount code for the respective product 240, etc.) to the user device 120. In addition, or alternatively, the market intelligence service 205 can add the customer 140 to a user group (e.g., a group of first party users with an interest in the respective product 240). In some implementations, the market intelligence service 205 can provide information associated with the user group to the third party computing system 510 for future user servicing operations as described in further detail herein.

For example, turning back to FIG. 5, the third party can be associated with a third party computing system 510. The third party computing system 510, for example, can be associated with an advertisement platform (e.g., the advertisement platform(s) 115 described herein). The advertisement platform can be in collaboration with the merchant, for example, to advertise one or more items or services offered by the merchant. By way of example, the advertisement platform can include an entity configured to provide one or more advertisements and/or other messaging services (e.g., user acquisition, personalized product advertisements, etc.) for the merchant.

The advertisement platform can include and/or be associated with a plurality of third party users 590. The plurality of third party users 590 can have an account with and/or otherwise utilize one or more services, platforms, etc. of the advertisement platform. For example, the advertisement platform can include and/or be associated with an internet browser, a video player application, a social media platform, an advertising agency, and/or any other interactive interface (e.g., third party user interface(s) 545) and/or third party software applications for engaging with the plurality of third party users 590.

By way of example, the advertisement platform can include and/or otherwise be associated with a third party software application (e.g., configured to provide third party user interface(s) 545). The third party software application can be accessible to one or more of the plurality of third party users 590, for example, via user device 120 associated with the third party users 590. The user device 120, for example, can be and/or include one or more of the user device 120 associated with the first party users 585.

The third party software application can be configured to present one or more third party user interface(s) 545 associated with one or more of the first party items, physical locations 515, etc. to the plurality of third party users 590 through the user device 120 (e.g., through one or more display device(s) of the user device 120). For instance, a third party user interface 545 can provide, for display, a content item descriptive of a particular first party item, one or more first party items of a particular item type, and/or one or more areas within a physical location 515. A third party user can engage with the third party software application to receive information for first party items/physical locations associated with the merchant, provide information to the third party (e.g., through a third party user account, etc.), and/or interact (e.g., purchase, favorite, dislike, review, etc.) with a particular first party item.

The advertisement platform can include and/or have access to third party data 555. The third party data 555 can include information associated with the plurality of third party users 590. In some implementations, the third party data 555 can include one or more third party user identifier(s) 560 and/or third party user attribute(s) 565 for one or more of the plurality of third party users 590. The third party user identifier(s) 560 and/or third party user attribute(s) 565 can include any identifier(s) and/or attributes discussed above with reference to the first party user identifier(s) 570 and/or the first party user attribute(s) 575.

In some implementations, the third party data 555 can be indicative of a plurality of third party user accounts associated with an advertisement platform. For instance, the third party data 555 can include one or more user preferences, user identifiers, activity information, etc. for each of the plurality of third party users 590. By way of example, each of the plurality of third party user accounts can include one or more third party user identifier(s) 560 (e.g., a name, email, phone number, physical address, etc.), third party user attribute(s) 565 (e.g., transaction history, user preference(s), etc.), and/or any other information associated with a corresponding third party user.

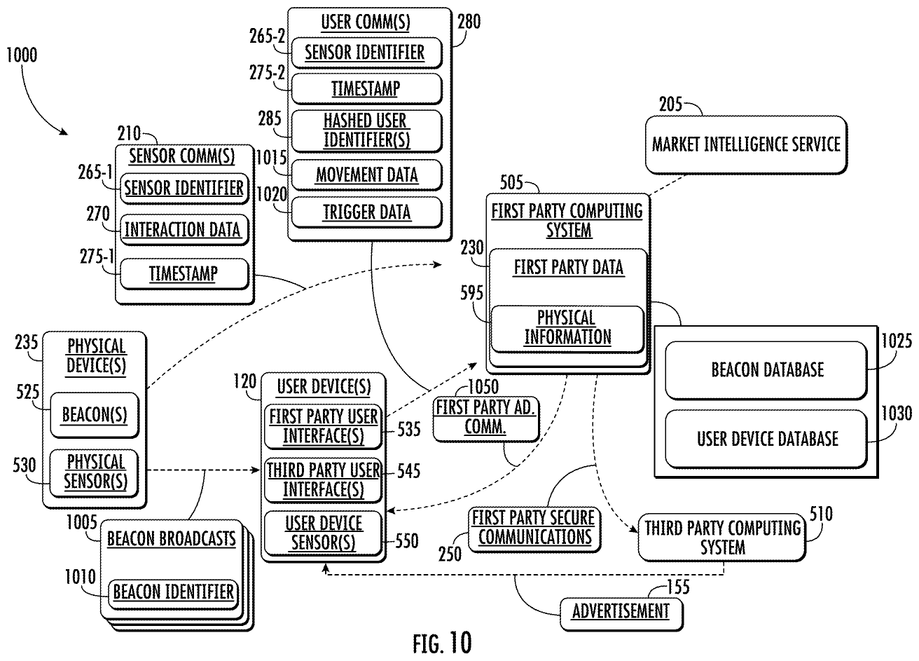

FIG. 10 depicts an example block diagram 1000 for utilizing physical signals according to example aspects of the present disclosure. As depicted, the diagram 1000 includes physical device(s) 235, user device(s) 120, first party computing system 505, and a third party computing system 510. The physical device(s) 235, user device(s) 120, first party computing system 505, and the third party computing system 510 can communicate over one or more network(s) (e.g., communication networks 590 of FIG. 5) and/or using one or more different frequencies (e.g., radio frequencies, etc.).

The first party computing system 505 can receive one or more communication(s) (e.g., sensor communication(s) 260, user communication(s) 280, etc.) and/or sensor data indicative of physical information 595 from at least one of the physical device(s) 235 and/or user device(s) 120. For example, the physical information 595 can include sensor data from one or more physical sensor(s) 530 (e.g., radar sensors, motion sensor(s) etc.) associated with the physical device(s) 235 and/or one or more user device sensor(s) 550 associated with the user device(s) 120. For instance, the first party computing system 505 can receive, store, and/or analyze sensor data via a plurality of physical device(s) 235 associated with a physical location. In addition, or alternatively, the first party computing system 505 can receive, store, and/or analyze sensor data via one or more user device(s) 120 associated with a plurality of users.

In addition, or alternatively, and as depicted by FIG. 10, the physical information 595 can include and/or be derived from communication data. The communication data can include one or more sensor communication(s) 260 received from one or more of the plurality of physical device(s) 235 and/or one or more user communication(s) 280 received from one or more user device(s) 120. For example, the first party computing system 505 can receive a sensor communication 210 from a physical device 235. The sensor communication 210 can be associated with at least one item (e.g., item type, area, etc.) and/or a physical location associated with the first party. In addition, or alternatively, the first party computing system 505 can receive a user communication 280 from a user device(s) 120 associated with at least one first party user of the plurality of first party users associated with the first party.

For example, as described above, the physical device(s) 235 can include at least one of a plurality of first party beacon(s) 525. The first party beacon(s) 525 can be configured to communicate with one or more user device(s) 120. For example, the first party beacon(s) 525 can include one or more radio signal transmitters. By way of example, the first party beacons 525 can include one or more Bluetooth (“BLE”) beacons configured to emit a constant radio signal at one or more radio frequencies (e.g., 3.4 GHz, etc.). Each first party beacon 525 can be configured to emit a plurality of beacon broadcasts 1005 at a predetermined time interval. The time interval can include a constant rate at which the first party beacon 525 emits a respective beacon broadcast 1005. For instance, the time interval can include one or more seconds (e.g., one second, ten seconds, fifteen second, etc.), minutes, etc. A respective beacon broadcast 1005 can be received by one or more user device(s) 120 within a signal range of the respective first party beacon 525. In some implementations, the signal range for each first party beacon 525 can be tunable based, at least in part, on a corresponding item, item type, and/or area of a physical location.

The beacon broadcast 1005 can include a radio signal packet indicative of one or more aspects of the first party beacon 525 (and/or physical device(s) 235). For example, each first party beacon 525 can be associated with a corresponding beacon identifier 1010. A beacon broadcast 1005 from a respective first party beacon can include the corresponding beacon identifier 1010. Accordingly, each respective first party beacon 525 of the plurality of first party beacons can be configured to emit a respective beacon identifier 1010 corresponding to the respective first party beacon 525.

Each beacon identifier 1010 can correspond to at least one first party item, item type, and/or area of a respective physical location associated with the first party. For example, a first party item associated with a beacon identifier 1010 can be disposed within a physical location associated with the first party. For instance, the beacon identifier 1010 can correspond to a first party beacon 525 within a proximity to the first party item associated with the beacon identifier 1010. The first party item associated with the beacon identifier 1010, for example, can be presented within the physical location associated with the first party. In addition, or alternatively, an area associated with a beacon identifier 1010 can include an area within and/or proximate to the physical location associated with the first party. For instance, the beacon identifier 1010 can correspond to a first party beacon 525 within and/or proximate to the area associated with the beacon identifier 1010.

An item type associated with a beacon identifier 1010 can include one or more item types associated with a first party item and/or area corresponding to the beacon identifier 1010. For example, as described herein, one or more of the plurality of first party items and/or areas can be associated with one or more item types. Each item type can be descriptive of one or more common characteristics associated with one or more first party items. For example, an item type can include sports type, a clothing type, a media entertainment type, and/or any other type identifying similar items. By way of example, a first party item used in a sports game (e.g., ball, glove, bat, etc.) can be associated with a sports type. Moreover, an area including a plurality of items associated with a respective item type can be associated with the respective item type.

The user device(s) 120 can receive a plurality of beacon broadcasts 1005. The plurality of beacon broadcasts 1005 can include one or more beacon identifiers 1010 corresponding to one or more first party beacons 525 within a respective physical location associated with the first party. The user device(s) 120 can receive the plurality beacon broadcasts 1005 as the user of the user device(s) 120 moves throughout the physical location. For example, the plurality of received beacon broadcasts 1005 can change based, at least in part, on the user's proximity to each of the plurality of first party beacons 525. In this manner, the plurality of beacon broadcasts 1005 received by the user device(s) 120 can be indicative of a user's location relative to the plurality of first party beacons 525 and the respective physical location.

By way of example, the user device sensor(s) 550 can include one or more beacon detection sensor(s) configured to detect a proximity to one or more first party beacons 525 within a physical location. The beacon detection sensor(s) can include one or more radio receptors configured to receive and/or process one or more radio signal(s) (e.g., Bluetooth signals, etc.) emitted by the first party beacon(s) 525. A proximity to a respective beacon can be inferred by the reception of a radio signal and/or a received signal strength of a radio signal received from a respective first party beacon.

In some implementations, the user device(s) 120 (and/or user thereof) can opt into receiving the plurality of beacon broadcasts 1005. For example, as described herein, the first party computing system 505 (and/or the first party) can be associated with the first party software application configured to run on the user device(s) 120. The user device(s) 120 can be configured to enable the first party software application before receiving the plurality of beacon broadcasts 1005. In some implementations, the first party computing system 505 can detect a proximity of the user to a physical location associated with the first party (e.g., via user input, location data, etc.). For example, the user can scan a barcode upon entering the physical location, the first party computing system 505 can receive location data associated with the user device(s) 120, etc. The first party computing system 505 can provide an initial first party communication to the user device(s) 120 based, at least in part, on the proximity of the user to the physical location. The initial first party communication can include a request to run the first party software application via the user device(s) 120. The first party user can enable the first party software application to opt into receiving the plurality of beacon broadcasts 1005.

By way example, the user device(s) 120 can be configured to execute one or more instructions to enable the first party software application associated with the first party. For example, the user device(s) 120 can receive the initial first party communication including the request to execute the first party software application. The user device(s) 120 can receive user input associated with the initial first party communication. In response to the user input, the user device(s) 120 can execute one or more software instructions to run (e.g., execute, etc.) the first party software application via the user device(s) 120. In some implementations, the plurality of beacon broadcasts 1005 can be received in response to running and/or enabling the first party software application.

The first party computing system 505 can receive physical information 595 based, at least in part, on one or more triggering events. A triggering event, for example, can cause user device(s) 120 and/or a physical device(s) 235 (e.g., first party beacon 525, physical sensor(s) 530, etc.) to provide user communication(s) 280 and/or sensor communication(s) 260, respectively, to the first party computing system 505. The triggering event can be based, at least in part, on a period of time, a strength of a received sensor signal, sensor data obtained by a respective sensor (physical sensor(s) 530, user device sensor(s) 550, etc.), and/or any other metric for facilitating the collection of physical information 595.

For example, the physical device(s) 235 (e.g., first party beacon 525, physical sensor(s) 530, etc.) can detect the triggering event. The triggering event, for example, can be indicative of the reception of sensor data by the physical device(s) 235 (e.g., first party beacon 525, physical sensor(s) 530, etc.). For example, the physical device(s) 235 (e.g., first party beacon 525, physical sensor(s) 530, etc.) can detect a triggering event in response to receiving sensor data (e.g., radar data, image data, audio data, location data, tactile data, etc.) indicative of a physical interaction between a first party user and at least one first party item associated with the first party. In response, the physical device(s) 235 can generate a sensor communication 210 including the interaction data 270 indicative of the physical interaction between the first party user and the at least one first party item. For example, the sensor communication 210 can include a communication from a first party beacon 525 associated with the at least one first party item. The sensor communication 210 can include a sensor identifier 265-1 corresponding to a first party beacon 525, a beacon timestamp 275-1 indicative of a time of transmission and/or generation of the sensor communication 210, and/or interaction data 270 indicative of the physical interaction between the first party user and the at least one first party item. The sensor identifier 265-1, for example, can correspond to a beacon identifier 1010 broadcast by the first party beacon 525. The first party computing system 505 can receive the sensor communication 210 from the physical device 235 associated with the at least one first party item.

In addition, or alternatively, the user device(s) 120 can detect a triggering event associated with at least one of one or more beacon identifiers 1010 corresponding to the plurality of received beacon broadcasts 1005. As one example, the triggering event can be based, at least in part, on a threshold period of time. For instance, the user device(s) 120 can receive a beacon broadcast 1005 including a particular beacon identifier at a plurality of times (e.g., time steps, etc.). The plurality of times can include a plurality of at least partially consecutive times. The user device(s) 120 can determine a period of time between the reception of the first beacon broadcast including the particular beacon identifier and the last beacon broadcast including the particular beacon identifier. The user device(s) 120 can detect the triggering event in response to determining that the period of time between the reception of the first and last beacon broadcast achieves (e.g., is equal to or longer than, etc.) the threshold period of time. In some implementations, the beacon broadcasts 1005 can be emitted at a predetermined time interval. In such a case, the user device(s) 120 can detect the triggering event in response to receiving a beacon broadcast including the particular beacon identifier at each time step of the predetermined time interval during the period of time between the first and last beacon broadcast.

As another example, the triggering event can be based, at least in part, on a threshold received signal strength indicator (“RSSI”). The threshold received signal strength indicator (“RSSI”), for example, can correspond to a particular distance (e.g., one or more centimeters, inches, feet, meters, etc.) from a respective first party beacon 525. The user device(s) 120 can determine a received signal strength for each of the plurality of received beacon broadcasts 1005 and compare each received signal strength to the threshold RSSI. The user device(s) 120 can detect the triggering event in response to determining that a respective received signal strength for a respective beacon broadcast 1005 that includes a particular beacon identifier achieves (e.g., is greater than or equal to) the threshold received signal strength indicator. In this manner, the triggering event can be detected based, at least in part, on a proximity of the user device(s) 120 to a first party beacon 525 (and/or a corresponding item, item type, area, etc.).

The user device(s) 120 can detect a triggering event associated with at least one sensor identifier 265-1 and, in response, provide a user communication 280 to the first party computing system 505. The at least one sensor identifier 265-1 can correspond to a beacon identifier 1010 that satisfies or causes a triggering event. For example, the user device(s) 120 can generate the user communication 280 for the first party computing system 505 associated with the first party. The user communication 280 can include data indicative of a sensor identifier 265-2 and/or one or more characteristics associated with the triggering event (e.g., triggering data 1020) or the user device(s) 120 (e.g., hashed user identifier(s) 285).

For example, the user communication 280 can include data indicative of one or more characteristics associated with the triggering event. For example, the user communication 280 can include trigger data 1020 indicative of the period of time between the first and last received broadcast associated with the particular sensor identifier 265-2. As another example, the trigger data 1020 can include data indicative of a respective received signal strength indicator for at least one received beacon broadcast associated with the particular sensor identifier 265-2. For instance, the user communication 280 can include the highest RSSI recorded for one or more beacon broadcasts 1005 associated with the particular sensor identifier 265-2.

In addition, or alternatively, the user communication 280 can include physical information 595 indicative of a physical interaction between the user and the at least one item. For example, the physical information 595 can include movement data 1015 indicative of one or more user movements. As described herein, the movement data 1015 can include sensor data descriptive of one or more physical interactions with an item associated with the at least one sensor identifier 265-2. The user device(s) 120, for example, can receive the movement data 1015 via user device sensor(s) 550. The user device(s) 120 can determine that at least a portion of the movement data 1015 is received proximate to the triggering event. For example, the user device(s) 120 can determine that the portion of the movement data 1015 is received at least partially during the period of time between the first and last beacon broadcast associated with the particular sensor identifier 265-2. In addition, or alternatively, the user device(s) 120 can determine that the portion of the movement data 1015 is received within a period of time of the reception of the received beacon broadcast associated with a received signal strength achieving the threshold RSSI. The user device(s) 120 can generate the user communication 280 based, at least in part, on the movement data 1015. For example, the user communication 280 can include at least the portion of the movement data 1015.

In some implementations, the user communication 280 can include data indicative of one or more user identifiers associated with the first party user of the user device(s) 120. To preserve the privacy of the first party user, the user device(s) 120 can encrypt the one or more user identifiers before providing the user communication 280 to the first party computing system 505.

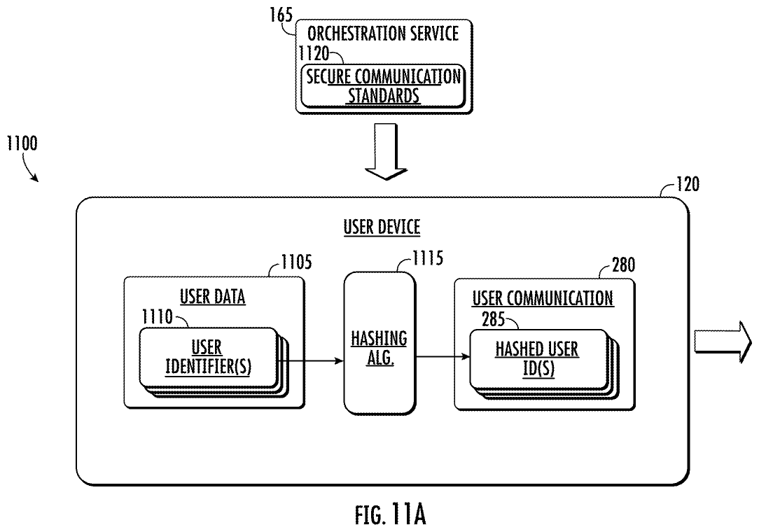

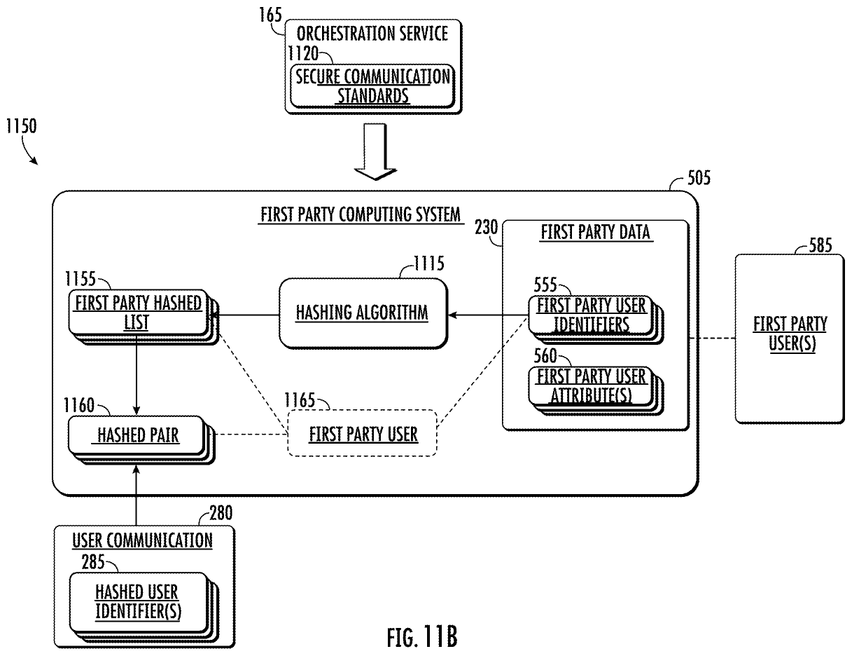

For example, FIG. 11A depicts an example block diagram 1100 for generating a privacy conscious communication via a user device 120 according to example aspects of the present disclosure. As depicted, the user device(s) 120 can include user data 1105 indicative of one or more user identifier(s) 1110 associated with the first party user of the user device(s) 120. For example, the user identifier(s) 1110 can be indicative of a name (e.g., first name, last name, username, etc.), address (e.g., physical address, digital address (e.g., email, etc.), phone number, and/or any other identifiable information discussed herein with reference to the user information attribute(s) 180-1, 185-1 of FIG. 1B. In some implementations, the user identifier(s) 1110 can be stored at the user device(s) 120 in association with the first party software application. For example, the user identifier(s) 1110 can include a username, email, and/or login information associated with a first party software application and/or a user profile for the first party software application.

The user device(s) 120 can generate one or more hashed user identifier(s) 285 referencing the user identifier(s) 1110 based, at least in part, on the user identifier(s) 1110 and the hashing algorithm 1115. For instance, the user device(s) 120 can apply the hashing algorithm 1115 to the user identifiers 1110 to generate the hashed user identifier(s) 285. The hashing algorithm 1115 can include any type of hashing function such as, for example, at least one of a message digest algorithm (e.g., MD5), secure hash algorithm (e.g., SHA-0, SHA-1, SHA-2, etc.), local area network manager algorithm (e.g., LANMAN, NTLM, etc.), etc. In some implementations, for example, the hashing algorithm 1115 can include SHA-1 and/or SHA-256. The user communication 280 can include data indicative the hashed user identifier(s) 285. In some implementations, the user communication 280 can identify the hashing algorithm 1115.

In some implementations, the hashing algorithm 1115 can be determined by the orchestration service 165. For example, the user device 120 can generate the hashed user identifier(s) 285 based, at least in part, on secure communication standards 1120 received from an orchestration service 165 as described herein. For example, the secure communication standards 1120 can identify a particular hashing algorithm 1115 to apply to the user identifier(s) 1110 to individually hash each of the user identifier(s) 1110.

Turning back to FIG. 10, the user device(s) 120 can provide the user communication 280 to the first party computing system 505 (e.g., in the privacy conscious manner described herein). In some implementations, the user device(s) 120 can receive one or more additional beacon broadcast(s) at a time subsequent to the triggering event. For example, the additional beacon broadcast can include one or more beacon broadcasts 1005 associated with the particular sensor identifier 265-2 received at one or more times subsequent to the reception of the last beacon broadcast. In such a case, the user device(s) 120 can generate one or more additional user communications 280 for the first party computing system 505. Each additional user communication 280 can include the particular sensor identifier 265-2 and a device timestamp 275-2 corresponding to the additional beacon broadcast. The user device(s) 120 can provide the one or more additional user communications 280 to the first party computing system 505. The first party computing system 505 can receive the user communication(s) 280 and determine one or more user insights based, at least in part, on the user communication(s) 280.

In some implementations, the insight(s) can be based on first party data 230 associated with the first party user of the user device(s) 120. For example, the first party computing system 505 can receive user data corresponding to a first party user associated with the communication(s) 210, 280 and/or physical information 595 (e.g., interaction data 270, movement data 1015, etc.). The user data, for example, can include a portion of the first party data 230 corresponding to the first party user. For example, the user data can be indicative of one or more user characteristics for the user. The user characteristics, for example, can include one or more user identifiers and/or user attributes for the user as described herein. By way of example, the user data can include one or more user identifiers indicative of the user device(s) 120 associated with the user and/or one or more user accounts associated with the user. In addition, or alternatively, the user data can include one or more user attributes indicative of at least one of a transaction history associated with the respective user, one or more user account preferences of a user account with the first party, and/or any other user attribute described herein.

For instance, the first party computing system 505 can reference the first party user associated with the communication(s) 210, 280 and/or physical information 595. The first party computing system 505 can selectively receive the user data based, at least in part, on the identity of the first party user. For example, the first party computing system 505 can reference the first party user corresponding to the communication(s) 210, 280 and/or physical information 595 via one or more sensor processing techniques (e.g., facial recognition, etc.) and/or one or more cryptographic techniques.

By way of example, FIG. 11B depicts an example block diagram 1150 for referencing a first party user 1165 based on a privacy conscious communication according to example aspects of the present disclosure. The first party computing system 505 can receive the user communication 280 from the user device associated with a first party user 1165 that includes one or more irreversible hashed user identifier(s) 285. The first party computing system 505 can receive the first party data 230 associated with the plurality of first party users 585 and reference the first party user 1165 based, at least in part, on the hashed user identifier(s) 285, the first party data 230, and a hashing function (e.g., hashing algorithm 1115). For example, the first party computing system 505 can generate a first party hashed list 1155 including a plurality of hashed user identifiers for one or more of the plurality of first party users 285 based, at least in part, on the hashing function 1115. The first party computing system 505 can compare the plurality of hashed user identifiers to the hashed user identifier(s) 285 to determine a user match (e.g., hashed pair 1160) between at least one of the plurality of hashed user identifiers and the hashed user identifier(s) 285. The first party computing system 505 can reference the first party user 1165 based, at least in part, on the hashed pair 1160. By way of example, the first party user 1165 can include a first party user 530 corresponding to the at least one matching hashed user identifier.

In this manner, the first party computing system 505 can compare the hashed user identifier(s) 285 to first party data 230 to reference the first party user 1165 associated with the user communication 280 without any prior knowledge of the user device. For example, in the event that the first party user 1165 is affiliated with the first party (e.g., via the first party software application, a previous transaction with the first party, etc.) before the user communication 280, the first party data 230 can include first party user identifiers 570 corresponding to a respective first party user identifier for the affiliated user 1165. This enables the first party computing system 505 to reference the first party user 1165 despite the irreversibility of the hashed user identifier(s) 285 (e.g., which are unrecoverable due to the hash) by hashing the same information hashed by the user device and matching the hashed information to at least a portion of the hashed user identifier(s) 285. In this manner, a user device can securely transmit hashed information associated with first party user 1165 over one or more networks (e.g., secure, or unsecure) without exposing user information to malicious parties.

More particularly, the first party computing system 505 can generate a first party hashed list 1155 based, at least in part, on the first party data 230 and the hashing algorithm 1115. The hashing algorithm 1115 can include any type of hashing function such as, for example, any of the hashing algorithms described herein. In some implementations, the hashing algorithm 1115 can be the same hashing algorithm utilized by the user device(s) 120. The first party computing system 505 can apply the hashing algorithm 1115 to at least one of the one or more first party user identifiers 570 for each of the plurality of first party users 585 (e.g., user accounts, etc.) to generate the first party hashed list 1155.

In some implementations, the user communication 280 can identify the hashing algorithm 1115. In such a case, the first party computing system 505 can generate the first party hashed list 1155 by applying the hashing algorithm 1115 identified by the user communication 280. In some implementations, the hashing algorithm 1115 can be determined by the orchestration service 165. For example, the user device 120 can generate the first party hashed list 1155 based, at least in part, on the secure communication standards 1120 received from the orchestration service 165 as described herein. For example, the secure communication standards 1120 can identify a particular hashing algorithm 1115 to apply to the first party user identifier(s) 570 to individually hash each of the first party user identifier(s) 570.

The first party hashed list 1155 can include a plurality of hashed first party identifiers corresponding to the plurality of first party user identifiers 570. For example, each hashed first party identifier can correspond to a respective first party user identifier. Each hashed first party identifier can reference a respective first party user based, at least in part, on the corresponding first party user identifier. The plurality of first party user identifiers 570 corresponding to the first party hashed list 1155 can at least in part overlap the one or more user identifier(s) used as a basis for the hashed user identifier(s) 285. The first party computing system 505 can generate a hashed pair 1160 based, at least in part, on the hashed user identifier(s) 285, the first party hashed list 1155, and the first party data 230 (e.g., the corresponding first party user identifiers 570, etc.). For example, the first party computing system 505 can determine a hashed pair 1160 between the first party hashed list 1155 and the hashed user identifier(s) 285 of the user communication 280. The first party computing system 505 can reference at least one of the plurality of first party users 1165 (and/or user accounts) based, at least in part, on a correlation between the hashed pair 1160 and the first party user identifier(s) 570.

Turning back to FIG. 10, the first party computing system 505 can determine an insight for the first party user based, at least in part, on an item interest level. For example, the first party computing system 505 can determine an item interest level for at least one first party item based, at least in part, on the physical information 595 and/or the user data.

As one example, the item interest level can be determined based, at least in part, on the user communication 280. The first party computing system 505, for example, can identify at least one item based, at least in part, on the sensor identifier 265-2 included in the user communication 280 (e.g., in the event that the sensor identifier 265-2 corresponds to at least one item). The first party computing system 505 can determine a user-item association based, at least in part, on the sensor identifier 265-2 (e.g., the identified item corresponding thereto) and the hashed user identifier(s) 285 (e.g., the referenced first party user corresponding thereto) of the user communication 280. The first party computing system 505 can determine the item interest level for the at least one item based, at least in part, on the user-item association.

As another example, the first party computing system 505 can identify at least one area of a physical location based, at least in part, on the sensor identifier 265-2 included in the user communication 280 (e.g., in the event that the sensor identifier 265-2 corresponds to at least one area). The first party computing system 505 can determine a user-area association based, at least in part, on the sensor identifier 265-2 (e.g., the identified area corresponding thereto) and the hashed user identifier(s) 285 (e.g., the identified first party user corresponding thereto) of the user communication 280. The first party computing system 505 can determine the item interest level for at least one item based, at least in part, on the user-area association. For instance, the at least one item can include one or more items associated (e.g., presented, stored, etc. within) the area corresponding to the sensor identifier 265-2.

As yet another example, the first party computing system 505 can identify at least one item type based, at least in part, on the sensor identifier 265-2 included in the user communication 280 (e.g., in the event that the sensor identifier 265-2 corresponds to at least one item type). By way of example, the item type can include one or more item types associated with an area and/or first party item corresponding to the sensor identifier 265-2. The first party computing system 505 can determine at least one item type of a plurality of item types associated with the beacon identifier and/or physical information 595. The first party computing system 505 can determine a user-type association based, at least in part, on the sensor identifier 265-2 (e.g., the identified item type corresponding thereto) and the hashed user identifier(s) 285 (e.g., the identified first party user corresponding thereto) of the user communication 280. The first party computing system 505 can determine the item interest level for at least one item based, at least in part, on the user-type association.

By way of example, each of the plurality of item types can identify one or more associated items. The first party computing system 505 can determine the item interest level for the at least one first party item based, at least in part, on the one or more associated items corresponding to at least one item type. For instance, the at least one first party item can include one or more first party items associated with the item type corresponding to the sensor identifier 265-2 and/or physical information 595. By way of example, the at least one first party item can include one or more first party items corresponding to the at least one item type.

In some implementations, the item interest level can be determined based, at least in part, on additional physical information 595. For example, the first party computing system 505 can determine the item interest level based, at least in part, on movement data 1015 received from the user device(s) 120, interaction data 270 received from physical device(s) 235 (e.g., beacon(s) 525, physical sensor(s) 530), trigger data 1020 (e.g., a period of time between a first and last beacon communication, a signal strength of a received beacon communication, etc.) and/or any physical information 595 described herein.

By way of example, first party computing system 505 can correlate the interaction data 270 (and/or other physical information 595) received through a sensor communication 210 to movement data 1015 (and/or other physical information 595) received through a user communication 280 by comparing the beacon timestamp 275-1 and/or the sensor identifier 265-1 of the sensor communication 210 to the device timestamp 275-2 and/or sensor identifier 265-2 of the user communication 280. As an example, the first party computing system 505 can store a plurality of beacon communication records in a beacon database 1025. In addition, or alternatively, the first party computing system 505 can store a plurality of device communication records in a user device database 1030. The plurality of beacon communication records and the plurality of device communication records can be compared to determine one or more beacon-device matches. Each beacon-device match can include a respective beacon communication and a respective device communication associated with a respective beacon timestamp and device timestamp within a threshold time period (e.g., one, five, etc. seconds). In addition, or alternatively, each beacon-device match can include a respective beacon communication and a respective device communication associated with matching beacon identifiers.

The first party computing system 505 can determine an interaction type associated with the interaction data 270 and/or the movement data 1015. The interaction type can be indicative of a respective interaction between a first party user and at least one first party item. For instance, the interaction type can identify an approaching action (e.g., data descriptive of the first party user walking up to an item, etc.), a viewing action (e.g., data descriptive of the first party user stopping and looking at an item, etc.), a touching action (e.g., data descriptive of the first party user picking up and/or otherwise handling the item, etc.), and/or a holding action (e.g., data descriptive of the first party user picking up and/or otherwise handling the item for a period of time, etc.). The first party computing system 505 can determine the item interest level based, at least in part, on the interaction type such that more significant actions such as, for example, a touching/holding action can result in a higher interest level for the item than a less significant action such as, for example, an approaching/viewing action.

In some implementations, the physical information 595 can include gesture data. The gesture data, for example, can include sensor data (e.g., interaction data 270, movement data 1015, etc.) indicative of one or more postures, positions, and/or actions of a user with respect to at least one item. The gesture data can be determined from raw sensor data such as, for example, image data, radar data, etc. The first party computing system 505 can receive the gesture data for the user by inputting the raw sensor data (e.g., radar data) to a gesture recognition machine-learning model (e.g., a model of the prediction system 735, etc.) configured to identify one or more gestures corresponding to radar data. The gesture recognition machine-learning model can be provided by the market intelligence service 205 (e.g., one or more APIs thereof) associated with the first party computing system 505. The first party computing system 505 can determine the item interest level for the at least one item based, at least in part, on the gesture data.

In some implementations, the first party computing system 505 can determine a secondary interest level for one or more associated users (e.g., associated with the first party user, etc.) based, at least in part, on the physical information 595 and the user data. The associated users, for example, can include one or more of the plurality of first party users associated with one or more common attributes (e.g., similar interest levels, preferences, age, etc.). In some implementations, the user data can be descriptive of the one or more associated users with respect to the first party user. The first party computing system 505 can determine the secondary interest level for at least one of the one or more associated users based, at least in part, on a user-item association, a user-type association, a user-area association, and/or any other interest level determined for the respective first party user.

The first party computing system 505 can initiate an action based, at least in part, on the interest level, the user data, and/or the physical information 595. In some implementations, the action can be initiated based, at least in part, on a customer journey (e.g., journey 300 of FIG. 3, etc.)) and/or stage of a product lifecycle (e.g., lifecycle of FIG. 4). The action can include initiating (e.g., directly and/or indirectly through a third party) the presentation of product information to the customer(s) referenced by a sensor/user communication. The product information can be determined based on the interest level for the respective item, item type, and/or area of the physical location. The information provided can be tailored to a respective customer journey for the customers and/or a stage (e.g., an availability, etc.) of the respective item, items of a respective item type, and/or items located in a respective area of the physical location.

For example, the first party computing system 505 can initiate the presentation of a content item (e.g., advertisement, incentive to purchase a product, etc.) to the first party user via the user device(s) 120 associated with the first party user. The presentation of the content item can be based, at least in part, on the user data and/or the item interest level for the at least one first party item, item type, and/or area. By way of example, the content item can include information for the at least one first party item, first party items of the item type, and/or first party items located within a respective area.

For example, the first party data 230 can include item data. The item data can be indicative of one or more characteristics for each respective item of the plurality of items associated with the first party. The item data, for example, can identify one or more item attributes (e.g., associated item types, item reviews, item user manuals, item prices, prices relative to competing items, etc.), one or more product offerings (e.g., one or more incentives to purchase the item, a price reduction, etc.), inventory information (e.g., in stock or out of stock, number of onsite items, etc.), and/or any other information associated with a respective item.

The first party computing system 505 can generate the content item based, at least in part, on the user data, the item interest level, and/or the first party item (e.g., item data thereof). By way of example, the content item can include one or more item details for the at least one item, one or more incentives for purchasing the at least one item, one or more item advertisements tailored for the first party user, and/or one or more associated item details (e.g., advertisements for associated items, etc.) for one or more associated items associated with the at least one item. In some implementations, the content item can include item inventory data for the at least one item. The inventory data can be indicative of whether the at least one item includes an onsite item (e.g., located at a respective physical location) and/or an offsite item (e.g., unavailable at the physical location). In the event that the at least one item includes an onsite item, the content item can include at least one of an incentive to purchase (e.g., a product offering, etc.) the onsite item from the physical location, location information for finding the onsite item within the physical location, directions to the item, etc. In the event the at least one item includes an offsite item, the content item can include at least one of an incentive to purchase (e.g., a product offering, etc.) the offsite item from another location and/or location information for finding the offsite item at the other location, etc.

In some implementations, the first party computing system 505 can generate the content item based, at least in part, on the one or more items associated with the at least one item. For example, the one or more items can be associated with an item type and/or area associated with the at least one item. For example, the content item can include data indicative of at least one of the one or more items corresponding to the at least one item type.

As an example, the content item can include item inventory data for at least one item of the one or more items corresponding to the at least one item type. For example, the first party computing system 505 can receive item inventory data for at least one of the one or more associated items. The item inventory data can identify an availability of the one or more associated items at the physical location. The first party computing system 505 can provide data indicative of the item inventory data to the user device(s) 120.

For instance, the first party computing system 505 can determine, based, at least in part, on the item inventory data, that at least one of the one or more associated items is unavailable at the physical location. In response to determining that the at least one associated item is unavailable, the first party computing system 505 can provide data indicative of another physical location associated with the first party where the associated item is available. In some implementations, for example, the first party computing system 505 can provide information indicative of an online ordering form for the at least one associated item.

In addition, or alternatively, the first party computing system 505 can determine, based, at least in part, on the item inventory data, that at least one of the one or more associated items is available at the physical location. In response to determining that the at least one associated item is available, the first party computing system 505 can provide data indicative of an incentive to purchase the at least one associated item at the physical location, a relative location of the associated item, etc.

As another example, the content item can include item location data for at least one onsite item of the one or more items corresponding to the at least one item type. By way of example, in some implementations, a content item can include item location data for at least one of the one or more associated items. The item location data can be indicative of a location of the at least one associated item within the physical location. For example, the content item can include one or more directions to the location of at least one associated item within the physical location. In some implementations, the content item can include an incentive to purchase the onsite item associated with the at least one item type.

The first party computing system 505 can determine whether to generate the content item based, at least in part, on the item interest level. For example, the first computing system can compare the item interest level to a threshold interest level. The threshold interest level can include a predetermined interest level and/or a dynamically determined interest level for each of one or more of the plurality of first party items associated with the first party. In some implementations, the predetermined interest level can be item-specific. For example, each of the one or more first party items can be associated with a particular predetermined interest level. The threshold interest level for a respective item (and/or item type/area) can be dynamically adjusted based, at least in part, on item data associated with the first party item (and/or item type/area). As an example, the threshold interest level can be adjusted based, at least in part, on inventory data (and/or a stage of a product's lifecycle) associated with the first party item (and/or item type/area). By way of example, the threshold interest level for a respective item can be decreased in response to a low supply of the respective first party item and/or increased in response to a high supply of the respective first party item. In addition, or alternatively, the threshold interest level can be adjusted based, at least in part, on a demand for the respective first party item, an available product offering for the respective first party item, an age of the respective first party item, and/or any other information associated with the respective first party item.

The first party computing system 505 can provide data indicative of the content item to the user device(s) 120. For instance, the first party computing system 505 can provide a first party advertising communication 1050 to the user device(s) 120. The first party advertising communication 1050 can be configured to cause a first party user interface 535 of the first party software application to display the content item associated with the at least one item (and/or item type/area). The first party advertising communication 1050, for example, can include data indicative of the content item and one or more instructions to provide the data indicative of the content item for display via the first party user interface 535. In this manner, the first party computing system 505 and/or the user device(s) 120 can provide, for display, data indicative of an item via a first party user interface 535 of the first party software application.

The first party advertising communication 1050 can include one or more timing instructions. For example, the timing instructions can identify a time (e.g., relative to reception of the second party communication, at a particular time step, etc.) at which the user device(s) 120 can display the data indicative of the content item. In this manner, the user device(s) 120 can be configured to display the content item in real-time and/or at one or more subsequent times. By way of example, the user device(s) 120 can be configured to display the content item via the first party user interface 535 within the predetermined time period of the physical interaction.

In some implementations, the first party computing system 505 can provide the content item for presentation to the user via a first party user interface 535 associated with a user account with the first party. By way of example, the user device(s) 120 can be configured to display the content item via the first party user interface 535 associated with at least one of one or more user accounts corresponding to the user. The user device(s) 120 can be configured to display the content item via the first party user interface 535 associated with the at least one of the one or more user accounts within the predetermined time period of the physical interaction.

The user device(s) 120 can receive the first party advertising communication 1050 indicative of the first party item, item type, and/or area. In response to the first party advertising communication 1050 (and/or one or more instructions thereof), the user device(s) 120 can provide for display the data indicative of the first party item, item type, and/or area. The content item can be presented via the first party user interface 535 of the first party application executed by the user device(s) 120.

In some implementations, the first party computing system 505 can determine one or more insights based, at least in part, on the item interest level and/or first party data 230. The insight(s), for example, can be indicative of an item interest over time, a value of a first party user to the first party over time, an expected churn rate for the first party user, and/or any other information associated with the first party user's relationship with the first party. In some implementations, the insight(s) can include one or more groupings of users according to one or more common characteristics for one or more of the plurality of first party users. For example, the first party computing system 505 can generate a user insight based, at least in part, on the item interest level for at least one item and/or first party data associated with the plurality of first party users.

By way of example, the first party computing system 505 can generate a user group (e.g., using the one or more predictive model(s) of FIG. 7) based, at least in part, on the one or more user attributes and/or insight thereof for each of the plurality of first party users and the item interest level for the first party user. For example, a user group can be indicative of a subset of the plurality of users (e.g., grouped based on common attributes) with a predicted interest in the at least one item, item type, and/or area. In some implementations, the first party computing system 505 can initiate an action (e.g., the presentation of the content item to the user via the user device(s) 120 associated with the user) based, at least in part, on the generated user group.

In addition, or alternatively, the first party computing system 505 can receive data indicative of a user group. The user group can be indicative of a subset of the plurality of first party users with a predicted interest in at least one first party item. In some implementations, the first party computing system 505 can update the user group based, at least in part, on the one or more user attributes for a first party user and an item interest level for the user. For example, each user of the subset of the plurality of first party users can be associated with a respective item interest level for the at least one item. In some implementations, the first party computing system 505 can update the user group in the event that the item interest level for a first party user (e.g., not already in the user group) achieves the threshold interest level for the first party item. The first party computing system 505 can initiate the action (e.g., presentation of the content item to the user via the user device(s) 120 associated with the user, etc.) based, at least in part, on the user group.

In some implementations, the first party computing system 505 can leverage a third party computing system 510 to initiate the action. For example, the first party computing system 505 can generate a first party secure communication 250 for the third party computing system 510 based, at least in part, on one or more insights (and/or user groups thereof) for the plurality of first party users. The first party secure communication 250 can include and/or otherwise identify one or more hashed user identifiers. In addition, the first party secure communication 250 can include one or more service requests for the third party computing system 510.

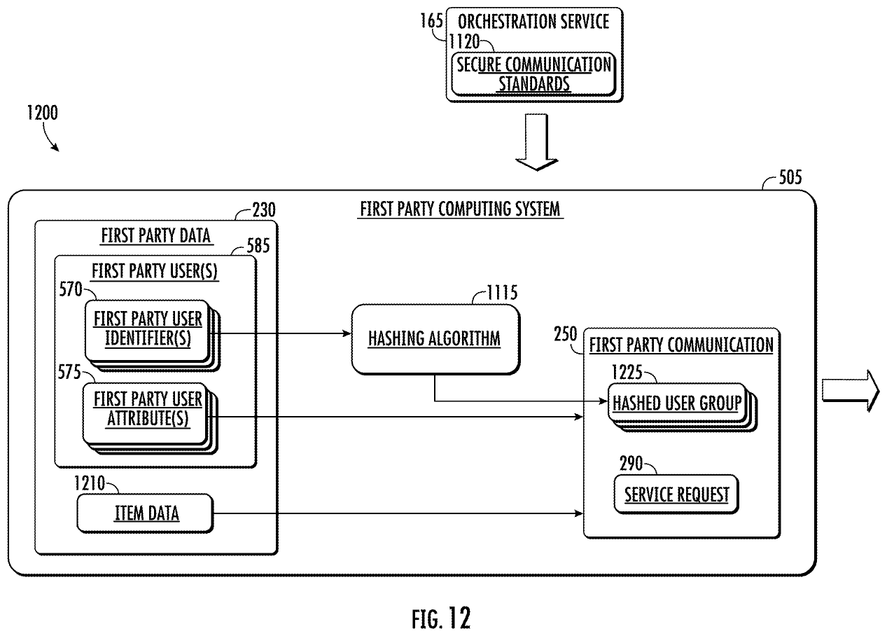

For example, FIG. 12 depicts an example block diagram 1200 for generating a privacy conscious communication according to example aspects of the present disclosure. As depicted, the first party computing system 505 can generate the first party secure communication 250 based, at least in part, on the first party user identifier(s) 570 associated with a subset of the first party users 585 and, in some implementations, item data 1210 of the first party data 230. The first party secure communication 250 can include a hashed user group 1225 made up of a plurality of individually hashed first party user identifier(s) 570 and a service request 290. The service request 290 can include an indication of the hashed user group 1225 and/or a request to perform one or more service operations for the merchant. The service operations can include, for example, providing personalized advertisements (e.g., based on a respective stage of a customer journey 300, etc.) for the merchant to third-party users, providing inventory aware advertisements (e.g., based on a respective stage of a product life cycle 400, etc.) for the merchant to third party users, and/or any other operation to facilitate consistent messaging across various third-party platforms.

The first party secure communication 250 can include first party data 230 such as first party user attributes 575, item data 1210, and/or insights for a number of first party user(s) 585. The first party data 230 included with the communication 250 can be encrypted or unencrypted. However, the identity of the first party user(s) 585 will always be hidden (e.g., through one or more hashes). Thus, in the event that the first party data 230 of a communication 250 is received by a party unaffiliated with a respective first party user referenced by the communication 250, the unaffiliated party will be unable to trace the information back to the hidden first party user.

The service request 290 can include a request to add first party users referenced by the hashed user group 1225 to a third party group maintained by a third party. The third party group, for example, can include a product specific group referencing third party users with an interest in specific products. The first party computing system 505 can facilitate the creation and maintenance of such a group by identifying first party users 585 with an interest in a specific product based on first party data 230, generating a hashed user group 1225 referencing the identified users, and providing the hashed user group 1225 to a third party with a service request 290 instructing the third party to add the referenced users to the product specific group. In this manner, a merchant can provide first party secure communication(s) 250 to a plurality of different third-party advertising platforms to facilitate consistent third-party lists across each platform. The product specific group is provided as one example. As described herein with reference to the merchant, the user group (first party or third party) can include any type or combination of types of groups such as, for example, a high-value group, a high-churn rate group, etc.

The first party computing system 505 can generate the hashed user group 1225 based, at least in part, on at least one user group of the one or more user groups and the secure communication standards 1120 received from an orchestration service 165 as described herein. For example, the secure communication standards 1120 can identify a particular hashing algorithm 1115 to apply to the first party user identifier(s) 570 to individually hash each of the first party user identifier(s) corresponding to a first party user of a first party group. The hashed user group 1225 can include a list of individually hashed identifiers for each of the subset of users within at least one of the user group(s). For instance, the hashed list can include one or more hashed first party user identifiers 570 for each respective first party user within the user group. By way of example, the hashed identifiers for each respective first party user can include at least one of a hashed email, a hashed phone number, and/or a hashed first name, last name, and/or zip code (e.g., as illustrated by FIG. 1B).

The first party computing system 505 can receive a subset of the first party user identifiers 570 for the subset of the first party users 585 within a user group. The subset of the first party user identifiers 570 can include at least one of the first party user's name, electronic/physical address, contact information, and/or any other identifying information for the first party user. In some implementations, the subset of user identifiers can include at least one user identifier for each respective user in the user group.

The first party computing system 505 can generate the hashed user group 1225 based on the subset of user identifiers and the hashing algorithm 1115 identified by the secure communication standards 1120. For instance, the first party computing system 505 can individually apply the hashing algorithm 1115 to the subset of user identifiers to generate the hashed user group 1225. The hashing algorithm 1115 can include any type of hashing function such as, for example, at least one of a message digest algorithm (e.g., MD5), secure hash algorithm (e.g., SHA-0, SHA-1, SHA-2, etc.), local area network manager algorithm (e.g., LANMAN, NTLM, etc.), etc. In some implementations, for example, the hashing algorithm 1115 can include SHA-256. The first party secure communication 250 can include data indicative of and/or otherwise identify the hashed user group 1225.

The first party secure communication 250 can include one or more service request(s) 225 for the third party computing system 510. For example, the first party secure communication 250 can include a service request 290 to perform one or more service operations for the first party computing system 505. For example, as described herein, the service operations can include instructions for facilitating consistent, personalized, and/or inventory aware messaging to third-party users of the third party computing system. As examples, the service operations can include user acquisition operation(s) for acquiring new customers for the merchant, user servicing operation(s) for providing user specific information to one or more customers of the merchant (e.g., third-party users that are already first party customers), item offering operation(s) for providing item specific information to one or more users of the advertisement platform, merchant informational operation(s) for providing first party information (e.g., for a respective item, etc.) to one or more users of the advertisement platform, and/or any other servicing operations for messaging user through a respective third-party platform.

The service request 290, for example, can provide instructions for providing particular information to a third party user (e.g., based on a customer journey, product stage, etc.). The same (or different) service request 290 can be provided to a plurality of different third parties to initiate consistent marketing campaigns across multiple advertising platforms. By way of example, the service request 290 can include a request to perform user acquisition operation(s) for acquiring new customers based on a hashed user group 1225 that references potential customer identified by the merchant as in an exploratory phase (e.g., a first stage 305 of FIG. 3, etc.) for particular products or services. As another example, the service request 290 can include a request to perform item offering operation(s) for providing item specific information for a product offered by the merchant based on the product's stage (e.g., stages 405, 410, 415 of FIG. 4, etc.) in a product lifecycle.

In some implementations, the first party secure communication 250 can be generated based, at least in part, on at least one group type associated with a user group. For example, the at least one group type can include a high value type (e.g., indicative of one or more high value users of the merchant). In such a case, the first party secure communication 250 can include a service request 290 including a request to identify potentially high value users for the merchant based, at least in part, on the hashed user group 1225. The service request 290, for example, can include a request to identify potential high value users (e.g., user acquisition operations) based, at least in part, on the subset of users within the user group (and/or one or more common attributes thereof).

In addition, or alternatively, the at least one group type can include a high churn type. In such a case, the first party secure communication 250 can include a service request 290 including a request to provide an incentive to one or more users associated with the recipient of the first party secure communication 250 based, at least in part, on the hashed user group. By way of example, the recipient can include the third party computing system 510. In such a case, the first party secure communication 250 can include a service request 290 including a request to provide an incentive (e.g., user servicing operations) to one or more third party users associated with the advertisement platform based, at least in part, on the hashed user group 1225. In some implementations, the at least one group type can include a respective item type and the first party secure communication 250 can include a service request 290 including a request to provide item specific information (e.g., item data 1210) to one or more third party users associated with the advertisement platform based, at least in part, on the hashed user group 1225.

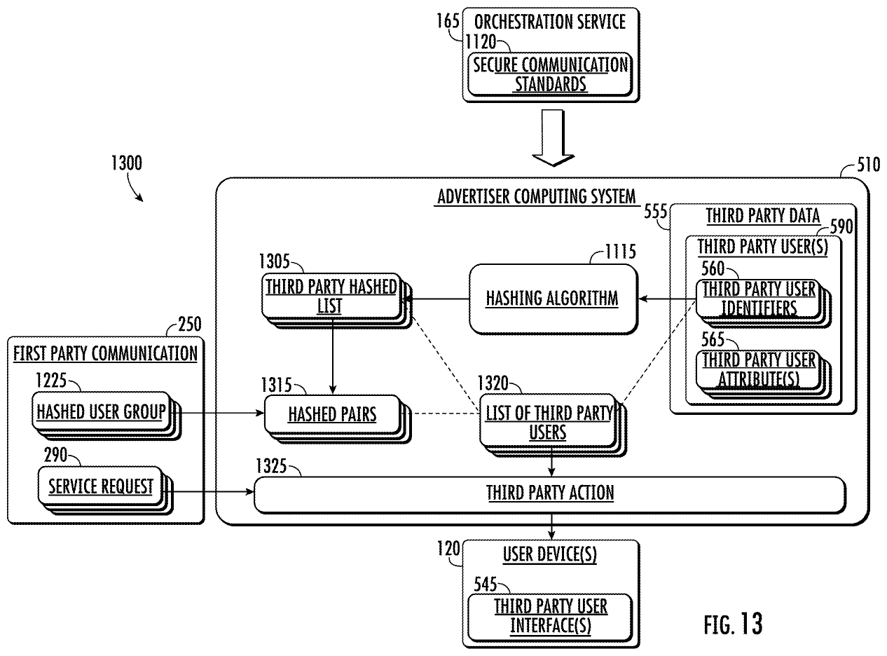

FIG. 13 depicts an example block diagram 1300 for referencing third party users based on a privacy conscious communication according to example aspects of the present disclosure. As depicted, the third party computing system 510 can receive a first party secure communication 250 including data indicative of a hashed user group 1225 and/or a service request 290. The third party computing system 510 can generate a third party hashed list 1305 based, at least in part, on a plurality of third party user identifier(s) 560 corresponding to a plurality of third party users 590 identified by the third party data 555 and the secure communication standards 1120 received from the orchestration service 165 as described herein. For example, the secure communication standards 1120 can identify a particular hashing algorithm 1115 to apply to the third party user identifier(s) 560. Each third party hashed identifier of the third party hashed list 1305 can correspond to a respective third party user identifier of the third party user identifier(s) 560. The third party computing system 510 can generate a set of hashed pairs 1315 based, at least in part, on the third party hashed list 1305 and the hashed user group 1225 and determine a list of third party users 1320 corresponding to the first party secure communication 250 based, at least in part, on the set of hashed pairs 1315.

In this manner, the third party computing system 510 can compare the hashed user group 1225 to third party data 555 to reference one or more third party users 1320 associated with the first party secure communication 250 without any prior knowledge of the first party computing system 505, a subset of first party users associated with a merchant generated user group, or the plurality of first party users of a merchant. For example, in the event that the same user is affiliated with both the merchant (e.g., is a customer, etc. of the merchant) and the advertisement platform (e.g., is a user of an advertisement platform), the third party data 555 can include third party user identifier(s) 560 corresponding to a respective first party user identifier 555 for the affiliated user. This enables the third party computing system 510 to reference an affiliated user of the hashed user group 1225 by hashing the same information hashed by the merchant (e.g., corresponding user identifiers) and matching the hashed information to at least a portion (e.g., an individual digest included in the hashed user group 1225) of the hashed user group 1225. In this manner, the first party computing system 505 can securely transmit hashed information associated with one or more first party users over one or more networks (e.g., secure, or unsecure) without exposing information associated with its users such as transaction history, value to the first party, etc. to malicious parties.

More particularly, the third party computing system 510 can generate a third party hashed list 1305 based, at least in part, on the third party data 555 and the hashing algorithm 1115 identified by the secure communication standards 1120. The hashing algorithm 1115 can include any type of hashing function such as, for example, any of the hashing algorithms described herein. The hashing algorithm 1115 is the same hashing algorithm utilized by the first party computing system 505. The third party computing system 510 can individually apply the hashing algorithm 1115 to at least one of the one or more third party user identifier(s) 560 for each of the plurality of third party users 590 (e.g., user accounts, etc.) to generate the third party hashed list 1305.

The third party hashed list 1305 can include a plurality of hashed third party identifiers corresponding to the plurality of third party user identifier(s) 560. For example, each hashed third party identifier can correspond to a respective third party user identifier. Each hashed third party identifier can reference a respective third party user based, at least in part, on the corresponding third party user identifier. The plurality of third party user identifier(s) 560 corresponding to the third party hashed list 1305 can at least in part overlap the plurality of first party user identifiers 555 corresponding to the hashed user group 1225. By way of example, a user affiliated with both the merchant and the advertisement platform can provide at least one of the same user identifiers to each party. This, in turn, enables the third party computing system 510 to hash at least part of the same information used by the first party computing system 505 as the basis for the hashed user group 1225. The third party computing system 510 can generate the third party hashed list 1305 that at least partially matches the hashed user group 1225 by applying the same hash function 1015 as the first party computing system 505 to the at least partially overlapping information (e.g., an individual user identifier) used as the basis for the hashed user group 1225. By doing so, the third party computing system 510 can reference one or more third party users 1320 despite the irreversible nature of hashed information.

By way of example, the third party computing system 510 can generate a list of third party users 1320 based, at least in part, on the hashed user group 1225, the third party hashed list 1305, and the third party data 555 (e.g., the corresponding third party user identifier(s) 560, etc.). For example, the third party computing system 510 can determine one or more hashed pairs 1315 between the third party hashed list 1305 and the hashed user group 1225 of the first party secure communication 250. The third party computing system 510 can reference at least one of the plurality of third party users (and/or user accounts) based, at least in part, on a correlation between the hashed pair(s) 1315 and the third party user identifier(s) 560 for each of the plurality of third party users (and/or user accounts). For example, the third party computing system 510 can reference each third party user identifier corresponding to the hashed third party identifier of each of the hashed pair(s) 1315.

By way of example, the at least one third party user (and/or user account) of the list of third party users 1320 can include and/or be associated with a third party user identifier corresponding to at least one of the hashed pair(s) 1315. The corresponding hashed pair can be indicative of a first party user (and/or one or more user identifiers thereof) associated with the hashed user group 1225. In this manner, the third party computing system 510 can reference at least one of the subset of users of the user group by applying the hashing algorithm 1115 to one or more third party user identifier(s) 560 associated with the plurality of third party user (and/or user accounts).

The third party computing system 510 can generate the list of third party users 1320 based, at least in part, on the at least one of the plurality of third party users (e.g., user accounts). For instance, the list of third party users 1320 can include a plurality of third party users (e.g., a subset of third party users 590) associated with respective third party user accounts corresponding to at least one hashed pair. The list of third party users 1320 can include a first subset of the plurality of third party user accounts. Each respective third party user account of the plurality of third party user accounts can be associated with one or more third party user attribute(s) 565 such as any of the user attributes described herein.

With reference to FIGS. 10 and 13, the first party secure communication 250 can include data indicative of a first party item, a user group, and/or one or more insights (e.g., a predicted interest, etc.) or attributes for the user group. The first party computing system 505 can communicate the first party secure communication 250 to the third party computing system 510. The third party computing system 510 can generate a content item based, at least in part, on the first party secure communication 250 and cause the user device(s) 120 associated with the first party user to present the content item. The content item, for example, can be based at least in part on the service request 290 of the first party secure communication 250.

The content item(s) can include product advertisements 155. The third party computing system 510 can initiate the presentation of the content item by providing the product advertisements 155 to third party users in accordance with the service request 290 of the first party secure communication 250. The service request 290 can specify a particular advertisement, a type of advertisement, or include information for use in generating third party specific advertisements 155. For instance, the information can include instructions to provide messages consistent with a customer's stage in their customer journey such that the third party can generate stage-specific advertisements keyed to particular first party users. In addition, or alternatively, the information can include instructions to provide messages consistent with a customer's interests such that the third party can generate product-specific advertisements keyed to particular first party users. As another example, the information can include instructions to provide messages consistent with a customer's value or likelihood of leaving the first party. In such a case, a service request 290 can authorize the third party to generate and provide advertisements 155 including product discounts (and/or other incentives) to particular third party users.

The third party computing system 510 can provide an advertisement 155 including data indicative of the one or more content items to the one or more referenced third party user(s) 590 using one or more tools and/or platforms of the third party (e.g., third party platform, etc.). By way of example, the third party computing system 510 can provide the data for display within third party user interface(s) 545 hosted by the third party computing system 510. The user interface(s) 545 can include social media platforms, messaging platforms, media platforms, internet searching platforms, cloud storage platforms, gaming platforms, etc. As one example, the third party computing system 510 can be associated with a search engine that provides an internet searching platform. In such a case, the third party computing system 510 can receive input data indicative of a website and at least one third party user in the list of third party users 590. The third party computing system 510 can provide data indicative of customized third party user interface 545 (e.g., a customized website, etc.) for display to the third party user based, at least in part, on the one or more content items and at least one third party user. The customized third party user interface 545, for example, can present personalized messages (e.g., advertisements keyed to the user's interests, value, and/or other insights service by the first party) to the third party user. Such messages can be informed by first party data gathered by the first party. Moreover, the same (and/or similar) first party advertising communication(s) 1050 can be provided to a plurality of different third party platforms such that consistent information is provided to the respective user regardless of the third party platform.

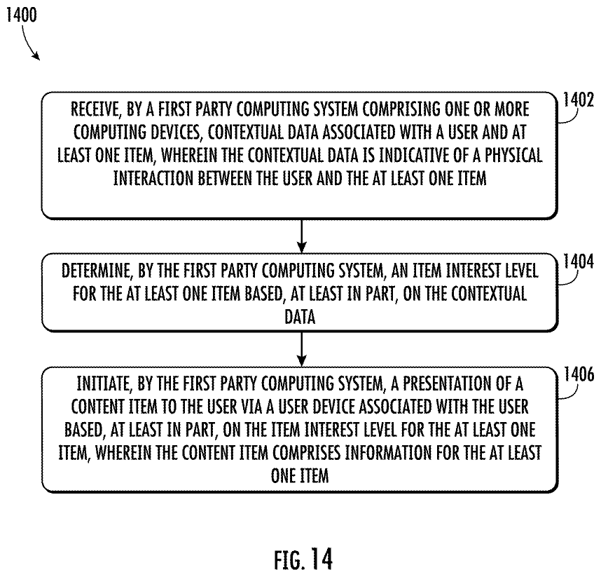

FIG. 14 depicts an example method 1400 for providing privacy conscious advertisements based on physical signals according to example aspects of the present disclosure. One or more portion(s) of method 1400 can be implemented by one or more computing device(s) such as, for example, those shown in FIGS. 1-13 and 18. Moreover, one or more portion(s) of the method 1400 can be implemented as an algorithm on the hardware components of the device(s) described herein (e.g., as in FIGS. 1-13 and 18) to, for example, to provide privacy conscious advertisements based on physical signals. FIG. 14 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1402), the method 1400 can include receiving, by a first party computing system comprising one or more computing devices, contextual data associated with a first party user and at least one item. For example, the first party computing system can receive the contextual data associated with the user and the at least one item. The contextual data, for example, can be indicative of a physical interaction between the user and the at least one item. For instance, the contextual data can include at least one of sensor data descriptive of the physical interaction or communication data indicative of the physical interaction. The physical interaction can include an interaction type. As examples, the interaction type can be indicative of at least one of an approaching action, a viewing action, a touching action, or a holding action.

At (1404), the method 1400 can include determining an item interest level for the at least one item based, at least in part, on the contextual data. For example, the first party computing system can determine the item interest level for the at least one item based, at least in part, on the contextual data. The item interest level for the at least one item can be based, at least in part, on the interaction type of the physical interaction.

In some implementations, the first party computing system can reference the first party user corresponding to the physical interaction. The first party computing system can receive user data associated with the first party user and determine the item interest level for the at least one item based, at least in part, on the user data. The user data can include a portion of first party data associated with a merchant corresponding to the first party computing system. For example, the first party data can be indicative of a plurality of first party users associated with the merchant as described herein.

The user data can include one or more first party user identifiers and one or more first party user attributes associated with the first party user. The one or more first party user identifiers associated with first party user are indicative of at least one of a first-party identified user profile maintained by the first-party computing system. The one or more user attributes associated with the first party user are indicative of at least one of a user transaction history or one or more user preferences of the first-party identified user profile maintained by the first-party computing system.

At (1406), the method 1400 can include initiating a presentation of a content item to the first party user via a user device associated with the first party user based, at least in part, on the item interest level for the at least one item. For example, the first party computing system can initiate the presentation of the content item to the first party user via the user device associated with the first party user based, at least in part, on the item interest level for the at least one item. The content item, for example, can include information for the at least one item. The user device, for example, can include a mobile phone associated with the first party user. The first party computing system can identify the user device associated with the first party user based, at least in part, on the one or more user identifiers. The first party computing system can provide a first party advertising communication to the user device. The first party advertising communication can include data indicative of the content item and one or more instructions for presenting the content item to the first party user.

In some implementations, the merchant can be associated with a first party software application configured to run on the user device. The one or more instructions can cause the first party software application to display a user interface comprising data indicative of the content item. The user interface can be associated with the first-party identified user profile maintained by the first-party computing system.

In some implementations, the first party computing system can receive data indicative of a user group including a subset of the plurality of first party users. Each first party user of the subset of the plurality of first party users can be associated with a respective item interest level for the at least one item. The first party computing system can update the user group based, at least in part, on the one or more user attributes associated with the first party user and the item interest level for the at least one item. The first party computing system can initiate the presentation of the content item to the first party user via the user device associated with the first party user based, at least in part, on the user group.

By way of example, the first party computing system can generate a first party secure communication for a third party computing system The communication can include data indicative of the at least one item and the user group. The first party computing system can communicate the first party secure communication to the third party computing system. The third party computing system can be configured to cause the user device associated with the first party user to display data indicative of the content item based, at least in part, on the first party secure communication. The first party secure communication can be generated by accessing a first-party user information attribute for the first party user. The first-party user information attribute can include and/or be otherwise associated with at least one of the one or more first party user identifiers. The first party secure communication can be generated by generating a first-party hashed user information attribute including indecipherable text by applying a predetermined hash function to the first-party user information attribute. For instance, the first party secure communication can include the first-party hashed user information attribute and the data indicative of the at least one item.

The third party computing system can be associated with a third party software application configured to run on the user device. The third party computing system can be configured to cause the third party software application to display a third party interface including data indicative of the content item. The information for the at least one item can include one or more item details for the at least one item, one or more incentives for purchasing the at least one item, or one or more associated item details for one or more associated items associated with the at least one item.

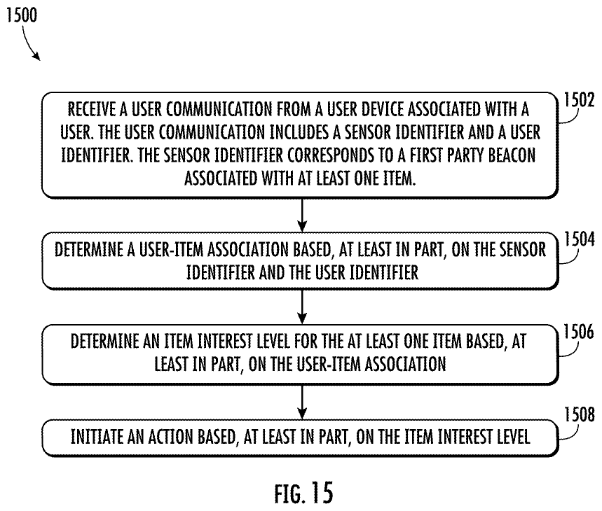

FIG. 15 depicts an example method 1500 for object specific audience servicing according to example aspects of the present disclosure. One or more portion(s) of method 1500 can be implemented by one or more computing device(s) such as, for example, those shown in FIGS. 1-13 and 18. Moreover, one or more portion(s) of the method 1500 can be implemented as an algorithm on the hardware components of the device(s) described herein (e.g., as in FIGS. 1-13 and 18) to, for example, to service one or more customers with object specific content. FIG. 15 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1502), the method 1500 can include receiving, by a first party computing system comprising one or more computing devices, a user communication from a user device associated with a user. For example, a first party computing system can receive the user communication from a user device associated with a user. The user communication can include a sensor identifier and a user identifier. In some implementations, the user communication can include a device timestamp.

The sensor identifier can correspond to a physical device associated with at least one item. The physical device, for example, can be located relative to the at least one item within a physical location associated with a merchant corresponding to the first party computing system. For example, the first party computing system can be associated with a merchant and the user can be one of a plurality of first party users associated with the merchant. In some implementations, the at least one the item can include at least one of a plurality of first party items associated with the merchant. The physical device can be one of a plurality of physical devices located relative to a plurality of first party items within the physical location. Each respective physical device can correspond to a respective sensor identifier. The first party computing system can identify the at least one item based, at least in part, on the sensor identifier.

The first party computing system can receive user data associated with the user. The user data can include a portion of the first party data that corresponds to the user. The user data can be indicative of at least one of a transaction history associated with the user or one or more user account preferences of a user account with the merchant. The first party computing system can generate a user insight based, at least in part, on the item interest level and the user data. In some implementations, the user identifier can include a hashed user identifier. The first party computing system can receive first party data associated with the plurality of first party users and identify the user based, at least in part, on the hashed user identifier, the first party data, and a hashing algorithm.

In some implementations, the first party computing system can detect a proximity of the user to a physical location associated with the merchant. The first party computing system can provide an initial first party communication to the user device based, at least in part, on the proximity of the user to the physical location associated with the merchant. The initial first party communication can include a request to execute a first party software application configured to run on the user device.

At (1504), the method 1500 can include determining a user-item association based, at least in part, on the sensor identifier and the user identifier. For example, the first party computing system can determine the user-item association based, at least in part, on the sensor identifier and the user identifier.

At (1506), the method 1500 can include determining an item interest level for the at least one item based, at least in part, on the user-item association. For example, the first party computing system can determine an item interest level for the at least one item based, at least in part, on the user-item association.

For example, the first party computing system can receive a sensor communication from the physical device associated with the at least one item. The sensor communication can include the sensor identifier, a beacon timestamp, and interaction data indicative of a physical interaction between the user and the at least one item. The first party computing system can determine the item interest level for the at least one item based, at least in part, on the sensor communication.

The interaction data can include sensor data descriptive of the physical interaction. The sensor data can be received through one or more physical sensors of the physical device. The interaction data can be indicative of an interaction time between the at least one item and the user. The first party computing system can determine a timestamp match based, at least in part, on the beacon timestamp and the device timestamp. In response to the timestamp match, the first party computing system can determine the item interest level for the at least one item based, at least in part, on the interaction data.

At (1508), the method 1500 can include initiating an action based, at least in part, on the item interest level. For example, the first party computing system can initiate the action based, at least in part, on the item interest level. The first party computing system can initiate the action based, at least in part, on the user insight. In some implementations, the first party computing system can provide a first party advertising communication to the user device based, at least in part, on the item interest level. The first party advertising communication can be configured to cause a user interface of the first party software application to display a content item associated with the at least one item. The content item can include item details for the at least one item.

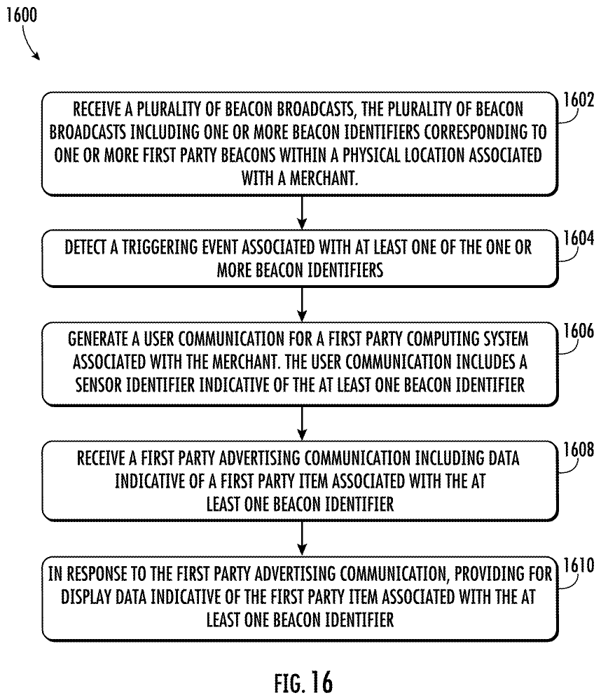

FIG. 16 depicts an example method 1600 for mobile device servicing at a point of interest according to example aspects of the present disclosure. One or more portion(s) of method 1600 can be implemented by one or more computing device(s) such as, for example, those shown in FIGS. 1-13 and 18. Moreover, one or more portion(s) of the method 1600 can be implemented as an algorithm on the hardware components of the device(s) described herein (e.g., as in FIGS. 1-13 and 18) to, for example, to service one or more mobile devices at a point of interest. FIG. 16 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1602), the method 1600 can include receiving a plurality of beacon broadcasts. For example, a user computing device can receive the plurality of beacon broadcasts. The plurality of beacon broadcasts can include one or more beacon identifiers corresponding to one or more first party beacons within a physical location associated with a merchant. Each respective first party beacon of the one or more first party beacons corresponds to a respective first party item presented within the physical location associated with the merchant. The first party item associated with the at least one beacon identifier is disposed within the physical location associated with the merchant. The at least one beacon identifier can correspond to a first party beacon within a proximity to the first party item associated with the at least one beacon identifier.

The one or more first party beacons can include one or more radio signal transmitters. The plurality of beacon broadcasts can include a plurality of radio signal packets. For example, each of the one or more radio signal transmitters can be configured to emit a radio signal packet at a predetermined time interval.

At (1604), the method 1600 can include detecting a triggering event associated with at least one of the one or more beacon identifiers. For example, the user computing device can detect the triggering event associated with the at least one of the one or more beacon identifiers.

In some implementations, the triggering event can be based, at least in part, on a threshold period of time. The user computing device can receive a beacon broadcast including the at least one beacon identifier at a plurality of at least partially consecutive times. The user computing device can determine a period of time between a first beacon broadcast comprising the at least one beacon identifier and a last beacon broadcast comprising the at least one beacon identifier. The user computing device can detect the triggering event in response to determining that the period of time achieves the threshold period of time.

At (1606), the method 1600 can include generating a user communication for a first party computing system associated with the merchant. For example, the user computing device can generate the user communication for the first party computing system associated with the merchant. The user communication can include data indicative of the at least one beacon identifier. In some implementations, the user communication includes data indicative of the period of time between a first beacon broadcast comprising the at least one beacon identifier and a last beacon broadcast comprising the at least one beacon identifier.

In some implementations, the user computing device can include one or more sensors. The user computing device can receive movement data associated with a user of the user computing device. The user computing device can determine that the movement data is received at least partially during the period of time. The user computing device can generate the user communication based, at least in part, on the movement data. For example, the user communication can include at least a portion of the movement data. The movement data can include sensor data descriptive of one or more physical interactions with the first party item associated with the at least one beacon identifier.

In some implementations, the user computing device can receive one or more additional beacon broadcasts including the at least one beacon identifier at one or more subsequent times to the period of time. The user computing device can generate one or more additional user communications for the first party computing system. Each additional user communication can include an additional timestamp indicative of at least one of the one or more subsequent times. The user computing device can provide the one or more additional user communications to the first party computing system.

In some implementations, the triggering event can be based, at least in part, on a threshold received signal strength indicator. By way of example, the user computing device can determine a respective signal strength for each of the plurality of beacon broadcast. The user computing device can detect the triggering event in response to determining that a signal strength for a beacon broadcast that includes the at least one beacon identifier achieves the threshold received signal strength indicator. The user communication can include data indicative of the signal strength for the beacon broadcast comprising the at least one beacon identifier.

At (1608), the method 1600 can include receiving a first party advertising communication including data indicative of a first party item associated with the at least one beacon identifier. For example, the user computing device can receive the first party advertising communication including data indicative of a first party item associated with the at least one beacon identifier.

At (1610), the method 1600 can include, in response to the first party advertising communication, providing for display data indicative of the first party item associated with the at least one beacon identifier. For example, the user computing device can, in response to the first party advertising communication, provide, for display, the data indicative of the first party item associated with the at least one beacon identifier. For example, the first party item can be provided for display within the physical location associated with the merchant.

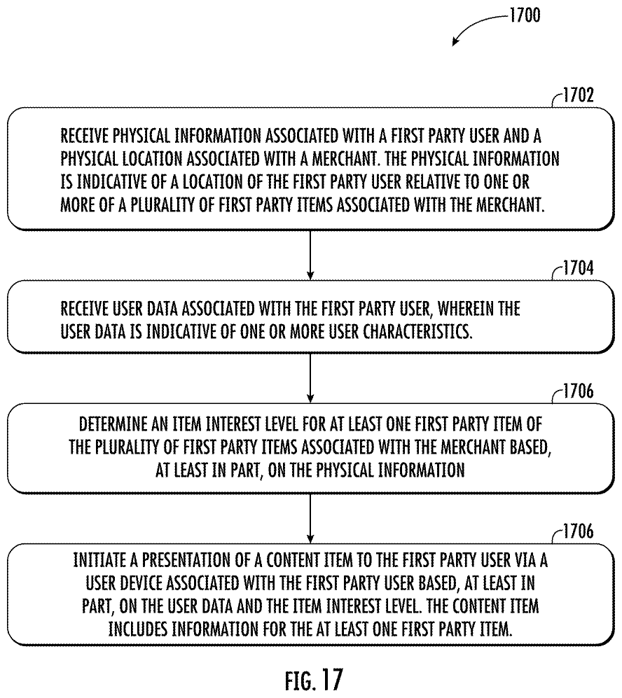

FIG. 17 depicts an example method 1700 for inferring user intent based on physical signals according to example aspects of the present disclosure. One or more portion(s) of method 1700 can be implemented by one or more computing device(s) such as, for example, those shown in FIGS. 1-13 and 18. Moreover, one or more portion(s) of the method 1700 can be implemented as an algorithm on the hardware components of the device(s) described herein (e.g., as in FIGS. 1-13 and 18) to, for example, infer user intent based on physical signals. FIG. 17 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1702), the method 1700 can include receiving physical information associated with a first party user and a physical location associated with a merchant. For example, a first party computing system can receive physical information associated with a first party user and a physical location associated with a merchant. The physical information can be indicative of a location of the first party user relative to one or more of a plurality of first party items associated with the merchant.

The physical location associated with the merchant can include a subset of onsite items of the plurality of first party items. The subset of onsite items can include one or more first party items located within the physical location. The physical location can include a plurality of physical devices configured to capture the physical information. The physical information includes sensor data received via at least one of the plurality of physical devices. In some implementations, each of the plurality of physical devices correspond to one or more of the subset of onsite items. In some implementations, each of the plurality of physical devices correspond to a respective onsite item presented within the physical location. In some implementations, each of the plurality of physical devices correspond to a respective area of a plurality of areas within the physical location. In some implementations, each of the plurality of areas correspond to one or more of the plurality of item types.

At (1704), the method 1700 can include receiving user data associated with the first party user. For example, the first party computing system can receive the user data associated with the first party user. The user data, for example, can be indicative of one or more user characteristics. The first party computing system can receive first party data associated with a plurality of first party users of the merchant. The first party data can include the user data for the first party user. The user data can be indicative of one or more user attributes for the first party user. The one or more user attributes are indicative of a transaction history associated with the first party user.

At (1706), the method 1700 can include determining an item interest level for at least one first party item of the plurality of first party items associated with the merchant based, at least in part, on the physical information. For example, the first party computing system can determine the item interest level for at least one first party item of the plurality of first party items associated with the merchant based, at least in part, on the physical information. The first party computing system can determine at least one item type associated with the physical information of a plurality of item types associated with the plurality of first party items. The at least one item type can identify one or more associated items. The first party computing system can determine the item interest level for the at least one first party item based, at least in part, on the at least one item type. The item interest level can be indicative of a user interest in the one or more associated items. The item interest level for the at least one item can be determined based, at least in part, on the transaction history associated with the first party user.

In some implementations, the physical information includes radar data descriptive of one or more user movements relative to one or more of the plurality of first party items. The first party computing system can determine the gesture data for the first party user by inputting the radar data to a gesture recognition machine-learning model configured to identify one or more gestures corresponding to radar data. The first party computing system can determine the item interest level for the at least one item based, at least in part, on the gesture data.

In some implementations, the user data can be indicative of one or more associated users. The first party computing system can determine a secondary item interest level for the one or more associated users based, at least in part, on the physical information.

At (1708), the method 1700 can include initiating a presentation of a content item to the first party user via a user device associated with the first party user based, at least in part, on the user data and the item interest level. For example, the first party computing system can initiate the presentation of the content item to the first party user via the user device associated with the first party user based, at least in part, on the user data and the item interest level. The content item can include information for the at least one first party item.

The first party computing system can receive item inventory data for at least one of the one or more associated items. The item inventory data identifies an availability of the one or more associated items at the physical location. The first party computing system can provide the data indicative of the item inventory data to the user device. The first party computing system can determine based, at least in part, on the item inventory data, that at least one of the one or more associated items are unavailable at the physical location. In response to determining that the at least one associated item is unavailable, the first party computing system can provide data indicative of another physical location associated with the merchant. The first party computing system can determine based, at least in part, on the item inventory data, that at least one of the one or more associated items are available at the physical location. In response to determining that the at least one associated item is available, the first party computing system can provide data indicative of an incentive to purchase the at least one associated item at the physical location.

The content item can include item location data for at least one of the one or more associated items. The item location data can be indicative of a location of the at least one associated item within the physical location. The content item can include one or more directions to the location of the at least one associated item within the physical location.

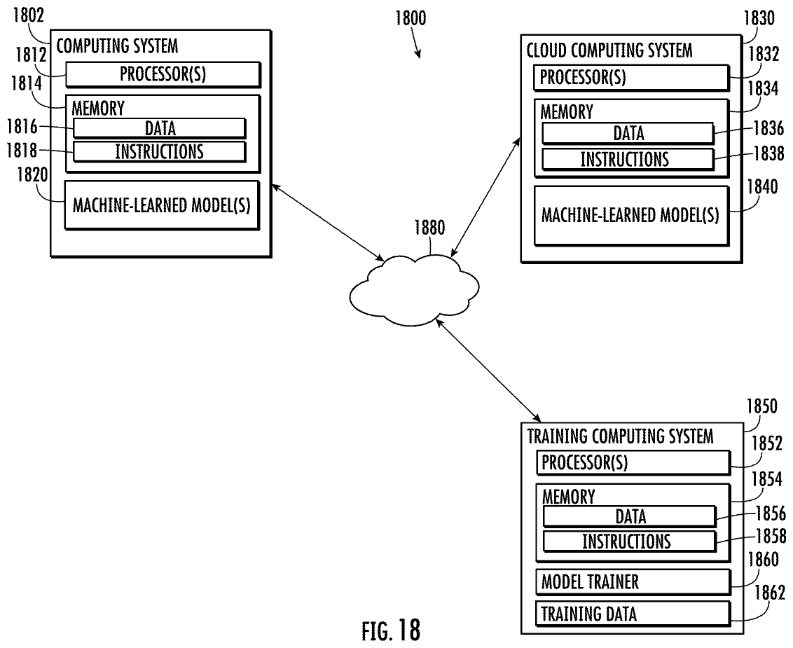

FIG. 18 depicts a block diagram of an example machine-learning computing environment 1800 according to example aspects of the present disclosure. The environment 1800 includes a computing system 1802 (e.g., first party computing system 505, third party computing system 510, etc. of FIG. 5) that performs predictive analytics according to example embodiments of the present disclosure. In addition, the environment 1800 includes a server computing system 1830 (e.g., merchant/marketer cloud computing system 105, intermediary cloud computing system 240, cloud computing system 540, market analytics cloud computing system 700, etc.), and a training computing system 1850 that are communicatively coupled over a network 1880.

The computing system 1802 can include one or more of any type of computing device(s), such as, for example, one or more servers, personal computing device (e.g., laptop or desktop), a mobile computing device (e.g., smartphone or tablet), or any other type of computing device(s).

The computing system 1802 includes one or more processors 1812 and a memory 184. The one or more processors 1812 can be any suitable processing device (e.g., a processor core, a microprocessor, an ASIC, an FPGA, a controller, a microcontroller, etc.) and can be one processor or a plurality of processors that are operatively connected. The memory 1814 can include one or more non-transitory computer-readable storage media, such as RAM, ROM, EEPROM, EPROM, flash memory devices, magnetic disks, etc., and combinations thereof. The memory 1814 can store data 1816 and instructions 1818 which are executed by the processor 1812 to cause the computing system 1802 to perform operations.

In some implementations, the computing system 1802 can store or include one or more model(s) 1820 (e.g., predictive model(s), etc.). For example, the models 1820 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 1820 are discussed with reference to the prediction system of FIG. 2.

In some implementations, the one or more model(s) 1820 can be received from the server computing system 1830 over network 1880, stored in the computing system memory 1814, and then used or otherwise implemented by the one or more processors 1812. In some implementations, the computing system 1802 can implement multiple parallel instances of the model(s) 1820 (e.g., to perform parallel predictive analytics across multiple instances of the predictive model(s)).

More particularly, model(s) can include one or more insight model(s) such as, for example, value-based model(s) configured to output value segmentations (e.g., high, medium, low value segmentations, etc.) based on first party data, global data, and/or third party data, predictive churn model(s) configured to output churn segmentations (e.g., high, medium, low churn rate, etc.), predictive item specific model(s) configured to output item interest segmentations (e.g., high, medium, low interest with respect to respective item(s), etc.) based on first party data, and/or any other model or combinations thereof described herein.

Additionally, or alternatively, one or more models 1840 can be included in or otherwise stored and implemented by the server computing system 1830 that communicates with the computing system 1802 according to a client-server relationship. For example, the models 1840 can be implemented by the server computing system 1830 as a portion of a web service (e.g., a cloud marketing service). Thus, one or more models 1820 can be stored and implemented at the computing system 1802 and/or one or more models 1840 can be stored and implemented at the server computing system 1830.

The server computing system 1830 includes one or more processors 1832 and a memory 1834. The one or more processors 1832 can be any suitable processing device (e.g., a processor core, a microprocessor, an ASIC, an FPGA, a controller, a microcontroller, etc.) and can be one processor or a plurality of processors that are operatively connected. The memory 1834 can include one or more non-transitory computer-readable storage media, such as RAM, ROM, EEPROM, EPROM, flash memory devices, magnetic disks, etc., and combinations thereof. The memory 1834 can store data 1836 and instructions 1838 which are executed by the processor 1832 to cause the server computing system 1830 to perform operations.

In some implementations, the server computing system 1830 includes or is otherwise implemented by one or more server computing devices. In instances in which the server computing system 1830 includes plural server computing devices, such server computing devices can operate according to sequential computing architectures, parallel computing architectures, or some combination thereof.

As described above, the server computing system 1130 can store or otherwise include one or more models 1840. For example, the models 1840 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 1840 are discussed with reference to FIG. 2.

The computing system 1802 and/or the server computing system 1830 can train the models 1820 and/or 1840 via interaction with the training computing system 1850 that is communicatively coupled over the network 1880. The training computing system 1850 can be separate from the server computing system 1830 or can be a portion of the server computing system 1830.

The training computing system 1850 includes one or more processors 1852 and a memory 1854. The one or more processors 1852 can be any suitable processing device (e.g., a processor core, a microprocessor, an ASIC, an FPGA, a controller, a microcontroller, etc.) and can be one processor or a plurality of processors that are operatively connected. The memory 1854 can include one or more non-transitory computer-readable storage media, such as RAM, ROM, EEPROM, EPROM, flash memory devices, magnetic disks, etc., and combinations thereof. The memory 1854 can store data 1856 and instructions 1858 which are executed by the processor 1852 to cause the training computing system 1850 to perform operations. In some implementations, the training computing system 1850 includes or is otherwise implemented by one or more server computing devices.

The training computing system 1850 can include a model trainer 1860 that trains the machine-learned models 1820 and/or 1840 stored at the computing system 1802 and/or the server computing system 1830 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 1860 can perform a number of generalization techniques (e.g., weight decays, dropouts, etc.) to improve the generalization capability of the models being trained.

In particular, the model trainer 1860 can train the models 1820 and/or 1840 based on a set of training data 1862. The training data 1862 can include, for example, the first party data, global data, and/or third party data described herein with reference to the first party. In addition, or alternatively, the training data 1862 can include universal first party data, global data, and/or third party data received from a plurality of different first parties associated with the service computing system 1830. In some implementations, the training data 1862 can include labeled first party data, global data, and/or third party data including labels indicative of a first party user's actual activity and/or any other labels for facilitating the training of the models 1820 and/or 1840 (e.g., via one or more supervisory training techniques, etc.).

In some implementations, if the computing system 1802 has provided consent, the training examples can be provided by the computing system 1802. Thus, in such implementations, the model 1820 provided to the computing system 1802 can be trained by the training computing system 1850 on first party (and/or third party) specific data received from the computing system 1802. In some instances, this process can be referred to as personalizing the model.

The model trainer 1860 includes computer logic utilized to provide desired functionality. The model trainer 1860 can be implemented in hardware, firmware, and/or software controlling a general purpose processor. For example, in some implementations, the model trainer 1860 includes program files stored on a storage device, loaded into a memory and executed by one or more processors. In other implementations, the model trainer 1860 includes one or more sets of computer-executable instructions that are stored in a tangible computer-readable storage medium such as RAM, hard disk, or optical or magnetic media.

The network 1880 can be any type of communications network, such as a local area network (e.g., intranet), wide area network (e.g., Internet), or some combination thereof and can include any number of wired or wireless links. In general, communication over the network 1880 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 18 illustrates one example computing system that can be used to implement the present disclosure. Other computing systems can be used as well. For example, in some implementations, the computing system 1802 can include the model trainer 1860 and the training data 1862. In such implementations, the models 1820 can be both trained and used locally at the computing system 1802. In some of such implementations, the computing system 1802 can implement the model trainer 1860 to personalize the models 1820 based on first party (and/or third party) specific data.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, comprising:
receiving, by a first party computing system comprising one or more computing devices, contextual data associated with a first party user and at least one item, wherein the contextual data is indicative of a physical interaction between the first party user and the at least one item;
determining, by the first party computing system, an item interest level for the at least one item based, at least in part, on the contextual data; and
initiating, by the first party computing system, a presentation of a content item to the first party user via a user device associated with the first party user based, at least in part, on the item interest level for the at least one item, wherein the content item comprises information for the at least one item.

2. The computer-implemented method of claim 1, wherein the user device comprises a mobile phone associated with the first party user.

3. The computer-implemented method of claim 1, wherein the contextual data comprises at least one of sensor data descriptive of the physical interaction or communication data indicative of the physical interaction.

4. The computer-implemented method of claim 1, wherein the physical interaction comprises an interaction type, the interaction type indicative of at least one of an approaching action, a viewing action, a touching action, or a holding action.

5. The computer-implemented method of claim 4, wherein the item interest level for the at least one item is based, at least in part, on the interaction type of the physical interaction.

6. The computer-implemented method of claim 1, wherein determining the item interest level for the at least one item based, at least in part, on the contextual data comprises:
referencing, by the first party computing system, the first party user corresponding to the physical interaction;
receiving, by the first party computing system, user data associated with the first party user, wherein the user data comprises a portion of first party data associated with a merchant corresponding to the first party computing system, wherein the first party data is indicative of a plurality of first party users associated with the merchant; and
determining, by the first party computing system, the item interest level for the at least one item based, at least in part, on the user data.

7. The computer-implemented method of claim 6, wherein the user data comprises one or more first party user identifiers and one or more first party user attributes associated with the first party user.

8. The computer-implemented method of claim 7, wherein the one or more first party user identifiers associated with first party user are indicative of at least one of a first-party identified user profile maintained by the first-party computing system.

9. The computer-implemented method of claim 8, wherein the one or more user attributes associated with the first party user are indicative of at least one of a user transaction history or one or more user preferences of the first-party identified user profile maintained by the first-party computing system.

10. The computer-implemented method of claim 8, wherein initiating the presentation of the content item to the first party user via the user device associated with the first party user comprises:
identifying, by the first party computing system, the user device associated with the first party user based, at least in part, on the one or more user identifiers; and
providing, by the first party computing system, a first party advertising communication to the user device, wherein the first party advertising communication comprises data indicative of the content item and one or more instructions for presenting the content item to the first party user.

11. The computer-implemented method of claim 9, wherein the merchant is associated with a first party software application configured to run on the user device, and wherein the one or more instructions cause the first party software application to display a user interface comprising data indicative of the content item, wherein the user interface is associated with the first-party identified user profile maintained by the first-party computing system.

12. The computer-implemented method of claim 7, wherein the method further comprises:
receiving, by the first party computing system, data indicative of a user group comprising a subset of the plurality of first party users, wherein each first party user of the subset of the plurality of first party users are associated with a respective item interest level for the at least one item;
updating, by the first party computing system, the user group based, at least in part, on the one or more user attributes associated with the first party user and the item interest level for the at least one item; and
initiating, by the first party computing system, the presentation of the content item to the first party user via the user device associated with the first party user based, at least in part, on the user group.

13. The computer-implemented method of claim 12, wherein initiating the presentation of the content item to the first party user via the user device associated with the first party user based, at least in part, on the user group, comprises:
generating, by the first party computing system, a first party secure communication for a third party computing system, wherein the communication comprises data indicative of the at least one item and the user group; and
communicating, by the first party computing system, the first party secure communication to the third party computing system, wherein the third party computing system is configured to cause the user device associated with the first party user to display data indicative of the content item based, at least in part, on the first party secure communication.

14. The computer-implemented method of claim 13, wherein generating the first party secure communication for the third party computing system comprises:
accessing, by the first-party computing system, a first-party user information attribute for the first party user, the first-party user information attribute associated with at least one of the one or more first party user identifiers;
generating, by the first-party computing system, a first-party hashed user information attribute including indecipherable text by applying a predetermined hash function to the first-party user information attribute; and
generating, by the first-party computing system, the first party secure communication including the first-party hashed user information attribute and the data indicative of the at least one item.

15. The computer-implemented method of claim 14, wherein the third party computing system is associated with a third party software application configured to run on the user device, wherein the third party computing system is configured to cause the third party software application to display a third party interface comprising data indicative of the content item.

16. The computer-implemented method of claim 1, wherein the information for the at least one item comprises one or more item details for the at least one item, one or more incentives for purchasing the at least one item, or one or more associated item details for one or more associated items associated with the at least one item.

17. A first party computing system, comprising:
one or more processors; and
a memory storing instructions that when executed by the one or more processors cause the first party computing system to perform operations comprising:
receiving contextual data associated with a first party user and at least one item, wherein the contextual data is indicative of a physical interaction between the first party user and the at least one item;
determining an item interest level for the at least one item based, at least in part, on the contextual data; and
initiating a presentation of a content item to the first party user via a user device associated with the first party user based, at least in part, on the item interest level for the at least one item, wherein the content item comprises information for the at least one item.

18. The first party computing system of claim 17, wherein the contextual data is indicative of a time associated with the physical interaction, and wherein user device is configured to display the content item within a predetermined time period from the time associated with the physical interaction.

19. One or more non-transitory computer-readable media comprising instructions that when executed by one or more computing devices cause the one or more computing devices to perform operations comprising:
receiving contextual data associated with a first party user and at least one item, wherein the contextual data is indicative of a physical interaction between the first party user and the at least one item;
receiving user data associated with the first party user;
determining an item interest level for the at least one item based, at least in part, on the contextual data; and
initiating a presentation of a content item to the first party user via a user device associated with the first party user based, at least in part, on the user data and the item interest level, wherein the content item comprises information for the at least one item.

20. The one or more non-transitory computer-readable media of claim 19, wherein the contextual data comprises radar data generated via one or more radar sensors, wherein the radar data is descriptive of one or more user movements relative to the at least one item.
